(19) United States
(12) Patent Application Publication
(10) Pub. No.: US 2026/0227600 A1
(43) Pub. Date: Aug. 6, 2026

(54) OPTICAL SYSTEM AND CAMERA MODULE

(71) Applicant: LG INNOTEK CO., LTD., Seoul (KR)

(72) Inventor: Ju Yong SHIM, Seoul (KR)

(21) Appl. No.: 19/147,934

(22) PCT Filed: Jan. 10, 2024
(86) PCT No.: PCT/KR2024/000509

§ 371 Date: Jul. 14, 2025

(30) Foreign Application Priority Data
Jan. 12, 2023 (KR) 10-2023-0005026
Apr. 19, 2023 (KR) 10-2023-0051652

(51) Int. Cl. G02B 13/00; G02B 1/04; G02B 3/00; G02B 9/64

(52) U.S. Cl. CPC G02B 13/0045; G02B 1/041; G02B 9/64; G02B 2003/0093

(57) ABSTRACT

An optical system, according to the present embodiment, comprises first to eighth lenses disposed along the optical axis, wherein the first lens has negative (−) refractive power, the second lens has negative (−) refractive power, the third lens has positive (+) refractive power, the fourth lens has negative (−) refractive power, the fifth lens has positive (+) refractive power, the sixth lens has positive (+) refractive power, the seventh lens has negative (−) refractive power, and the eighth lens has positive (+) refractive power. An aperture is disposed between the fourth lens and the fifth lens, and the distance between the first lens and the second lens is the largest among the distances between the adjacent lenses on the optical axis.

### CROSS-REFERENCE TO RELATED APPLICATIONS

This application is the U.S. national stage application of International Patent Application No. PCT/KR2024/000509, filed Jan. 10, 2024, which claims the benefit under 35 U.S.C. § 119 of Korean Application No. 10-2023-0005026, filed Jan. 12, 2023; and 10-2023-0051652, filed Apr. 19, 2023, the disclosures of each of which are incorporated herein by reference in their entirety.

### TECHNICAL FIELD

The present invention relates to an optical system for improved optical performance and a camera module including the same.

### BACKGROUND ART

Advanced driving assistance system (ADAS) is an advanced driver assistance system that assists the driver in driving being configured to sense the situation ahead, judge the situation with respect to the sensed results, and control the behavior of the vehicle with respect to the situation judgment. For example, an ADAS sensor device detects a vehicle ahead and recognizes a lane. Afterwards, when the target lane, target speed, and target ahead are determined, the vehicle's electrical stability control (ESC), engine management system (EMS), motor driven power steering (MDPS), and the like are controlled. Representatively, ADAS can be implemented as an automatic parking system, a low-speed city driving assistance system, a blind spot warning system, and so on.

Sensor devices for detecting the situation ahead in ADAS include GPS sensors, laser scanners, front radar, LIDAR, and the like, and the most representative one is a camera for taking pictures of the front, rear, and sides of the vehicle.

These cameras can be disposed outside or inside the vehicle to detect the surroundings of the vehicle. In addition, the cameras can be disposed inside the vehicle to detect the situations of the driver and passengers. For example, the camera can photograph the driver at a location adjacent to the driver and detect the driver's health status, whether the driver is drowsy, whether the driver is drinking, and the like. In addition, the camera can photograph the passenger at a location adjacent to the passenger and detect whether the passenger is sleeping, health status, and the like, and provide the driver with information about the passenger.

In particular, the most important element for obtaining an image from a camera is the imaging lens that forms the image. Recently, interest in high performance such as high definition and high resolution has been increasing, and research on an optical system including multiple lenses is being conducted to implement this. However, there is a problem that the characteristics of the optical system change when the camera is exposed to a harsh environment, such as high temperature, low temperature, moisture, or high humidity, outside or inside the vehicle. In this case, the camera has a problem that it is difficult to uniformly derive excellent optical characteristics and aberration characteristics.

Accordingly, new optical systems and cameras that can solve the above-described problems are required.

### DETAILED DESCRIPTION OF THE INVENTION

### Technical Subject

An embodiment is intended to provide an optical system and a camera module having enhanced optical characteristics.

An embodiment is intended to provide an optical system and camera module having excellent optical performance in low-temperature to high-temperature environments.

An embodiment is intended to provide an optical system and camera module capable of inhibiting or minimizing changes in optical properties over a variety of temperature ranges.

### Technical Solution

In order to solve the above technical problem, an optical system according to an embodiment of the present invention comprises first to eighth lenses disposed along an optical axis, wherein the first lens has negative (−) refractive power, the second lens has negative (−) refractive power, the third lens has positive (+) refractive power, the fourth lens has negative (−) refractive power, the fifth lens has positive (+) refractive power, the sixth lens has positive (+) refractive power, the seventh lens has negative (−) refractive power, and the eighth lens has positive (+) refractive power, and an aperture is disposed between the fourth lens and the fifth lens, and among the distances between adjacent lenses on an optical axis, the distance between the first lens and the second lens may be the greatest.

At least one among the first lens and the fifth lens is made of glass, and at least one among the second to fourth lenses and the sixth to eighth lenses may be made of plastic.

At least one among the lenses being disposed on the object side and the sensor side of the aperture may be made of glass.

Among the first to eighth lenses on the optical axis, the thickness of the eighth lens may be the largest.

From the optical axis to the effective diameter area, the maximum value of the distance between two adjacent lenses having the largest difference in Abbe numbers may be smaller than the maximum value of the distance between two other adjacent lenses.

The second lens may have a concave shape on both surfaces, and the eighth lens may have a convex shape on both surfaces.

The following conditional expression can be satisfied. <Conditional expression> 170<FOV_H<190 (In the conditional expression, FOV_H means a horizontal field of view (in degree) of the optical system.)

The following conditional expression can be satisfied. <Conditional expression> 0.3<CG1/ΣCG<0.8 (In the conditional expression, CG1 is the distance between the first lens and the second lens on the optical axis, and ΣCG is the sum of the gaps between adjacent lenses on the optical axis.)

The following conditional expression can be satisfied. <Conditional expression> 3<L1R2<10 (In the conditional expression, L1R2 means the radius of curvature of the first lens.)

In order to solve the above technical problem, an optical system according to an embodiment of the present invention comprises first to eighth lenses being disposed along an optical axis, wherein the first lens has negative (−) refractive power, the second lens has negative (−) refractive power, the third lens has positive (+) refractive power, the fourth lens has negative (−) refractive power, the fifth lens has positive (+) refractive power, the sixth lens has positive (+) refractive power, the seventh lens has negative (−) refractive power, and the eighth lens has positive (+) refractive power, and among the first to eighth lenses on the optical axis, the thickness of the eighth lens may be the largest.

Among the first to eighth lenses, the effective diameter of the first lens is the largest, and among the first to eighth lenses, the effective diameter of the fourth lens may be the smallest.

Among the distances between two adjacent lenses on the optical axis, the distance between the sixth lens and the seventh lens may be the smallest.

Among the distances between two adjacent lenses on the optical axis, the distance between the first lens and the second lens may be the greatest.

An aperture is disposed between the fourth lens and the fifth lens, and a first lens group is disposed on the object side with respect to the aperture, and a second lens group is disposed on the sensor side with respect to the aperture, and the sign of the composite focal length of the first lens group and the sign of the composite focal length of the second lens group may be different from each other.

At least one of the lenses being disposed on the object side and the sensor side of the above aperture may be made of glass.

### Advantageous Effects

An optical system and a camera module according to an embodiment may have enhanced optical characteristics. In detail, in an optical system according to an embodiment, a plurality of lenses may have set thicknesses, refractive powers, and gap from adjacent lenses. Accordingly, an optical system and a camera module according to an embodiment may have enhanced MTF characteristics, aberration control characteristics, resolution characteristics, and the like in a range of set angle of view, and may have good optical performance in the edge portion of the angle of view.

In addition, an optical system and a camera module according to an embodiment can have good optical performance in a low temperature to high temperature range (−40° C. to 105° C.). In detail, a plurality of lenses included in the optical system can have set materials, refractive powers, and refractive indices. Accordingly, when the refractive index of each lens changes according to a temperature change and the focal length of each lens changes due to this, it can be mutually compensated by the plastic lens and the glass lens. That is, the optical system can effectively perform distribution of refractive power in a low temperature to high temperature range, and can inhibit or minimize changes in optical characteristics in a low temperature to high temperature range. Therefore, an optical system and a camera module according to an embodiment can maintain enhanced optical characteristics in various temperature ranges.

In addition, an optical system and a camera module according to an embodiment can satisfy the set angle of view by mixing the plastic lens and the glass lens and implement excellent optical characteristics. As a result, the optical system can provide a slimmer vehicle camera module. Accordingly, the optical system and camera module can be provided for various applications and devices, and can have excellent optical characteristics even in harsh temperature environments, such as when exposed to the outside of a vehicle or inside a vehicle at high temperatures in the summer.

### BRIEF DESCRIPTION OF DRAWINGS

FIG. 1 is a side cross-sectional view of an optical system according to a first embodiment and a camera module having the same.

FIG. 2 is a table showing the aspherical coefficients of lenses in an optical system of FIG. 1.

FIG. 3 is a table showing the thickness of each lens and the gap between adjacent lenses in an optical system of FIG. 1.

FIG. 4 is a table showing sag values of lens surfaces of the first to eighth lenses in an optical system of FIG. 1.

FIG. 5 is a table showing slope angle values of lens surfaces of the first to eighth lenses in an optical system of FIG. 1.

FIG. 6 is a graph showing data on the diffraction modulation transfer function (MTF) of an optical system of FIG. 1 at room temperature.

FIG. 7 is a graph showing data on the aberration characteristics of an optical system of FIG. 1 at room temperature.

FIG. 8 is a graph showing data on the aberration characteristics of an optical system of FIG. 1 at low temperature.

FIG. 9 is a graph showing data on the aberration characteristics of an optical system of FIG. 1 at low temperature.

FIG. 10 is a graph showing data on the diffraction MTF of an optical system of FIG. 1 at high temperature.

FIG. 11 is a graph showing data on the aberration characteristics of an optical system of FIG. 1 at high temperature.

FIG. 12 is a graph showing the peripheral illumination ratio of an optical system.

FIG. 13 is a side cross-sectional view of an optical system according to a second embodiment and a camera module having the same.

FIG. 14 is a table showing aspherical coefficients of lenses in an optical system of FIG. 13.

FIG. 15 is a table showing the thickness of each lens and the spacing between adjacent lenses in an optical system of FIG. 13.

FIG. 16 is a table showing sag values of lens surfaces of a first to eighth lenses in an optical system of FIG. 13.

FIG. 17 is a table showing slope angles of lens surfaces of a first to eighth lenses in an optical system of FIG. 13.

FIG. 18 is a graph showing data on diffraction Modulation transfer function (MTF) of an optical system of FIG. 13 at room temperature.

FIG. 19 is a graph showing data on aberration characteristics of an optical system of FIG. 13 at room temperature.

FIG. 20 is a graph showing data on diffraction MTF of an optical system of FIG. 13 at low temperature.

FIG. 21 is a graph showing data on the aberration characteristics of an optical system of FIG. 13 at low temperatures.

FIG. 22 is a graph showing data on the diffraction MTF of an optical system of FIG. 13 at high temperatures.

FIG. 23 is a graph showing data on the aberration characteristics of an optical system of FIG. 13 at high temperatures.

FIG. 24 is a graph showing the peripheral illumination ratio of an optical system of FIG. 13.

FIG. 25 is a side cross-sectional view of an optical system according to a third embodiment and a camera module having the same.

FIG. 26 is a table showing aspherical coefficients of lenses in an optical system of FIG. 25.

FIG. 27 is a table showing the thickness of each lens of an optical system of FIG. 25 and the spacing between adjacent lenses.

FIG. 28 is a table showing the sag values of the lens surfaces of the first to eighth lenses in an optical system of FIG. 25.

FIG. 29 is a table showing the slope angles of the lens surfaces of the first to eighth lenses in an optical system of FIG. 25.

FIG. 30 is a graph showing data on the diffraction MTF of an optical system of FIG. 25 at room temperature.

FIG. 31 is a graph showing data on the aberration characteristics of an optical system of FIG. 25 at room temperature.

FIG. 32 is a graph showing data on the diffraction Modulation transfer function (MTF) of an optical system of FIG. 25 at low temperature.

FIG. 33 is a graph showing data on the aberration characteristics of an optical system of FIG. 25 at low temperature.

FIG. 34 is a graph showing data on the diffraction MTF of an optical system of FIG. 25 at high temperature.

FIG. 35 is a graph showing data on the aberration characteristics of an optical system of FIG. 25 at high temperature.

FIG. 36 is a graph showing the peripheral illumination ratio of an optical system of FIG. 25.

FIG. 37 is a side cross-sectional view of an optical system according to the fourth embodiment and a camera module having the same.

FIG. 38 is a table showing aspherical coefficients of lenses in an optical system of FIG. 37.

FIG. 39 is a table showing the thickness of each lens and the spacing between adjacent lenses in an optical system of FIG. 37.

FIG. 40 is a table showing the Sag values of the lens surfaces of the first to eighth lenses in an optical system of FIG. 37.

FIG. 41 is a table showing the Slope Angle of the lens surfaces of the first to eighth lenses in an optical system of FIG. 37.

FIG. 42 is a graph showing data on the diffraction Modulation transfer function (MTF) of an optical system of FIG. 37 at room temperature.

FIG. 43 is a graph showing data on the aberration characteristics of an optical system of FIG. 37 at room temperature.

FIG. 44 is a graph showing data on the diffraction MTF of an optical system of FIG. 37 at low temperature.

FIG. 45 is a graph showing data on the aberration characteristics of an optical system of FIG. 37 at low temperature.

FIG. 46 is a graph showing data on the diffraction MTF of an optical system of FIG. 37 at high temperature.

FIG. 47 is a graph showing data on the aberration characteristics of an optical system of FIG. 37 at high temperature.

FIG. 48 is a graph showing the peripheral illumination ratio of an optical system of FIG. 37.

FIG. 49 is an example of a vehicle having an optical system according to an embodiment of the invention.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction with respect to one component may be included.

In the description of the invention, the “object side surface” may mean a surface of a lens facing the object side with respect to the optical axis OA, and the “sensor side surface” may mean a surface of a lens facing the imaging surface (image sensor) with respect to the optical axis. The “object side” may be the “object side surface,” and the “sensor side surface” may be the “image side.” A convex surface of a lens may mean a convex shape on an optical axis or the paraxial region, and a concave surface of a lens may mean a concave shape on an optical axis or the paraxial region. The radius of curvature, the center thickness, and the optical axis gap between lenses described in the table for lens data may mean values (unit: mm) on an optical axis. The vertical direction may mean a direction perpendicular to the optical axis, and the end of a lens or a lens surface may mean the end of an effective area of a lens through which incident light passes. The size of the effective diameter of the lens surface may have a measurement error of up to ±0.4 mm depending on the measurement method, and the like. The paraxial region means a very narrow region near the optical axis, and is a region where the distance of light falling from an optical axis OA is almost 0. Hereinafter, the meaning of the optical axis may include the center of each lens or a very narrow region near the optical axis.

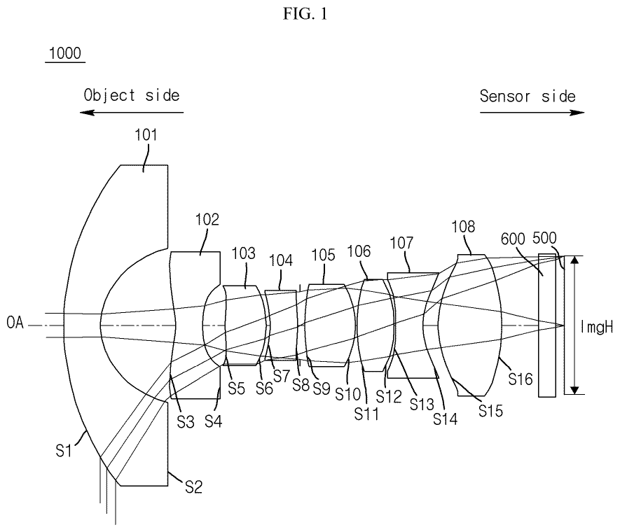

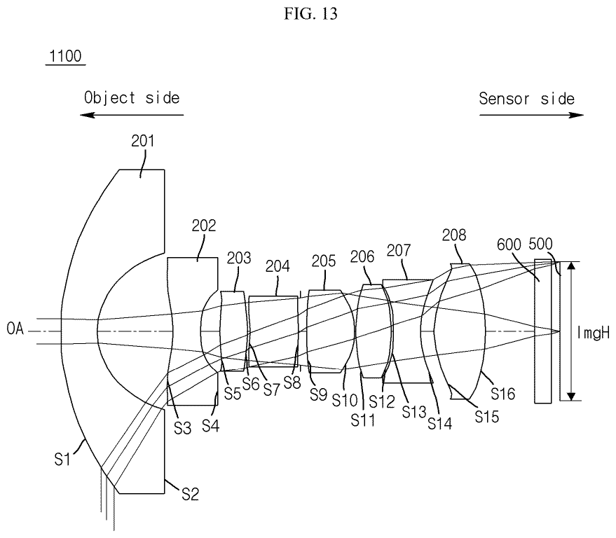

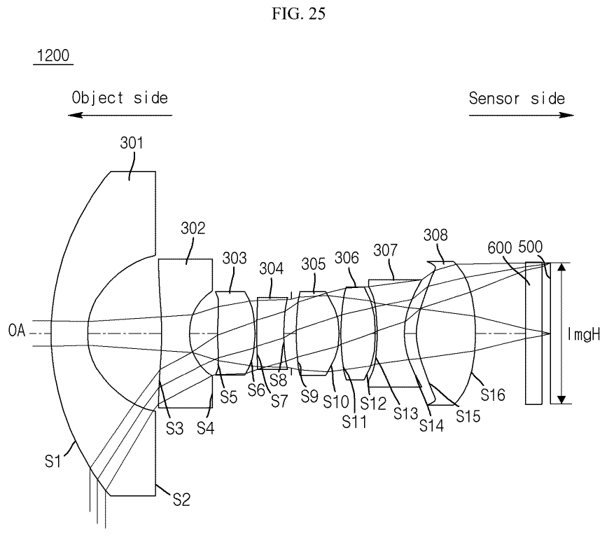

As shown in FIG. 1, FIG. 13, FIG. 25 and FIG. 37, the optical systems 1000, 1100, 1200 and 1300 according to a first to a fourth embodiments of the present invention may include seven or more lenses. The optical systems 1000, 1100, 1200 and 1300 and the camera module having the same may be mounted inside or outside a vehicle to monitor a driver or sense external objects or lanes. The material of the lenses may be selected from glass or plastic, and the linear expansion coefficient of glass is smaller than that of plastic. Accordingly, the glass lens is employed to suppress the change in the focal imaging position due to temperature change. However, the glass lens is expensive compared to the plastic lens, and there is a problem that it is difficult to meet the demand for low cost. Therefore, the lenses in the optical systems 1000, 1100, 1200 and 1300 are required to have a configuration in which the glass lens and the plastic lens are mixed. By employing these plastic lenses, the optical systems 1000, 1100, 1200 and 1300 can provide weight reduction and low cost by reducing the thickness of the plastic lenses, and can provide good correction for various aberrations such as spherical aberration and chromatic aberration due to the plastic lenses. In addition, since the plastic lenses can provide aspherical lenses, the distortion portion in the peripheral portion can be minimized.

The optical systems 1000, 1100, 1200 and 1300 may include n lenses, where the nth lens may be the last lens adjacent to the image sensor 500, and the (n−1)th lens may be the lens closest to the last lens. ‘n’ is an integer greater than or equal to 7, for example, 7 to 9. The n lenses may have a ratio of glass lenses to plastic lenses in a range of 2:6 to 3:5.

At least one lens closest to the object within the optical systems 1000, 1100, 1200 and 1300 may be made of glass. Two or fewer lenses closest to the object, for example, one lens, may be made of glass. Since the rate of contraction and expansion of lenses made of glass is smaller than that of lenses made of plastic due to temperature changes, lenses made of glass may be disposed in an area adjacent to the outside within the lens barrel.

At least one lens being disposed adjacent to the aperture STOP within the optical systems 1000, 1100, 1200 and 1300 may be made of glass. The lens being disposed closest to the aperture STOP on the sensor side of the aperture STOP may be made of glass. Since the lens being disposed adjacent to the aperture STOP is a lens with a large influence in the optical systems 1000, 1100, 1200 and 1300, the glass lens may be disposed so that the rate of change in contraction and expansion due to temperature change is small.

At least one lens closest to the image sensor 500 in the optical systems 1000, 1100, 1200 and 1300 may be made of plastic. For example, at least two lenses closest to the image sensor 500 may be made of plastic, and preferably, at least two lenses adjacent to the image sensor 500 may be made of plastic. That is, since the nth and (n−1)th lenses in the optical systems 1000, 1100, 1200 and 1300 are disposed as plastic lenses, various aberrations can be corrected for the incident light of the image sensor 500.

Within the optical systems 1000, 1100, 1200 and 1300, lenses made of plastic material can be disposed sequentially, and lenses made of glass material can be disposed sequentially. Within the optical systems 1000, 1100, 1200 and 1300, lenses made of plastic material can be disposed between lenses made of glass material. Within the optical systems 1000, 1100, 1200 and 1300, lenses made of glass material can be disposed between lenses made of plastic material.

Each of the lenses 101-108, 201-208, 301-308, and 401-408 can have an object side surface and a sensor side surface. The optical system can have more lenses with an aspherical sensor side surface and an aspherical object side surface than the number of plastic lenses. The optical system can have fewer lenses with a spherical sensor side surface and a spherical object side surface than the lenses with aspherical surfaces on both sides. The optical systems 1000, 1100, 1200 and 1300 have more aspherical lenses than spherical lenses, so it can correct various aberrations.

Among the lenses of the optical systems 1000, 1100, 1200 and 1300, a lens having a maximum refractive index can be positioned adjacent to an object. The maximum refractive index can be 1.7 or more. The chromatic dispersion of light incident by the lens having the maximum refractive index can be increased, and the center thickness can be made thinner than the edge thickness. In addition, since the lens having the maximum refractive index is disposed on the object side, it is easy to change the radius of curvature of the second and subsequent lenses, and the center thickness can be increased.

As shown in FIG. 1, FIG. 13, FIG. 25 and FIG. 37, the optical systems 1000, 1100, 1200 and 1300 according to first to fourth embodiments of the invention may include a plurality of lens groups LG1 and LG2. In detail, each of the plurality of lens groups LG1 and LG2 includes at least one lens. For example, the optical systems 1000, 1100, 1200 and 1300 may include a first lens group LG1 and a second lens group LG2 that are sequentially disposed along the optical axis OA from the object side toward the image sensor 500. The optical systems 1000, 1100, 1200 and 1300 may include n lenses, where the nth lens may be the last lens, and the (n−1)th lens may be the lens closest to the last lens. ‘n’ is an integer greater than or equal to 5, for example, 5 to 9.

The optical systems 1000, 1100, 1200 and 1300 may include a first lens group LG1 which is a plurality of lenses disposed on the object side with respect to the aperture STOP and a second lens group LG2 which is a plurality of lenses being disposed on the sensor side with respect to the aperture STOP. The number of lenses of each of the first lens group LG1 and the second lens group LG2 may be different. The number of lenses of the second lens group LG2 may be greater than the number of lenses of the first lens group LG1. Or, the number of lenses of the first lens group LG1 and the number of lenses of the second lens group LG2 may be the same.

The first lens group LG1 can include at least one lens. The first lens group LG1 can have four lenses or less. The first lens group LG1 can preferably have four lenses. The second lens group LG2 can include four or more lenses. The second lens group LG2 can have four lenses.

The composite focal length of the first lens group LG1 can be defined as F_LG1, and the composite focal length of the second lens group LG2 can be defined as F_LG2. The signs of F_LG1 and F_LG2 can be different from each other. F_LG1 has a negative (−) value and F_LG2 can have a positive (+) value. Through this, light can be spread from one of the two lens groups and then gathered from the remaining other lens group. The difference between the absolute value of the composite focal length F_LG1 of the first lens group LG1 and the absolute value of the composite focal length F_LG2 of the second lens group LG2 can satisfy a range of 1 to 3.

The aperture STOP may be disposed between the fourth lenses 104, 204, 304, and 404 and the fifth lenses 105, 205, 305, and 405, the first lens group LG1 may include the first to fourth lenses 101-104, 201-204, 301-304, and 401-404, and the second lens group LG2 may include the fifth to eighth lenses 105-108, 205-208, 305-308, and 405-408. The composite focal length of the first lens group LG1 has a minus (−) sign, and at least one of the first lenses 101, 201, 301, and 401, the second lenses 102, 202, 302, and 402, and the fourth lenses 104, 204, 304, and 404 can have the same focal length sign as that of the first lens group LG1. The Abbe number of the lens in the first lens group LG1 having the same sign as that of the composite focal length of the first lens group LG1 can be 40 or more. The Abbe numbers of the first lenses 101, 201, 301, and 401 and the second lenses 102, 202, 302, and 402 can be 40 or more. Through this, aberration of light passing through each lens can be removed. However, in exceptional cases, the Abbe number may be less than 40 for the fourth lenses 104, 204, 304, and 404 with low refractive power.

The composite focal length of the second lens group LG2 has a positive (+) sign, and at least one of the fifth lenses 105, 205, 305, and 405, the sixth lenses 106, 206, 306, and 406, and the eighth lenses 108, 208, 308, and 408 can have the same focal length sign as that of the second lens group LG2. The Abbe number of the lens in the second lens group LG2 having the same sign as that of the composite focal length of the second lens group LG2 can be 40 or greater. The Abbe number of at least one of the fifth lenses 105, 205, 305, and 405, the sixth lenses 106, 206, 306, and 406, and the eighth lenses 108, 208, 308, and 408 can be 40 or greater. Through this, aberrations of light passing through each lens can be eliminated. However, lenses with relatively low refractive power may have an Abbe number of 40 or less as an exception.

Within the optical systems 1000, 1100, 1200 and 1300, the lens with the maximum effective diameter can be disposed closest to the object side. The effective diameter of the lens can increase and then decrease as it moves from the object side to the sensor side. The effective diameter of the lens can decrease and then increase as it moves from the object side to the sensor side. Through this, since the light incident on the optical systems 1000, 1100, 1200 and 1300 is structured to gather toward the optical axis and then move away from an optical axis again, the optical systems 1000, 1100, 1200 and 1300 can form a stable optical path.

The effective diameter may be the diameter of the effective area on which effective light is incident from each lens. The effective diameter is the length in a direction (X, Y) orthogonal to the optical axis, and is the average of the effective diameter of the object side surface of each lens and the effective diameter of the sensor side surface. The “diameter of the lens surface” may mean the “effective diameter of the lens.” The “diameter of the lens” may be the diameter of the entire lens including the flange portion of the lens in addition to the effective area of the lens. Although the flange of the lens is not illustrated in FIGS. 1, 13, 25, and 37, the flange may be a portion being protruded in a direction perpendicular to the optical axis from the side surface of the lens so that the lens is coupled to the barrel. Effective light may not be incident on the flange. A spacer may be additionally disposed between the flanges of different lenses so that the lens is coupled to the barrel.

Each of the lenses 101-108, 201-208, 301-308, and 401-408 may include an effective area and an ineffective area. The effective area may be an area through which light incident on each of the lenses passes. In other words, the effective area may be defined as an effective area or effective diameter through which the incident light is refracted to implement optical characteristics. The ineffective area may be disposed around the effective area. The ineffective area may be an area through which effective light is not incident on a plurality of lenses. In other words, the ineffective area may be an area unrelated to the optical characteristics. In addition, an end portion of the ineffective area may be an area fixed to a lens barrel or the like that accommodates the lens.

Within the optical systems 1000, 1100, 1200 and 1300, the total top length (TTL) can be more than 5 times, for example, more than 6 times and less than 8 times, than Imgh. The total track length (TTL) is the distance from the center of the object side surface of the first lens to an upper surface of the image sensor 500 on the optical axis OA. Imgh is half the maximum diagonal length of the image sensor 500. Within the optical systems 1000, 1100, 1200 and 1300, the effective focal length (EFL) is provided to be more than 2 mm and less than 4 mm, and the angle of view (FOV) is provided to be more than 170 degrees and less than 190 degrees, so that the vehicle camera module can be provided as an optical system for monitoring the interior of a vehicle. For example, the optical system and the camera module according to the embodiment can be applied to a camera for an advanced driving assistance system (ADAS) being provided inside or outside a vehicle.

The optical systems 1000, 1100, 1200 and 1300 may have a condition of TTL/Imgh of 6 or more and 8 or less, for example, 1.7 or more and 2 or less. By setting the optical systems 1000, 1100, 1200 and 1300 to have the value of TTL/Imgh of 6 or more and 7 or less, a vehicle lens optical system can be provided. Accordingly, the optical systems 1000, 1100, 1200 and 1300 can provide an image without exaggeration or distortion for the image that is being formed.

An effective diameter of at least one plastic lens within the optical systems 1000, 1100, 1200 and 1300 may be smaller than the length of the image sensor 500. The effective diameter is the diameter or length of the effective area onto which light is incident. The length of the image sensor 500 is the maximum length of a diagonal line in a direction orthogonal to the optical axis OA. The number of lenses having an effective diameter larger than the length of the image sensor 500 within the optical systems 1000, 1100, 1200 and 1300 may be 10% or more and 20% or less, and the number of lenses having an effective diameter smaller than the length of the image sensor 500 may be 70% or more and 80% or less.

The lens unit can be a mixture of glass lenses and plastic lenses. The number of plastic lenses can be 70% or more of the total number of lenses, and can range from 65% to 85%. Accordingly, if more plastic lenses are disposed within the camera module, the weight of the camera module can be reduced, and the plastic material makes it easy to polish and process, is resistant to external impacts, has high price competitiveness, and is easy to secure materials. In addition, various aberrations can be corrected by the plastic lens, so that optical performance deterioration can be inhibited.

An embodiment of the invention can reduce the weight of a camera module by further mixing a plastic lens into an optical systems 1000, 1100, 1200 and 1300, can provide a lower manufacturing cost, can suppress deterioration of optical characteristics due to temperature change, various types of plastic lenses can replace glass lenses, and can facilitate polishing and processing of lens surfaces such as aspherical or free-form surfaces.

The effective diameter of the lens closest to the object side within the lens unit may be larger than the effective diameter of the lens closest to the image sensor 500. Accordingly, the brightness of the optical system can be controlled. The effective diameter may be an average effective diameter of the object side surface and the sensor side surface of each lens. By controlling the size of the effective diameter of each lens, the optical systems 1000, 1100, 1200 and 1300 can control the incident light to compensate for the deterioration of the optical characteristics due to resolution and temperature change, improve the chromatic aberration control characteristics, and improve the vignetting characteristics of the optical systems 1000, 1100, 1200 and 1300.

The lens unit may include first lenses 101, 201, 301, and 401, second lenses 102, 202, 302, and 402, third lenses 103, 203, 303, and 403, fourth lenses 104, 204, 304, and 404, fifth lenses 105, 205, 305, and 405, the sixth lenses 106, 206, 306, and 406, a seventh lenses 107, 207, 307, and 407, and an eighth lenses 108, 208, 308, and 408 aligned from the object side to the sensor side along an optical axis.

The lens unit may be disposed in a camera module having an inner barrel on one side or the entire inner surface of a lens barrel. The lens unit may be disposed in a camera module having a plurality of inner barrels around different lenses of the lens barrel. The lens unit may be disposed in a camera module having a first inner barrel in contact with an outer surface of at least one lens of the lens barrel and a second inner barrel in contact with an outer surface of at least one lens. The lens unit may be disposed in a camera module having a plurality of inner barrels each of which is disposed between an outer surface of at least one lens or two or more lenses and the lens barrel. The lens unit may be disposed in a camera module in which a plurality of inner barrels having a material different from a material of the lens barrel.

Among the lenses constituting the lens unit, at least some of the lenses made of glass may be disposed in the lens barrel, and at least some of the lenses made of plastic may be disposed in the inner barrel disposed within the lens barrel. Through this, the optical systems 1000, 1100, 1200 and 1300 can maintain resolution according to temperature change. The lens unit may be disposed in a camera module having different barrels to minimize decentering of a lens, for example, a plastic lens that expands according to temperature change. The lens barrel in which the lens unit is disposed has a plurality of inner barrels within the lens barrel, thereby maintaining the resolution of the optical system according to temperature change and suppressing deformation of the lenses. Therefore, the effective diameter of at least some of the lenses made of glass included in the lens unit may be smaller than the effective diameter of at least some of the lenses made of plastic.

Within the lens unit, there may be at least one lens, for example, at least two lenses, each of which is larger than the average effective diameter of the plastic lenses. When the average effective diameter of the plastic lenses is PLca_Aver and the average effective diameter of the glass lenses is GLca_Aver, the condition of PLca_Aver<GLca_Aver may be satisfied. In addition, the condition of 1<GLca_Aver/PLca_Aver<1.5 may be satisfied. In addition, the relationship between the length of the image sensor 500 and the average effective diameter PLca_Aver of the plastic lenses may satisfy the condition of 1<GLca_Aver/PLca_Aver<2. In addition, the relationship between the average effective diameter of the glass lens and the length of the image sensor 500 may satisfy the condition of 1≤PLca_Aver/Imgh<1.5. It may be disposed in that the difference between the maximum diagonal length of the image sensor 500 and the effective diameter of the plastic lens is not to be large. Accordingly, by arranging a plastic lens with a small effective diameter adjacent to the image sensor 500, the plastic lenses can disperse color from the center portion of the image sensor 500 to the edge portion.

The average effective diameter of the glass materials may be 8 mm or more, for example, in the range of 9 mm to 11 mm. The average effective diameter of the plastic material may be 4 mm or more, for example, in the range of 5 mm to 7 mm. The lens having the minimum effective diameter may be made of plastic, and the lens having the maximum effective diameter may be made of glass. The minimum effective diameter in the lens unit may be in the range of 4 mm to 5 mm, and the maximum effective diameter may be in the range of 11 mm to 15 mm. The plastic lens is designed to have a smaller effective diameter than the glass lens and is disposed so as not to touch the lens barrel, thereby minimizing changes in optical performance due to temperature changes. In addition, the optical systems 1000, 1100, 1200 and 1300 may improve resolution and chromatic aberration control characteristics by controlling incident light, and may improve vignetting characteristics of the optical systems 1000, 1100, 1200 and 1300.

The optical systems 1000, 1100, 1200 and 1300 or the camera module may include an image sensor 500. The image sensor 500 may detect light and convert the light into an electrical signal. The image sensor 500 may detect light sequentially passing through the lens unit. The image sensor 500 may include an element capable of detecting incident light, such as a charge coupled device (CCD) or a complementary metal oxide semiconductor (CMOS).

The optical systems 1000, 1100, 1200 and 1300 or the camera module may include a filter 600. The filter 600 may be disposed between the second lens group LG2 and the image sensor 500. The filter 600 may be disposed between the image sensor 500 and a lens closest to a sensor, among the lenses of the lens unit. For example, the filter 600 may be disposed between the nth lens and the image sensor 500.

The cover glass is disposed between the filter 600 and the image sensor 500, protects an upper portion of the image sensor 500, and may inhibit the reliability of the image sensor 500 from being deteriorated. The cover glass may be removed. The cover glass may be a protective glass.

The filter 600 may include an infrared filter or an infrared cut-off filter (IR cut-off). The filter 600 may allow light of a set wavelength band to pass through and filter out light of a different wavelength band. When the filter 600 includes an infrared filter, it may block radiant heat emitted from external light from being transmitted to the image sensor 500. Furthermore, the filter 600 may pass through visible light and reflect infrared light.

The optical systems 1000, 1100, 1200 and 1300 according to the embodiment may include an aperture Stop. The aperture may adjust the amount of light incident on the optical systems 1000, 1100, 1200 and 1300. In the lenses disposed between the object and the aperture, the effective diameter of the lens surfaces tends to increase from the object side to the aperture. In the lens surfaces disposed between the aperture and the sensor, the effective diameter of the lens surfaces tends to decrease from the aperture to the sensor side. The tendency for the effective diameter of the lens surfaces to increase or decrease does not only mean the case where the effective diameter of the lens surfaces increases or decreases. For example, it also includes the case where the effective diameter of the lens surfaces increases and then decreases as it goes from the aperture to the sensor side.

In the optical systems 1000, 1100, 1200 and 1300 of the embodiment, the sum of the refractive indices of the lenses of the lens unit may be 10 or more, for example, in the range of 11 to 14, and the average of the refractive indices may be in the range of 1.5 to 1.7. The sum of the Abbe numbers of each of the lenses may be 340 or more, for example, in the range of 345 to 360, and the average of the Abbe numbers may be 50 or less, for example, in the range of 40 to 45. The sum of the center thicknesses of the entire lens may be 15 mm or more, for example, in the range of 16 to 18 mm, and the average of the center thicknesses may be in the range of 1.8 to 2.2 mm. The sum of the central gaps between the lenses on an optical axis OA may be 5 mm or more, for example, in the range of 5.5 to 7 mm, and may be smaller than the sum of the center thicknesses of the lenses. In addition, the average value of the effective diameter of each of the lens surfaces S1 to S16 of the lens unit may be provided as 5 mm or more, for example, in the range of 6 to 8 mm.

In the optical systems according to the first to fourth embodiments of the invention, the F number may be 2 or less, for example, in the range of 1.7 to 1.9. The vehicle optical system may have a horizontal field of view FOV_H in a Y-axis direction that may be greater than 170 degrees and less than 190 degrees, for example, in the range of 175 degrees to 185 degrees. In addition, the vertical field of view may be provided at a smaller angle than the horizontal field of view. The vertical field of view FOV_V may be greater than 110 degrees and less than 120 degrees, for example, in the range of 110 degrees to 115 degrees. The sensor length in a horizontal direction Y may be 8.64 mm±0.5 mm, and the sensor height in a vertical direction X may be 5.58 mm±0.5 mm. The horizontal field of view FOV_H is the field of view with respect to the horizontal length of the image sensor, and the vertical field of view FOV_V is the field of view with respect to the vertical length of the image sensor. Accordingly, the focus position can be suppressed from changing due to temperature changes, and it can be provided as a vehicle camera in which various aberrations are well corrected.

An optical system being applied to a vehicle camera usually monitors the road conditions, so the optical system can be designed with respect to the horizontal angle of view rather than the entire angle of view. The optical system according to the present embodiment is designed with a certain margin with respect to the inscribed circle of the image sensor. The optical performance can be guaranteed in an area that satisfies the range of the horizontal angle of view (FOV_H.

Since the embodiment is an optical system being applied to a vehicle camera, the first lenses 101, 201, 301, and 401 may be provided as a glass material even though it is designed using a plastic lens and a glass lens together. This is because the glass material has the advantage of being scratch-resistant and insensitive to external temperature compared to the plastic material. The first lenses 101, 201, 301, and 401 may be a glass mold lens having an aspherical surface and made of glass material. The glass mold lens may be manufactured by placing an optical glass ingot inside a mold having an aspherical shape and through a heating and compression process.

In order to more effectively inhibit scratches caused by foreign substances or objects disposed inside a vehicle, a glass lens may be used as the first lenses 101, 201, 301, and 401, and the object-side surface of the first lenses 101, 201, 301, and 401 may have a gently curved shape so as not to come into contact with external structures. Through this, scratches caused by contact with external structures may be minimized. For driver monitoring, front/rear photographing of the vehicle, or lane detection and detection of objects around the vehicle while the vehicle is being driven, the angle of view may be more than 170 degrees and less than 190 degrees, and may be, for example, in the range of 175 degrees to 185 degrees. This horizontal angle of view may be a preset angle for an advanced driver assistance system (ADAS).

The optical systems 1000, 1100, 1200 and 1300 according to an embodiment may further include a reflective member for changing the path of light. The reflective member can be implemented as a prism that reflects incident light in the optical systems 1000, 1100, 1200 and 1300 toward the lenses. Hereinafter, an optical system according to the embodiment will be described in detail.

An optical system according to a first embodiment of the invention will be described.

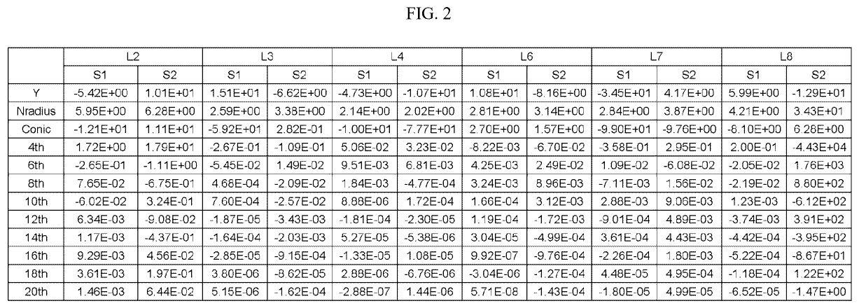

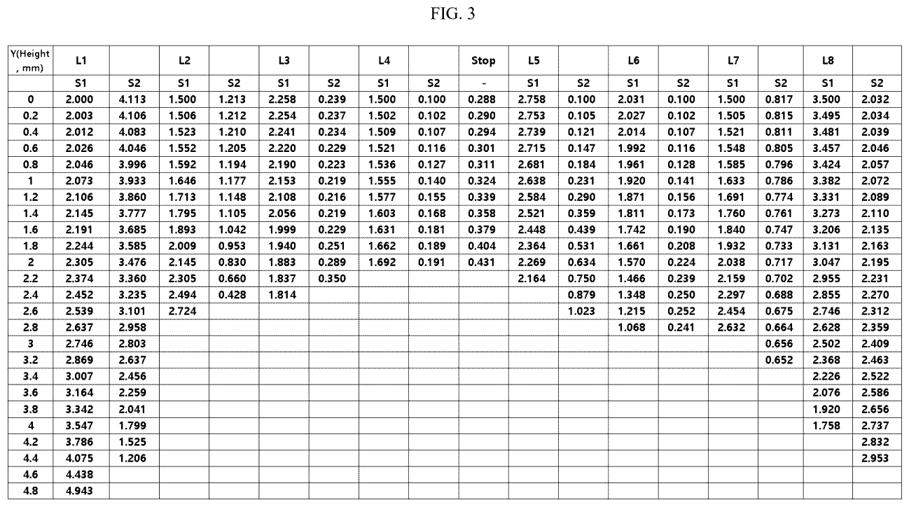

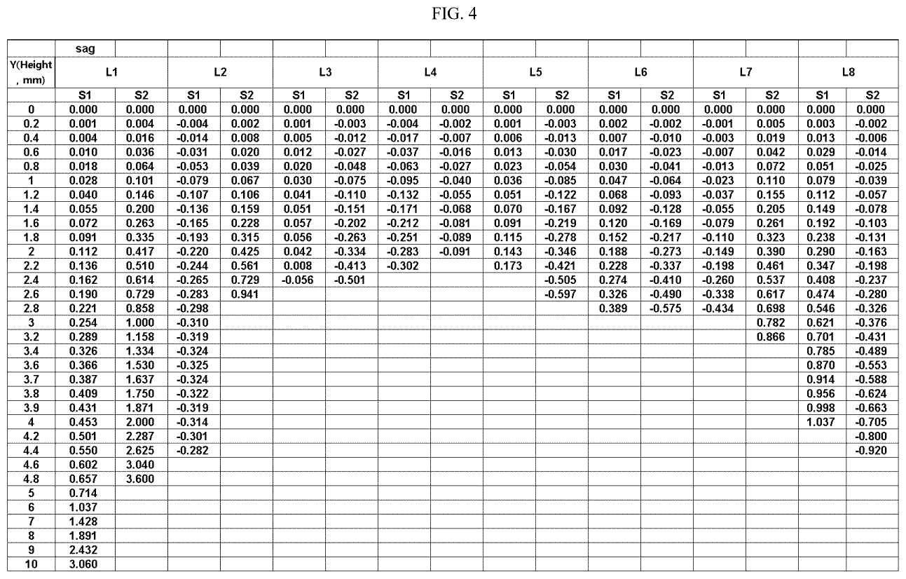

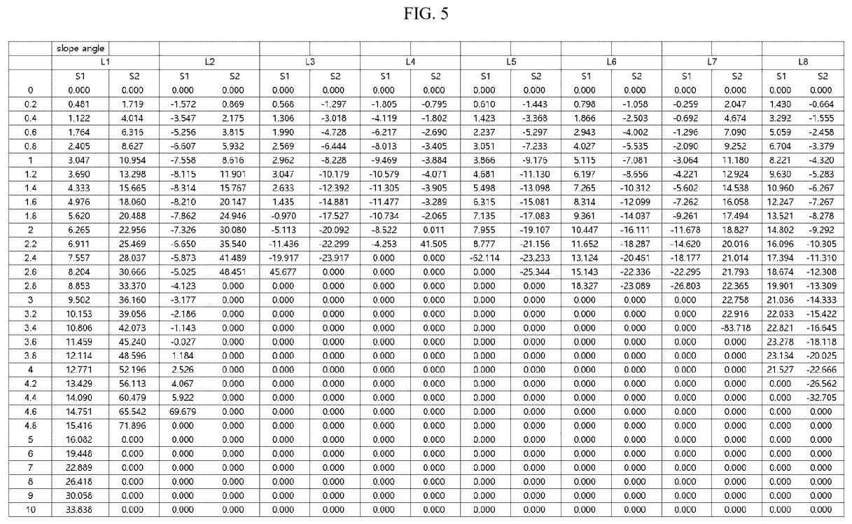

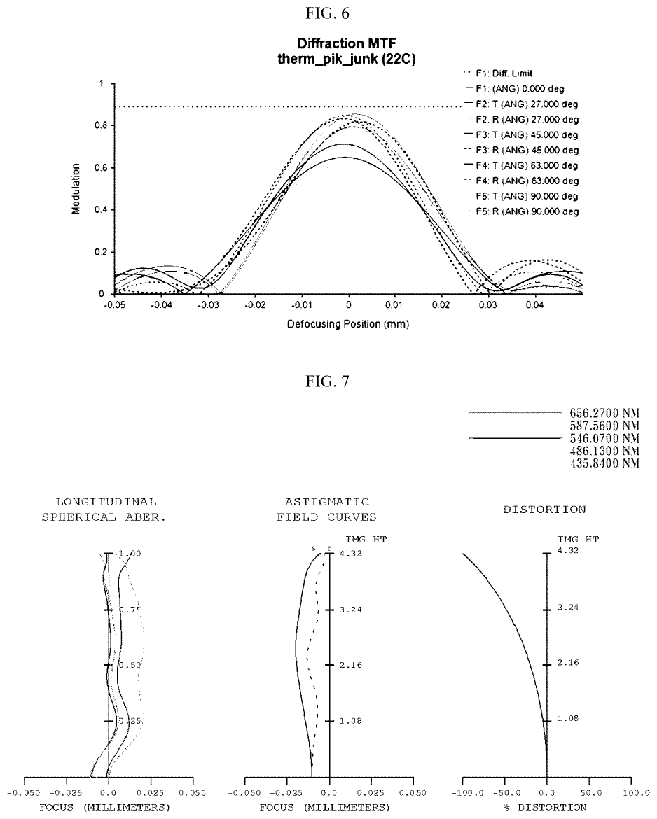

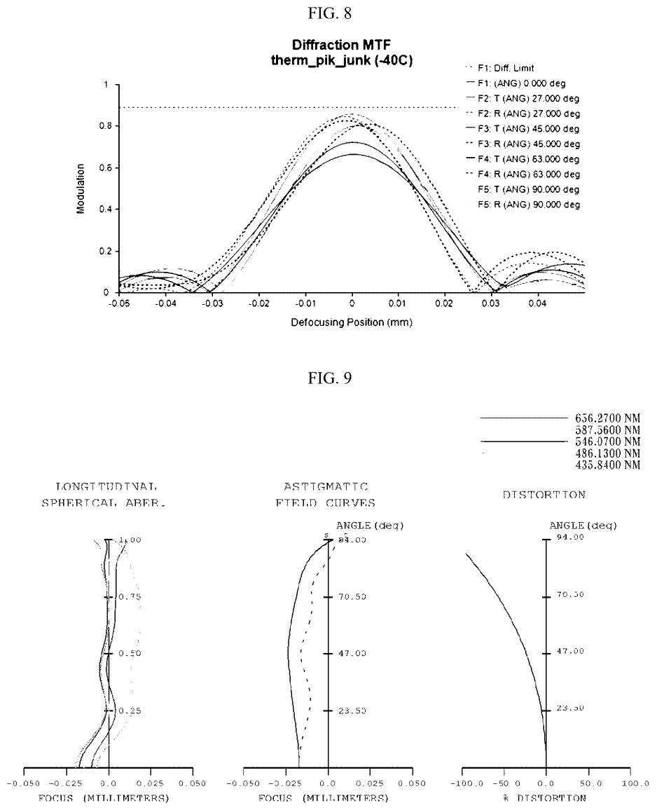

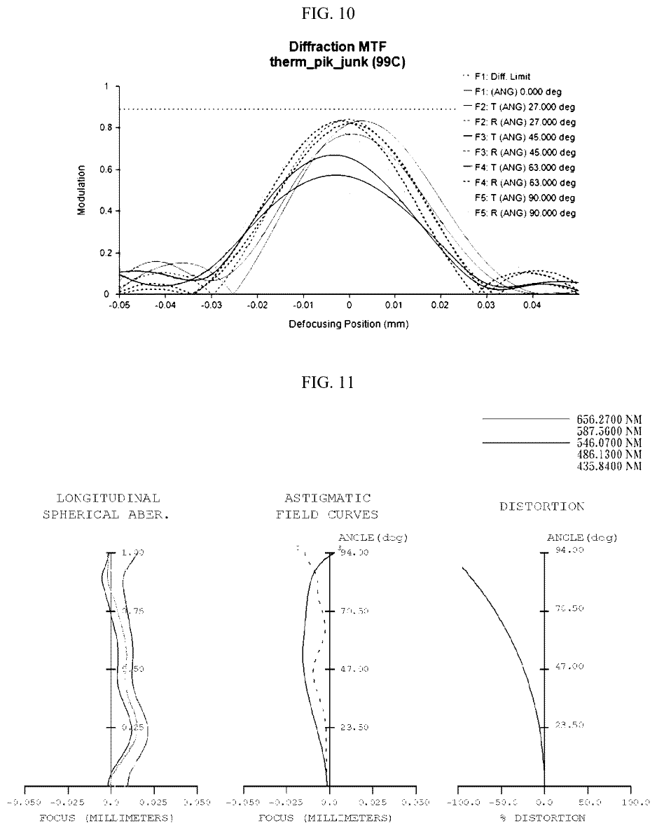

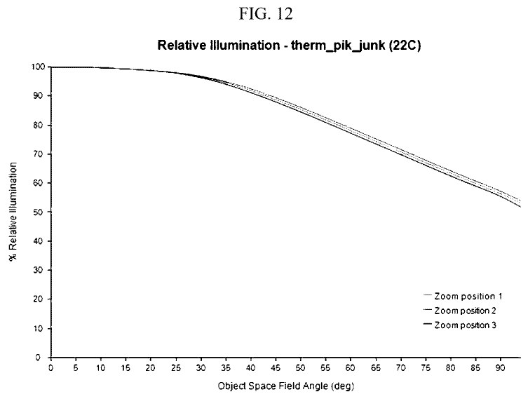

FIG. 1 is a side cross-sectional view of an optical system according to a first embodiment and a camera module having the same; FIG. 2 is a table showing the aspherical coefficients of lenses in an optical system of FIG. 1; FIG. 3 is a table showing the thickness of each lens and the gap between adjacent lenses in an optical system of FIG. 1; FIG. 4 is a table showing sag values of lens surfaces of the first to eighth lenses in an optical system of FIG. 1; FIG. 5 is a table showing slope angle values of lens surfaces of the first to eighth lenses in an optical system of FIG. 1; FIG. 6 is a graph showing data on the diffraction modulation transfer function (MTF) of an optical system of FIG. 1 at room temperature; FIG. 7 is a graph showing data on the aberration characteristics of an optical system of FIG. 1 at room temperature; FIG. 8 is a graph showing data on the aberration characteristics of an optical system of FIG. 1 at low temperature; FIG. 9 is a graph showing data on the aberration characteristics of an optical system of FIG. 1 at low temperature; FIG. 10 is a graph showing data on the diffraction MTF of an optical system of FIG. 1 at high temperature; FIG. 11 is a graph showing data on the aberration characteristics of an optical system of FIG. 1 at high temperature; and FIG. 12 is a graph showing the peripheral illumination ratio of an optical system.

Referring to FIG. 1, the optical system 1000 includes a lens unit, and the lens unit may include a first lens 101 to an eighth lens 108. The first to eighth lenses 101 to 108 may be sequentially disposed along an optical axis OA of the optical system 1000. Light corresponding to information about an object may pass through the first lens 101 to the eighth lens 108 and a filter 600 and be incident on an image sensor 500.

The first lens 101 can be disposed closest to the object side. The first lens 101 can be disposed farthest from the sensor side. The first lens 101 can have negative (−) refractive power on the optical axis OA. The first lens 101 can include a plastic material or a glass material, and can be, for example, a glass material. The first lens 101 made of a glass material can reduce changes in the center position and the radius of curvature due to temperature changes according to the surrounding environment, and can protect the incident side surface of the optical system 1000.

The first surface S1 on the object side of the first lens 101 with respect to an optical axis may be convex, and the second surface S2 on the sensor side may be concave. The first lens 101 may have a meniscus shape convex toward the object side. The first lens 101 may be made of glass and may have a spherical surface. At least one or both of the first surface S1 and the second surface S2 may be provided without a critical point from an optical axis OA to the end of the effective area.

Due to the refractive characteristics of the first lens 101, the second lens 102 can be further separated from the first lens 101. That is, the center spacing between the first and second lenses 101 and 102 can be the largest within the lens unit.

The refractive index n1 of the first lens 101 can satisfy the condition of n1>1.7 or n1>1.72. Since the refractive index n1 of the first lens 101 is the largest in the lens unit, the radius of curvature of the first and second lenses 101 and 102 can be increased, and lens manufacturing can be easy. If the refractive index n1 of the first lens 101 is smaller than the condition, the lens surface must be formed sharply concave or convex in order to increase the refractive power of the first and second lenses 101 and 102. In this case, lens manufacturing is not easy, the lens defect rate increases, and it can cause a decrease in yield.

The second lens 102 may be disposed second from the object side. The second lens 102 may be disposed seventh from the sensor side. The second lens 102 may be disposed between the first lens 101 and the third lens 103. The second lens 102 may have negative (−) refractive power on an optical axis OA. The second lens 102 may include a plastic or glass material. For example, the second lens 102 may be provided with a plastic material.

The object-side third surface S3 of the second lens 102 with respect to the optical axis OA is concave, and the sensor-side fourth surface S4 may be concave. The second lens 102 may have a concave shape on both surfaces. The second lens 102 is made of a plastic material and may be aspherical. At least one or both of the third surface S3 and the fourth surface S4 may be aspherical.

The aspherical coefficients of the third and fourth surfaces S3 and S4 may be provided as S1 and S2 of L2 in FIG. 2.

The third surface S3 of the second lens 102 may include a critical point from an optical axis OA to the end of the effective area. When the third surface S3 has a critical point, it may be located in a range of 75% to 85%, preferably 80% to 83%, of the effective radius r21 from an optical axis OA. The critical point of the third surface S3 may be located in a range of 3.5 mm to 4 mm, preferably 3.6 mm to 3.7 mm from an optical axis OA. The fourth surface S4 of the second lens 102 may be provided without a critical point from an optical axis OA to the end of the effective area.

The third lens 103 may be disposed third from the object side. The third lens 103 may be disposed sixth from the sensor side. The third lens 103 may be disposed between the second lens 102 and the fourth lens 104. The third lens 103 may have positive (+) refractive power on an optical axis OA. The third lens 103 may include a plastic or glass material. For example, the third lens 103 may be provided with a plastic material.

The object-side fifth surface S5 of the third lens 103 with respect to an optical axis may be convex, and the sensor-side sixth surface S6 may be convex. The third lens 103 may have a convex shape on both surfaces. The third lens 103 may be made of a plastic material and may be aspherical. At least one or both of the fifth surface S5 and the sixth surface S6 may be aspherical.

The aspherical coefficients of the fifth and sixth surfaces S5 and S6 may be provided as S5 and S6 of L3 in FIG. 2.

The fifth surface S5 of the third lens 103 may include a critical point from an optical axis OA to the end of the effective area. When the fifth surface S5 has a critical point, it may be located in a range of 65% to 75%, preferably in a range of 68% to 72.5%, of the effective radius r31 from an optical axis OA. The critical point of the fifth surface S5 may be located in a range of 1.5 mm to 2 mm, preferably in a range of 1.7 mm to 1.8 mm from an optical axis OA. The sixth surface S6 of the third lens 103 may be provided without a critical point from an optical axis OA to the end of the effective area.

The fourth lens 104 may be disposed fourth from the object side. The fourth lens 104 may be disposed fifth from the sensor side. The fourth lens 104 may be disposed between the third lens 103 and the fifth lens 105. The fourth lens 104 may have positive (+) or negative (−) refractive power on an optical axis OA. The fourth lens 104 may have negative (−) refractive power. The fourth lens 104 may include a plastic or glass material. For example, the fourth lens 104 may be provided with a plastic material.

The seventh surface S7 on the object side of the fourth lens 104 with respect to an optical axis may be concave, and the eighth surface S8 on the sensor side may be convex. The fourth lens 104 may have a convex meniscus shape toward the sensor side. The fourth lens 104 may have a concave meniscus shape toward the object side. The fourth lens 104 is made of a plastic material and may be aspherical. At least one or both of the seventh surface S7 and the eighth surface S8 may be aspherical. Aspherical coefficients of the seventh and eighth surfaces S7 and S8 may be provided as S1 and S2 of L4 of FIG. 2. At least one or both of the seventh surface S7 and the eighth surface S8 may be provided without a critical point from an optical axis OA to the end of the effective area.

The aperture Stop may be disposed around the sensor-side eighth surface S8 of the fourth lens 104. The aperture Stop may be disposed around the object-side ninth surface S9 of the fifth lens 105. The aperture may reduce the TTL within the field of view range, and miniaturization of the optical system may be possible. Accordingly, a decrease in the yield by weight of the optical system may be inhibited, and production efficiency may be enhanced. In addition, the optical system may be miniaturized by reducing the TTL at a horizontal field of view FOV_H of 170 degrees to 190 degrees.

The fifth lens 105 may be disposed as the fifth lens from the object side. The fifth lens 105 may be disposed as the fourth lens from the sensor side. The fifth lens 105 may be disposed between the fourth lens 104 and the sixth lens 106. The fifth lens 105 may have positive (+) or negative (−) refractive power on an optical axis OA. The fifth lens 105 may have positive (+) refractive power. The fifth lens 105 may include a plastic or glass material. For example, the fifth lens 105 may be provided as a glass material.

With respect to an optical axis OA, the ninth surface S9 on the object side of the fifth lens 105 may be convex, and the tenth surface S10 on the sensor side may be convex. The fifth lens 105 may have a shape in which both surfaces are convex. The fifth lens 105 is made of glass and may be spherical. At least one or both of the ninth surface S9 and the tenth surface S10 may be spherical. At least one or both of the ninth surface S9 and the tenth surface S10 may be provided without a critical point from an optical axis OA to the end of the effective area.

The sixth lens 106 may be disposed as the sixth lens from the object side. The sixth lens 106 may be disposed as the third lens from the sensor side. The sixth lens 106 may be disposed between the fifth lens 105 and the seventh lens 107. The sixth lens 106 may have positive (+) or negative (−) refractive power on an optical axis OA. The sixth lens 106 may have positive (+) refractive power. The sixth lens 106 may include a plastic or glass material. For example, the sixth lens 106 may be provided as a plastic material.

With respect to an optical axis OA, the object-side eleventh surface S11 of the sixth lens 106 may be convex, and the sensor-side twelfth surface S12 may be convex. The sixth lens 106 may have a convex shape on both surfaces. The sixth lens 106 may be made of a plastic material and may be aspherical. At least one or both of the eleventh surface S11 and the twelfth surface S12 may be aspherical. Aspherical coefficients of the eleventh and twelfth surfaces S11 and S12 may be provided as S1 and S2 of L6 of FIG. 2. At least one or both of the eleventh surface S11 and the twelfth surface S12 may be provided without a critical point from an optical axis OA to the end of the effective area.

The seventh lens 107 may be disposed seventh from the object side. The seventh lens 107 may be disposed second from the sensor side. The seventh lens 107 may be disposed between the sixth lens 106 and the eighth lens 108. The seventh lens 107 may have positive (+) or negative (−) refractive power on an optical axis OA. The seventh lens 107 may have negative (−) refractive power. The seventh lens 107 may include a plastic or glass material. For example, the seventh lens 107 may be provided with a plastic material.

With respect to an optical axis OA, the 13th surface S13 on the object side of the seventh lens 107 may be convex, and the 14th surface S14 on the sensor side may be convex. The seventh lens 107 may have a shape in which both surfaces are convex. The seventh lens 107 may be made of a plastic material and may be aspherical. At least one or both of the 13th surface S13 and the 14th surface S14 may be aspherical. Aspherical coefficients of the 13th and 14th surfaces S13 and S14 may be provided as S13 and S14 of L7 of FIG. 2. At least one or both of the 13th surface S13 and the 14th surface S14 may be provided without a critical point from an optical axis OA to the end of the effective area.

The eighth lens 108 may be disposed furthest from the object side. The eighth lens 108 may be disposed closest to the image sensor 500. The eighth lens 108 may have positive (+) or negative (−) refractive power on an optical axis OA. The eighth lens 108 may have positive (+) refractive power. The eighth lens 108 may include a plastic or glass material. For example, the eighth lens 108 may be provided with a plastic material.

With respect to an optical axis OA, the object-side 15th surface S15 of the eighth lens 108 may have a convex shape, and the sensor-side 16th surface S16 may have a convex shape. The eighth lens 108 may have a convex shape on both surfaces. At least one or both of the 15th surface S15 and the 16th surface S16 may be aspherical. The aspherical coefficients of the 15th and 16th surfaces S15 and S16 may be provided as S15 and S16 of L8 of FIG. 2. At least one or both of the 15th surface S15 and the 16th surface S16 may be provided without a critical point from an optical axis OA to the end of the effective area.

The eighth lens 108 may be a plastic lens that is closest to the image sensor 500. In addition, by arranging two or more plastic lenses adjacent to the image sensor 500, aberrations such as spherical aberration and chromatic aberration can be improved by the lens surface having an aspherical surface, and the influence on the resolution can be controlled. In addition, by arranging the plastic lens as the lens adjacent to the image sensor 500, it can be insensitive to the assembly tolerance compared to a glass lens. That is, being insensitive to the assembly tolerance means that the optical performance may not be significantly affected even if the assembly is slightly different from the design during assembly. In addition, by providing the two lenses 106 and 107 adjacent to the image sensor 500 as plastic, the optical performance can be improved by the lens surface having an aspherical surface, and for example, aberration characteristics can be improved and resolution deterioration can be inhibited.

TABLE 1

| | | | | | | Semi | Focal |
|---|---|---|---|---|---|---|---|
| Lens | Surface | Radius | Thickness | nd | vd | Aperture | length |
| 1 | S1 | 17.869 | 2.000 | 1.7762 | 49.6235 | 10.010 | −9.5959 |
| | S2 | 5.000 | 4.113 | | | 4.825 | |
| 2 | S3 | −5.423 | 1.500 | 1.5371 | 55.7074 | 4.583 | −6.3495 |
| | S4 | 10.077 | 1.213 | | | 2.602 | |
| 3 | S5 | 15.091 | 2.258 | 1.6679 | 20.3792 | 2.501 | 7.1907 |
| | S6 | −6.622 | 0.239 | | | 2.403 | |
| 4 | S7 | −4.735 | 1.500 | 1.6679 | 20.3792 | 2.200 | −14.1107 |
| | S8 | −10.722 | 0.100 | | | 2.155 | |
| | STOP | — | 0.288 | | | 2.157 | |
| 5 | S9 | 14.091 | 2.758 | 1.5521 | 75.4952 | 2.317 | 7.9748 |
| | S10 | −5.957 | 0.100 | | | 2.600 | |
| 6 | S11 | 10.780 | 2.031 | 1.5371 | 55.7074 | 2.800 | 8.9815 |
| | S12 | −8.156 | 0.100 | | | 2.875 | |
| 7 | S13 | −34.529 | 1.500 | 1.6679 | 20.3792 | 2.851 | −5.4903 |
| | S14 | 4.174 | 0.817 | | | 3.300 | |
| 8 | S15 | 5.992 | 3.500 | 1.5371 | 55.7074 | 4.047 | 8.1527 |
| | S16 | −12.948 | 2.032 | | | 4.418 | |
| Cover | | infinity | 0.900 | | | | |
| | | | 0.500 | | | | |
| Image | | infinity | 0.000 | | | | |

Table 1 shows the surface number Surface, radius of curvature Radius, center thickness of each lens or distance between lens surfaces Thickness, refractive index nd, Abbe number vd, effective radius Semi Aperture, and focal length Focal length of a lens according to a first embodiment of the present invention. At this time, the unit of the radius of curvature and thickness or distance may be mm.

TABLE 2

| Category | Value | Category | Value |
|---|---|---|---|
| F | 2.8720 | F-number | 1.8400 |
| ET1 | 2.6134 | FOV_H | 180.00 |
| ET2 | 2.6915 | EPD | 1.5609 |
| ET3 | 1.8530 | BFL | 0.5000 |
| ET4 | 1.7157 | TD | 26.9500 |
| ET5 | 1.9720 | ImgH | 4.32 |
| ET6 | 1.0371 | SD | 14.0266 |
| ET7 | 2.8601 | TTL | 27.4500 |
| ET8 | 1.5283 | GLca_Aver | 9.876 |
| ΣIndex | 12.9433 | PLca_Aver | 5.983 |
| ΣAbbe | 353.3785 | CT_max | 3.5000 |
| ΣCT | 17.0474 | CT_min | 1.5000 |
| ΣCG | 6.9702 | CT_Aver | 2.1309 |
| CA_max | 20.020 | F_LG1 | −5.958 |
| CA_min | 4.309 | F_LG2 | 6.210 |
| CA_Aver | 6.899 | | |

Table 2 shows categories of Mathematical expressions described above in the optical system 1000 of the embodiment, including the total track length (TTL) (mm), back focal length (BFL), effective focal length F (mm), ImgH (mm), effective diameter CA (mm), thickness (mm), TTL (mm), TD (mm), which is the optical axis distance from the first surface S1 to the sixteenth surface S16, sum of refractive indices, sum of Abbe numbers, sum of thicknesses (mm), sum of gaps between adjacent lenses, effective diameter characteristics, sum of refractive indices of glass lenses, sum of refractive indices of plastic materials, angle of view FOV_H (degree), edge thickness ET, F number, and the like of the optical system 1000.

The center thicknesses of the first to eighth lenses 101 to 108 are represented by CT1 to CT8, the edge thicknesses at the ends of the effective areas of each lens are represented by ET1 to ET8, the center gap between two adjacent lenses is represented by CG1 to CG7, and the edge gaps between the edges of each lens are represented by EG1 to EG7. Back focal length (BFL) is the optical axis distance from the image sensor 500 to the center of the last lens. TTL is the optical axis distance from the center of the first surface S1 of the first lens 101 to an upper surface of the image sensor 500.

As shown in FIG. 2, among the lenses of the lens unit in a first embodiment, the lens surfaces of the second, third, fourth, sixth, seventh, and eighth lenses 102, 103, 104, 106, 107, and 108 may include aspherical surfaces having a 30th order aspherical surface coefficient. For example, the second, third, fourth, sixth, seventh, and eighth lenses 102, 103, 104, 106, 107, and 108 may include lens surfaces having a 30th order aspherical surface coefficient. As described above, since the aspherical surface having the 30th order aspherical surface coefficient (a value other than “0”) can significantly change the aspherical shape of the peripheral portion, the optical performance of the peripheral portion of the field of view (FOV) can be well corrected.

The thicknesses T1 to T8 of the first to eighth lenses 101 to 108 and the gaps G1 to G7 between adjacent two lenses can be set. As shown in FIG. 3, the thicknesses T1 to T8 of each lens in a Y-axis direction can be expressed in a gap of 0.1 mm or 0.2 mm or more, and the gap G1 to G7 between each lens can be expressed in a gap of 0.1 mm or 0.2 mm or more.

When compared in terms of the absolute value of the radius of curvature of each lens, the radius of curvature of the 13th surface S13 of the seventh lens 107 on an optical axis OA may be the largest among the lenses, and the radius of curvature of the 14th surface S14 of the seventh lens 107 may be the smallest among the lenses. The difference between the maximum radius of curvature and the minimum radius of curvature may be 8 times or more, for example, in the range of 7.5 times to 8.5 times.

Since the effective diameter of a plastic lens is smaller than that of a glass lens, the lens disposed on the object side of a plastic lens can have strong refractive power in order to refract light through the plastic lens. In addition, the radius of curvature of the lens surface can be small in order to strengthen the refractive power.

The absolute value of the curvature radius of the first surface S1 of the first lens 101 may be greater than the absolute value of the curvature radius of the second surface S2. The absolute value of the curvature radius of the third surface S3 of the second lens 102 may be less than the absolute value of the curvature radius of the fourth surface S4. The absolute value of the curvature radius of the fifth surface S5 of the third lens 103 may be greater than the absolute value of the curvature radius of the sixth surface S6. The absolute value of the curvature radius of the seventh surface S7 of the fourth lens 104 may be less than the absolute value of the curvature radius of the eighth surface S8. The absolute value of the curvature radius of the ninth surface S9 of the fifth lens 105 may be greater than the absolute value of the curvature radius of the tenth surface S10. The absolute value of the curvature radius of the eleventh surface S11 of the sixth lens 106 may be greater than the absolute value of the curvature radius of the twelfth surface S12. The absolute value of the curvature radius of the thirteenth surface S13 of the seventh lens 107 may be greater than the absolute value of the curvature radius of the fourteenth surface S14. The absolute value of the curvature radius of the fifteenth surface S15 of the eighth lens 108 may be less than the absolute value of the curvature radius of the sixteenth surface S16.

The ratio of the radius of curvature of each lens can satisfy the following conditions.

$$3 < L 1 R 1 / L 1 R 2 \vert < 4 \qquad Condition 1$$

$$0.5 < \vert L 2 R 1 / L 2 R 2 \vert < 0.6 \qquad Condition 2$$

$$2 < \vert L 3 R 1 / L 3 R 2 \vert < 3 \qquad Condition 3$$

$$0.4 < L 4 R 1 / L 4 R 2 < 0.5 \qquad Condition 4$$

$$2 < \vert L 5 R 1 / L 5 R 2 \vert < 3 \qquad Condition 5$$

$$1 < \vert L 6 R 1 / L 6 R 2 \vert < 2 \qquad Condition 6$$

$$8 < \vert L 7 R 1 / L 7 R 2 \vert < 9 \qquad Condition 7$$

$$0.2 < L 8 R 1 / L 8 R 2 < 0.5 \qquad Condition 8$$

When explaining the center thickness CT of the lenses with respect to the optical axis, the center thickness CT8 of the eighth lens 108 is the largest among the lenses, and the center thickness CT2, CT4, and CT7 of at least one among the second lens 102, the fourth lens 104, and the seventh lens 107 is the smallest among the lenses. The difference between the maximum center thickness and the minimum center thickness among the lenses may be in the range of 2 mm or more and 2.5 mm or less. The center thickness of the eighth lens 108 disposed closest to the sensor side may be set to the largest so as to be suitable for the chief ray angle (CRA) of the image sensor 500.

The center thickness of each lens can satisfy any one among the conditions below.

$$CT 3 , CT 5 , CT 6 , CT 8 > CT 1 > CT 2 , CT 4 , CT 7 \qquad Condition 1$$

$$CT 1 , CT 3 , CT 5 , CT 6 , CT 8 > CT 2 = CT 4 = CT 7 \qquad Condition 2$$

$$CT 5 , CT 8 > CT 3 > CT 1 , CT 2 , CT 4 , CT 6 , CT 7 \qquad Condition 3$$

$$CT 8 > CT 5 > CT 1 , CT 2 , CT 3 , CT 4 , CT 6 , CT 7 \qquad Condition 4$$

$$CT 3 , CT 5 , CT 8 > CT 6 > CT 1 , CT 2 , CT 4 , CT 7 \qquad Condition 5$$

$$CT 8 > CT 1 , CT 2 , CT 3 , CT 4 , CT 5 , CT 6 , CT 7 \qquad Condition 6$$

When describing the center gap CG between the lenses, the center gap CG1 between the first lens 101 and the second lens 102 may be the maximum, and at least one among the center gap CG5 between the fifth and sixth lenses 105 and 106 and the center gap CG6 between the sixth and seventh lenses 106 and 107 may be the minimum. The difference between the maximum center gap and the minimum center gap among the lens gaps being spaced apart from one another may be 3 mm or more, for example, in the range of 3 mm to 4 mm.

The center gap between each lens can satisfy the conditions below.

$$CG 1 > CG 2 , CG 3 , CG 4 , CG 5 , CG 6 , CG 7 \qquad Condition 1$$

$$CG 1 > CG 2 > CG 3 , CG 4 , CG 5 , CG 6 , CG 7 \qquad Condition 2$$

$$CG 1 , CG 2 , CG 4 , CG 7 > CG 3 > CG 5 , CG 6 \qquad Condition 3$$

$$CG 1 , CG 2 , CG 7 > CG 4 > CG 3 , CG 5 , CG 6 \qquad Condition 4$$

$$CG 1 , CG 2 , CG 3 , CG 4 , CG 7 > CG 5 = CG 6 \qquad Condition 5$$

$$CG 1 , CG 2 > CG 7 > CG 3 , CG 4 , CG 5 , CG 6 \qquad Condition 7$$

When explaining the effective diameter, the lens having the maximum effective diameter may be a glass lens. The lens having the maximum effective diameter may be the first lens 101. Here, the effective diameter is an average of the effective diameter of the object side surface and the effective diameter of the sensor side surface of each lens. The lens surface having the maximum effective diameter may be the first surface S1 of the first lens 101.

The lens having the minimum effective diameter may be a lens disposed between the first lens 101 and the aperture STOP. The lens having the minimum effective diameter may be the fourth lens 104. The lens surface having the minimum effective diameter may be the eighth surface S8 of the fourth lens 104. The effective diameter of the lens made of a plastic material may be smaller than the effective diameter of the lens made of a glass material. The lens made of a plastic material may be disposed adjacent to the image sensor.

The effective diameter of each lens can satisfy any one among the conditions below.

$$CA\_L1 > CA\_L2 , CA\_L3 , CA\_L4 , CA\_L5 , CA\_L6 , CA\_L7 , CA\_L8 \qquad Condition 1$$

$$CA\_L1 , CA\_L8 > CA\_L2 > CA\_L3 , CA\_L4 , CA\_L5 , CA\_L6 , CA\_L7 \qquad Condition 2$$

$$CA\_L1 > CA\_L2 , CA\_L5 , CA\_L6 , CA\_L7 , CA\_L8 > CA\_L3 > CA\_L4 \qquad Condition 3$$

$$CA\_L1 > CA\_L2 , CA\_L3 , CA\_L5 , CA\_L6 , CA\_L7 , CA\_L8 > CA\_L4 \qquad Condition 4$$

$$CA\_L1 , CA\_L2 , CA\_L6 , CA\_L7 , CA\_L8 > CA\_L5 > CA\_L3 , CA\_L4 \qquad Condition 5$$

$$CA\_L1 , CA\_L2 , CA\_L7 , CA\_L8 > CA\_L6 > CA\_L3 , CA\_L4 , CA\_L5 \qquad Condition 6$$

$$CA\_L1 , CA\_L2 , CA\_L8 > CA\_L7 > CA\_L3 , CA\_L4 , CA\_L5 , CA\_L6 \qquad Condition 7$$

$$CA\_L1 > CA\_L8 > CA\_L2 , CA\_L3 , CA\_L4 , CA\_L5 , CA\_L6 , CA\_L7 \qquad Condition 8$$

When explaining the refractive index, the refractive index of the first lens 101 may be the largest among the lenses and may be greater than 1.7, for example, greater than 1.72. Any one or all among the second lens 102, the sixth lens 106, and the eighth lens 108 may have the smallest refractive index among the lenses. For example, the refractive indices among the second lens 102, the sixth lens 106, and the eighth lens 108 may be the smallest among the lenses and may be less than 1.6, for example, less than 1.55. The difference between the maximum refractive index and the minimum refractive index may be 0.2 or more. By providing a high refractive index lens made of glass closest to an object, and providing a lens adjacent to the glass lens and a lens adjacent to the image sensor 500 as a low refractive index lens made of plastic, the incidence efficiency can be increased, and the refractive power between the lenses made of glass and plastic can be adjusted to guide light to the image sensor 500.

The refractive index of each lens can satisfy any one among the conditions below.

$$n 1 > n 2 , n 3 , n 4 , n 5 , n 6 , n 7 , n 8 \qquad Condition 1$$

$$n 1 , n 3 , n 4 , n 5 , n 7 > n 2 = n 6 = n 8 \qquad Condition 2$$

$$n 1 > n 3 = n 4 = n 7 > n 2 , n 5 , n 6 , n 8 \qquad Condition 3$$

$$n 1 , n 3 , n 4 , n 7 > n 5 > n 2 , n 6 , n 8 \qquad Condition 4$$

When comparing the Abbe numbers, the Abbe number of the fifth lens 105 is the largest among the lenses, and may be 60 or more. The Abbe number of at least one among the third lens 103, the fourth lens 104, and the seventh lens 107 is the smallest among the lenses, and may be 25 or less. The difference between the maximum refractive index and the minimum Abbe number may be 50 or more. By making the Abbe number of the fifth lens 105 disposed at the center of the optical system 1000 the largest, and providing the Abbe number of the seventh lens 107 having a low refractive index adjacent to the image sensor 500 the smallest, the chromatic dispersion of light traveling between the lenses made of glass and plastic can be controlled, and the chromatic dispersion between the lenses made of glass and plastic can be increased to guide it to the image sensor 500.

The Abbe number of a lens can satisfy any one among the following conditions.

$$v 2 , v 5 , v 6 , v 8 > v 1 > v 3 , v 4 , v 7 \qquad Condition 1$$

$$v 5 > v 2 = v 6 = v 8 > v 1 , v 3 , v 4 , v 7 \qquad Condition 2$$

$$v 1 , v 2 , v 5 , v 6 , v 8 > v 3 = v 4 = v 7 \qquad Condition 3$$

$$v 5 > v 1 , v 2 , v 3 , v 4 , v 6 , v 7 , v 8 \qquad Condition 4$$

The focal lengths F1, F2, F4, and F7 of the first, second, fourth, and seventh lenses 101, 102, 104, and 107 may have negative (−) signs. The first, second, fourth, and seventh lenses 101, 102, 104, and 107 may have negative (−) refractive power. The focal lengths F3, F5, F6, and F8 of the third, fifth, sixth, and eighth lenses 103, 105, 106, and 108 may have positive (+) signs. The third, fifth, sixth, and eighth lenses 103, 105, 106, and 108 may have positive (+) refractive power. The third lens 103 having positive (+) refractive power may be disposed on the sensor side of the first lens 101 and the second lens 102 having negative (−) refractive power. Through this, light incident on the object side can move away from an optical axis direction and then gather again on an optical axis direction, thereby forming a stable optical path.

In addition, the sixth lens 106 and the seventh lens 107, which are adjacently disposed lenses, can satisfy the following conditions.

Refractive index of a lens with positive refractive power<Refractive index of a lens with negative refractive power Condition 1:

Dispersion value of a lens with positive refractive power>Dispersion value of a lens with negative refractive power Condition 2:

Here, among the plastic lenses, the sixth lens 106 has positive refractive power and the seventh lens 107 has negative refractive power, so that according to Conditions 1 and 2, the refractive index of the sixth lens 106 is smaller than that of the seventh lens 107, and the dispersion value of the sixth lens 106 is larger than that of the seventh lens 107. Chromatic aberration occurring in the plastic lens can be corrected by the plastic lens. In addition, since the sixth lens 106 and the seventh lens 107, which are plastic lenses being disposed in succession, satisfy the refractive index difference of 0.1 or more and 0.15 or less and the Abbe number difference of 20 or more and 50 or less, the chromatic aberration occurring in the plastic lens can be compensated for by the plastic lens.

The optical system has chromatic aberration, and chromatic aberration is corrected by using cemented lenses or two lenses disposed in succession. As the temperature changes from low to high, the lenses repeatedly contract and expand. Since the amount of change in lens characteristics according to the temperature change is the same for lenses of the same material, it is effective to correct chromatic aberration between lenses of the same material even when the temperature changes. Therefore, in a first embodiment of the present invention, chromatic aberration occurring in a plastic lens can be corrected by using the sixth lens 106 and the seventh lens 107.

From an optical axis to the effective diameter area, the maximum value of the distance between two lenses having the largest difference in Abbe numbers among two adjacent lenses may be smaller than the maximum value of the distance between the other two adjacent lenses. Here, the distance may mean the distance between the two lenses from an optical axis to the effective diameter area. The two lenses having the largest difference in Abbe numbers among two adjacent lenses may be the second lens 102 and the third lens 103, and the sixth lens 106 and the seventh lens 107. From an optical axis to the effective diameter area, in a direction perpendicular to the optical axis, the maximum value of the distance from the sensor side surface (the twelfth surface) S12 of the sixth lens 106 to the object side surface (the thirteenth surface) S13 of the seventh lens 107 may be smaller than the maximum value of the distance between the other two adjacent lenses. Through this, the distance between two lenses made of plastic material that is difficult to bond can be designed to be small, and the difference in Abbe numbers can be maximized to have the effect of reducing chromatic aberration to the same extent as a bonded lens even in a non-bonded state.

When comparing the focal lengths in absolute value, the focal length of the fourth lens 104 is the largest among the lenses, and may be 10 or more and 20 or less. The focal length of the seventh lens 107 is the smallest among the lenses, and the absolute value of the focal length of the seventh lens 107 may be 5 or more and 7 or less.

The absolute value of the focal length of each lens can satisfy any one among the conditions below.

$$\vert f 4 \vert > \vert f 1 \vert > \vert f 2 \vert , \vert f 3 \vert , \vert f 5 \vert , \vert f 6 \vert , \vert f 7 \vert , \vert f 8 \vert \qquad Condition 1$$

$$\vert f 1 \vert , \vert f 3 \vert , \vert f 4 \vert , \vert f 5 \vert , \vert f 6 \vert , \vert f 8 \vert > \vert f 2 \vert > \vert f 7 \vert \qquad Condition 2$$

$$\vert f 1 \vert , \vert f 4 \vert , \vert f 5 \vert , \vert f 6 \vert , \vert f 8 \vert > \vert f 3 \vert > \vert f 2 \vert , \vert f 7 \vert \qquad Condition 3$$

$$\vert f 4 \vert > \vert f 1 \vert , \vert f 2 \vert , \vert f 3 \vert , \vert f 5 \vert , \vert f 6 \vert , \vert f 7 \vert , \vert f 8 \vert \qquad Condition 4$$

$$\vert f 1 \vert , \vert f 4 \vert , \vert f 6 \vert , \vert f 8 \vert > \vert f 5 \vert > \vert f 2 \vert , \vert f 3 \vert , \vert f 7 \vert \qquad Condition 5$$

$$\vert f 1 \vert , \vert f 4 \vert > \vert f 6 \vert > \vert f 2 \vert , \vert f 3 \vert , \vert f 5 \vert , \vert f 7 \vert , \vert f 8 \vert \qquad Condition 6$$

$$\vert f 1 \vert , \vert f 2 \vert , \vert f 3 \vert , \vert f 4 \vert , \vert f 5 \vert , \vert f 6 \vert , \vert f 8 \vert > \vert f 7 \vert \qquad Condition 7$$

$$\vert f 1 \vert , \vert f 4 \vert , \vert f 6 \vert > \vert f 8 \vert > \vert f 2 \vert , \vert f 3 \vert , \vert f 5 \vert , \vert f 7 \vert \qquad Condition 8$$

The thickness T1 of the first lens 101 may be a difference of 1.1 times or more between the maximum thickness and the minimum thickness, for example, 1.2 times to 1.5 times, and the center thickness CT1 may be a minimum and the edge thickness ET1 may be a maximum. The thickness T2 of the second lens 102 may be a maximum thickness in a range of 1.5 times to 2 times the minimum thickness. The second lens 102 may be a minimum in the center thickness CT2 and the maximum in the edge thickness ET2. The thickness T3 of the third lens 103 may be a maximum at the center and a minimum at the edge, and the maximum thickness is in a range of 1.1 times to 1.5 times the minimum thickness. The thickness T4 of the fourth lens 104 may be a minimum at the center and a maximum at the edge, and the maximum thickness is in a range of 1.1 times to 1.5 times the minimum thickness. The thickness T5 of the fifth lens 105 may be maximum at the center and minimum at the edge and the maximum thickness is in a range of 1.1 to 1.5 times the minimum thickness. The thickness T6 of the sixth lens 106 may be maximum at the center and minimum at the edge and the maximum thickness is in a range of 1.5 to 2 times the minimum thickness. The thickness T7 of the seventh lens 107 may be minimum at the center and maximum at the edge and the maximum thickness is in a range of 1.5 to 2 times the minimum thickness. The thickness T8 of the eighth lens 108 may be maximum at the center and minimum at the edge and the maximum thickness is in a range of 2 to 2.5 times the minimum thickness.

The ratio of the center thickness to the edge thickness of each lens can be referred to as a ‘meat slice ratio’. When the ratio of the large and small values of the center thickness and the edge thickness satisfies 2 to 2.5, manufacturability of a lens can be improved and advantageous in terms of yield.

The thickness of each lens can satisfy any among the following conditions.

$$0.5 < CT 1 / ET 1 < 1 , 1 < ET 1 / CT 1 < 1.5 \qquad Condition 1$$

$$0.3 < CT 2 / ET 2 < 0.6 , 1.5 < ET 2 / CT2 < 2 \qquad Condition 2$$

$$1 < CT 3 / ET 3 < 1.5 , 0.5 < ET 3 / CT 3 < 1 \qquad Condition 3$$

$$0.5 < CT 4 / ET 4 < 1 , 1 < ET 4 / CT 4 < 1.5 \qquad Condition 4$$

$$1 < CT 5 / ET 5 < 1.5 , 0.5 < ET 5 / CT 5 < 1 \qquad Condition 5$$

$$1.5 < CT 6 / ET 6 < 2 , 0.3 < ET 6 / CT 6 < 0.8 \qquad Condition 6$$

$$0.5 < CT 7 / ET 7 < 1 , 1.5 < ET 7 / CT 7 < 2 \qquad Condition 7$$

$$2 < CT 8 / ET 8 < 2.5 , 0.1 < ET 8 / CT 8 < 0.5 \qquad Condition 8$$

$$1 < Σ CT / Σ ET < 1.2 , 0.5 < Σ ET / Σ CT < 1 \qquad Condition 9$$

Among the gaps G1 to G7 between the lenses, the first gap G1 between the first and second lenses 101 and 102 may have a maximum in the center portion and a minimum in the edge portion. The second gap G2 between the second and third lenses 102 and 103 may have a maximum in the center portion and a minimum in the edge portion. The third gap G3 between the third and fourth lenses 103 and 104 may have a maximum in the edge portion and a minimum in the center portion. The fourth gap G4 between the fourth and fifth lenses 104 and 105 may have a minimum in the center portion and a maximum in the edge portion. The fifth gap G5 between the fifth and sixth lenses 105 and 106 may have a minimum in the center portion and a maximum in the edge portion. The sixth gap G6 between the sixth and seventh lenses 106 and 107 may have a minimum in the center portion and a maximum in the edge portion. The seventh gap G7 between the seventh and eighth lenses 107 and 108 may be maximum at the center portion and minimum at the edge portion.

FIGS. 6, 8, and 10 are graphs illustrating a diffraction modulation transfer function (MTF) at room temperature, low temperature, and high temperature in the optical system of FIG. 1, illustrating a luminance ratio (modulation) according to a spatial frequency. As illustrated in FIGS. 6, 8, and 10, in a first embodiment of the present invention, a deviation of MTF to a low temperature or a high temperature with respect to room temperature may be less than 10%, that is, 7% or less.

FIGS. 7, 9, and 11 are graphs showing aberration characteristics at room temperature, low temperature, and high temperature in the optical system of FIG. 1. In the aberration graphs of FIGS. 7, 9, and 11, spherical aberration (longitudinal spherical aberration), astigmatic field curves, and distortion are measured from left to right. In FIGS. 7, 9, and 11, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 7, 9, and 11, it can be interpreted that the closer each curve at room temperature, low temperature, and high temperature is to the Y-axis, the better the aberration correction function is. It can be seen that the optical system 1000 according to a first embodiment has measurement values close to the Y-axis in almost all areas. That is, the optical system 1000 according to a first embodiment has improved resolution and can have good optical performance not only in the center of the field of view (FOV) but also in the periphery. Here, the low temperature is −20 degrees or lower, for example, in the range of −20 to −40 degrees, the room temperature is in the range of 22 degrees±5 degrees or in the range of 18 degrees to 27 degrees, and the high temperature can be in the range of 85 degrees or higher, for example, in the range of 85 degrees to 105 degrees. Accordingly, it can be seen that the decrease in the luminance ratio (modulation) from the low temperature to the high temperature of FIGS. 7, 9, and 11 is less than 10%, for example, 5% or lower, or is hardly changed.

Table 3 compares changes in optical characteristics such as EFL, BFL, F number F #, TTL, and field of view FOV_H at room temperature, low temperature, and high temperature in the optical system according to the first embodiment, and it can be seen that the change rate of the optical characteristics at low temperature is 5% or less, for example, 3% or less, with respect to room temperature, and it can be seen that the change rate of the optical characteristics at low temperature is 5% or less, for example, 3% or less, with respect to room temperature.

TABLE 3

| | Room | Low | High | Low/Room | High/Room |
|---|---|---|---|---|---|
| | temper- | temper- | temper- | temper- | temper- |
| | ature | ature | ature | ature | ature |
| EFL(F) | 2.87 | 2.85 | 2.90 | 99.30% | 101.04% |
| BFL | 3.43 | 3.43 | 3.44 | 100.00% | 100.29% |
| F# | 1.84 | 1.83 | 1.85 | 99.45% | 100.54% |
| TTL | 27.45 | 27.39 | 27.53 | 99.78% | 100.29% |
| FOV_H | 180.00 | 181.86 | 177.78 | 101.03% | 98.76% |

Therefore, as shown in Table 3, it can be seen that the changes in optical characteristics according to the temperature change from low temperature to high temperature, for example, the change rate of effective focal length (EFL), TTL, BFL, F number, and field of view FOV_H, are less than 10%, that is, less than 5%, for example, in the range of 0 to 5%. This makes it possible to design temperature compensation for plastic lenses even when using at least one or two or more plastic lenses, thereby inhibiting a decrease in the reliability of optical characteristics.

The optical system of the first embodiment disclosed above can effectively control aberration characteristics such as chromatic aberration and distortion aberration, and can have good optical performance not only at the center portion of the field of view (FOV) but also at the periphery portion.

An optical system according to a second embodiment of the invention will be described.

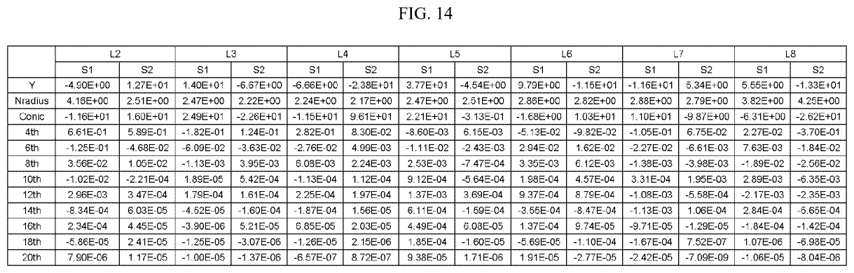

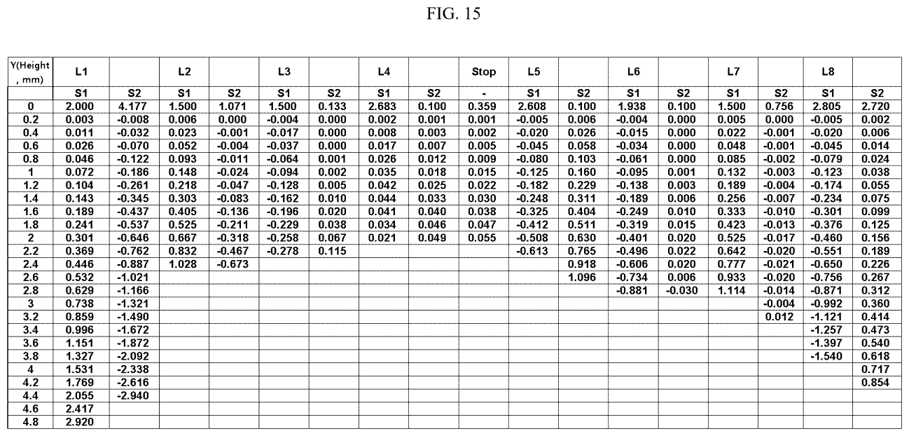

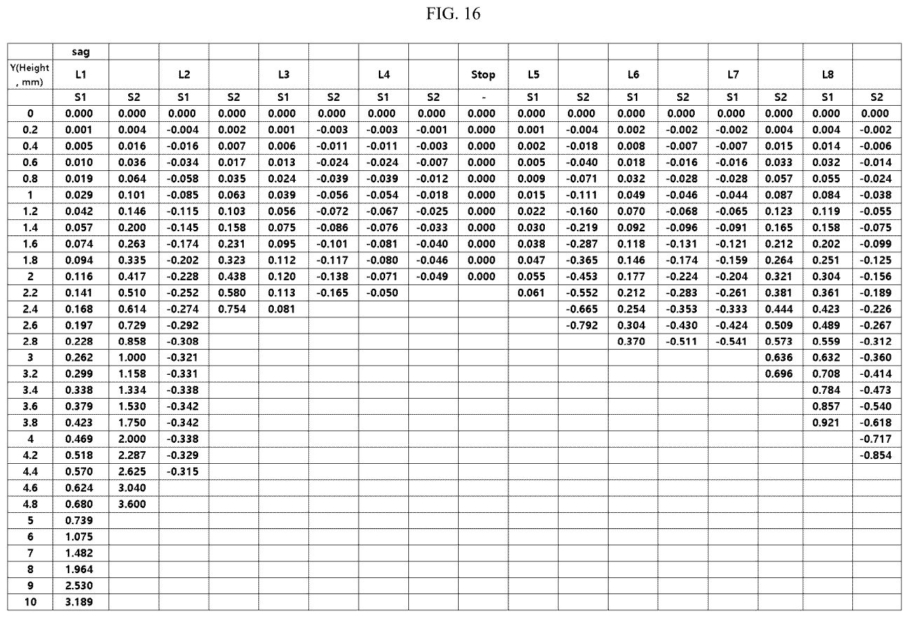

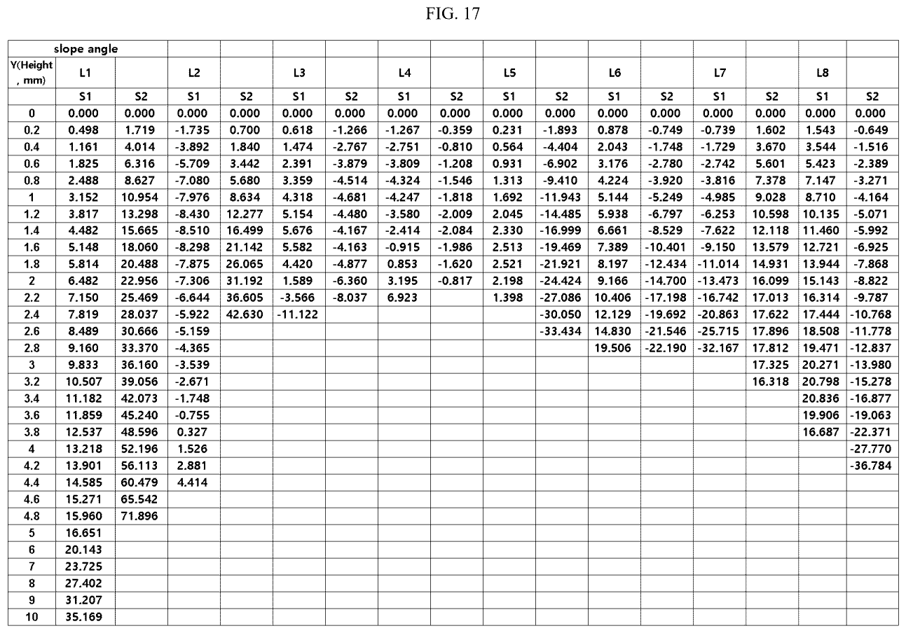

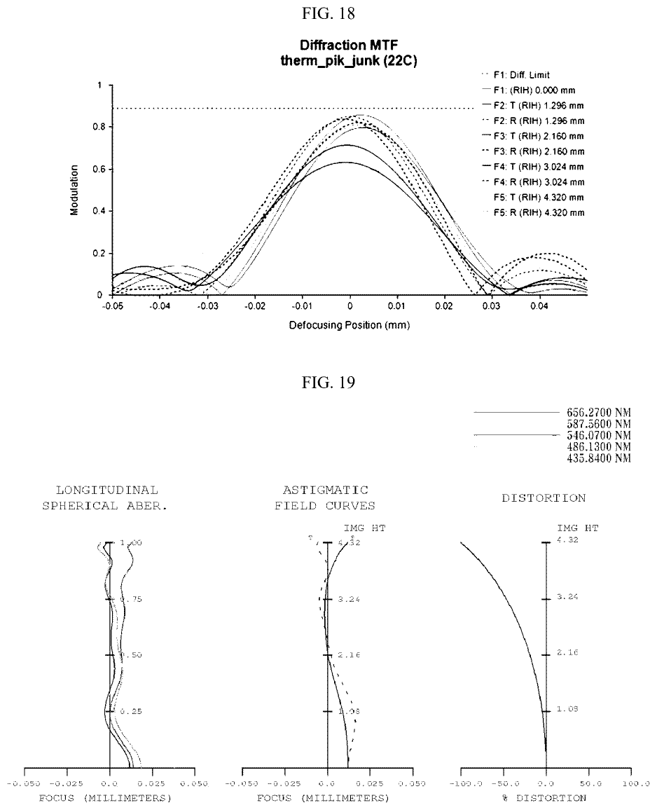

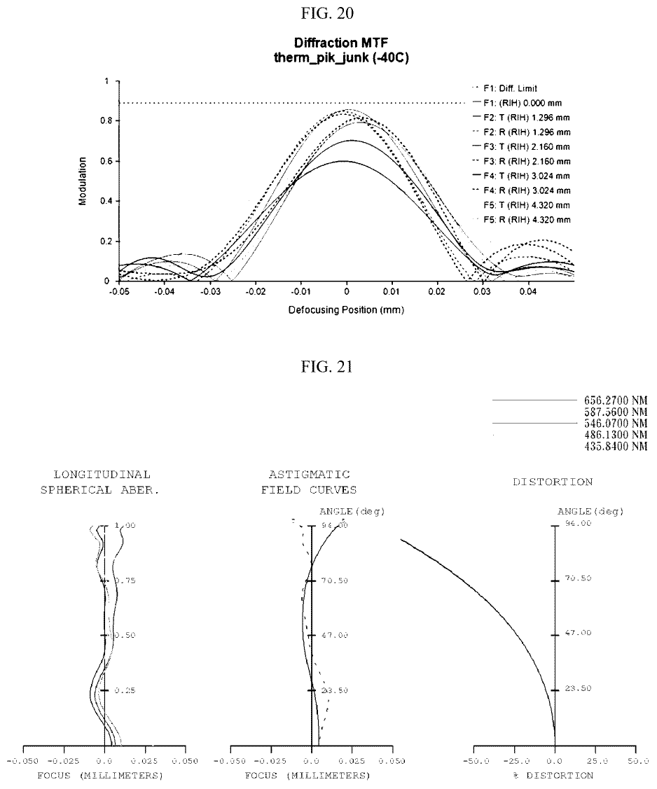

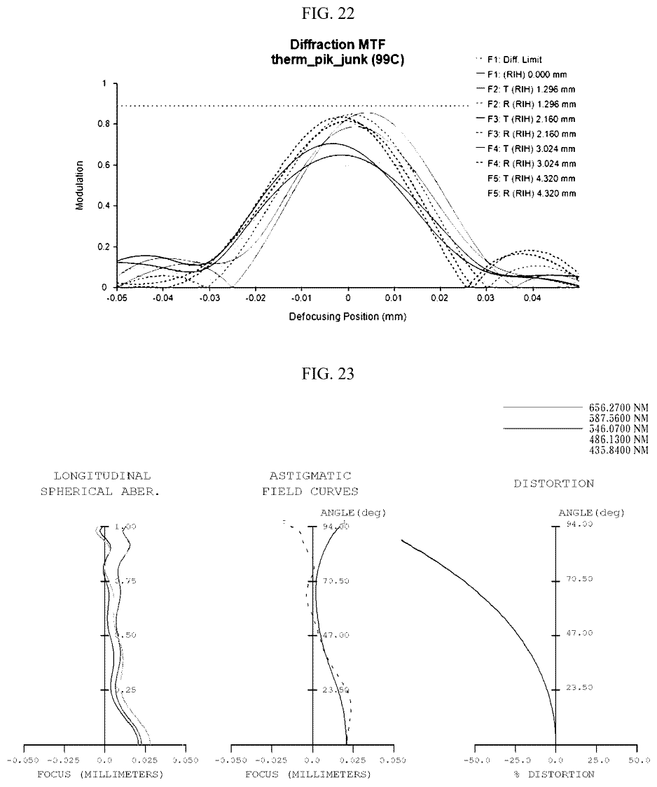

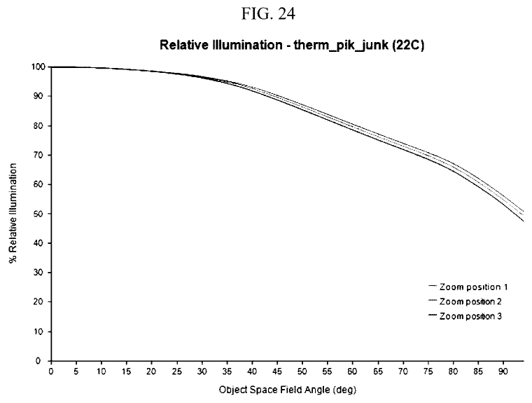

FIG. 13 is a side cross-sectional view of an optical system according to a second embodiment and a camera module having the same; FIG. 14 is a table showing aspherical coefficients of lenses in an optical system of FIG. 13; FIG. 15 is a table showing the thickness of each lens and the spacing between adjacent lenses in an optical system of FIG. 13; FIG. 16 is a table showing sag values of lens surfaces of a first to eighth lenses in an optical system of FIG. 13; FIG. 17 is a table showing slope angles of lens surfaces of a first to eighth lenses in an optical system of FIG. 13; FIG. 18 is a graph showing data on diffraction Modulation transfer function (MTF) of an optical system of FIG. 13 at room temperature; FIG. 19 is a graph showing data on aberration characteristics of an optical system of FIG. 13 at room temperature; FIG. 20 is a graph showing data on diffraction MTF of an optical system of FIG. 13 at low temperature; FIG. 21 is a graph showing data on the aberration characteristics of an optical system of FIG. 13 at low temperatures; FIG. 22 is a graph showing data on the diffraction MTF of an optical system of FIG. 13 at high temperatures; FIG. 23 is a graph showing data on the aberration characteristics of an optical system of FIG. 13 at high temperatures; and FIG. 24 is a graph showing the peripheral illumination ratio of an optical system of FIG. 13.

Referring to FIG. 13, the optical system 1100 includes a lens unit, and the lens unit may include a first lens 201 to an eighth lens 208. The first to eighth lenses 201 to 208 may be sequentially disposed along an optical axis OA of the optical system 1100. Light corresponding to information about an object may pass through the first lens 201 to the eighth lens 208 and a filter 600 and be incident on an image sensor 500.

The first lens 201 may be disposed closest to the object side. The first lens 201 may be disposed farthest from the sensor side. The first lens 201 may have negative (−) refractive power on an optical axis OA. The first lens 201 may include a plastic material or a glass material, and may be, for example, a glass material. The first lens 201 made of a glass material may reduce changes in the center position and the radius of curvature due to temperature changes according to the surrounding environment, and may protect the incident side surface of the optical system 1100.

The first surface S1 on the object side of the first lens 201 with respect to the optical axis may be convex, and the second surface S2 on the sensor side may be concave. The first lens 201 may have a meniscus shape convex toward the object side. The first lens 201 may be made of glass and may have a spherical surface. At least one or both of the first surface S1 and the second surface S2 may be provided without a critical point from an optical axis OA to the end of the effective area.

Due to the refractive characteristics of the first lens 201, the second lens 202 can be further separated from the first lens 201. That is, the center gap between the first and second lenses 201 and 202 can be the largest within the lens unit.

The refractive index n1 of the first lens 201 can satisfy the condition of n1>1.7 or n1>1.72. Since the refractive index n1 of the first lens 201 is the largest in the lens unit, the radius of curvature of the first and second lenses 201 and 202 can be increased, and lens manufacturing can be easy. If the refractive index n1 of the first lens 201 is smaller than the condition, the lens surface must be formed to be sharply concave or convex in order to increase the refractive power of the first and second lenses 201 and 202. In this case, lens manufacturing is not easy, the lens defect rate increases, and it can cause a decrease in yield.

The second lens 202 may be disposed second from the object side. The second lens 202 may be disposed seventh from the sensor side. The second lens 202 may be disposed between the first lens 201 and the third lens 203. The second lens 202 may have negative (−) refractive power on an optical axis OA. The second lens 202 may include a plastic or glass material. For example, the second lens 202 may be provided with a plastic material.

The object-side third surface S3 of the second lens 202 with respect to an optical axis OA is concave, and the sensor-side fourth surface S4 may be concave. The second lens 202 may have a concave shape on both surfaces. The second lens 202 is made of a plastic material and may be aspherical. At least one or both of the third surface S3 and the fourth surface S4 may be aspherical. The aspherical coefficients of the third and fourth surfaces S3 and S4 may be provided as S1 and S2 of L2 in FIG. 14.

The third surface S3 of the second lens 202 may include a critical point from an optical axis OA to the end of the effective area. When the third surface S3 has a critical point, it may be located in a range of 80% to 88%, preferably 82% to 85%, of the effective radius r21 from an optical axis OA. The critical point of the third surface S3 may be located in a range of 3.5 mm to 4 mm, preferably 3.7 mm to 3.8 mm from an optical axis OA. The fourth surface S4 of the second lens 202 may be provided without a critical point from an optical axis OA to the end of the effective area.

The third lens 203 may be disposed third from the object side. The third lens 203 may be disposed sixth from the sensor side. The third lens 203 may be disposed between the second lens 202 and the fourth lens 204. The third lens 203 may have positive (+) refractive power on an optical axis OA. The third lens 203 may include a plastic or glass material. For example, the third lens 203 may be provided with a plastic material.

The object-side fifth surface S5 of the third lens 203 with respect to an optical axis may be convex, and the sensor-side sixth surface S6 may be convex. The third lens 203 may have a convex shape on both surfaces. The third lens 203 may be made of a plastic material and may be aspherical. At least one or both of the fifth surface S5 and the sixth surface S6 may be aspherical. The aspherical coefficients of the fifth and sixth surfaces S5 and S6 may be provided as S5 and S6 of L3 of FIG. 14.

The fifth surface S5 of the third lens 203 may include a critical point from an optical axis OA to the end of the effective area. When the fifth surface S5 has a critical point, it may be located in a range of 80% to 90%, preferably 83% to 87%, of the effective radius r31 from an optical axis OA. The critical point of the fifth surface S5 may be located in a range of 1.8 mm to 2.2 mm, preferably 2 mm to 2.1 mm from an optical axis OA. The sixth surface S6 of the third lens 203 may be provided without a critical point from an optical axis OA to the end of the effective area.

The fourth lens 204 may be disposed fourth from the object side. The fourth lens 204 may be disposed fifth from the sensor side. The fourth lens 204 may be disposed between the third lens 203 and the fifth lens 205. The fourth lens 204 may have positive (+) or negative (−) refractive power on an optical axis OA. The fourth lens 204 may have negative (−) refractive power. The fourth lens 204 may include a plastic or glass material. For example, the fourth lens 204 may be provided with a plastic material.

The seventh surface S7 on the object side of the fourth lens 204 with respect to an optical axis may be concave, and the eighth surface S8 on the sensor side may be convex. The fourth lens 204 may have a convex meniscus shape toward the sensor side. The fourth lens 204 may have a concave meniscus shape toward the object side. The fourth lens 204 is made of a plastic material and may be aspherical. At least one or both of the seventh surface S7 and the eighth surface S8 may be aspherical. Aspherical coefficients of the seventh and eighth surfaces S7 and S8 may be provided as S1 and S2 of L4 of FIG. 14.

The seventh surface S7 of the fourth lens 204 may include a critical point from an optical axis OA to the end of the effective area. When the seventh surface S7 has a critical point, it may be located in a range of 75% to 85%, preferably in a range of 77% to 81%, of the effective radius r41 from an optical axis OA. The critical point of the seventh surface S7 may be located in a range of 1.5 mm to 2 mm, preferably in a range of 1.7 mm to 1.8 mm from an optical axis OA. The eighth surface S8 of the fourth lens 204 may be provided without a critical point from an optical axis OA to the end of the effective area.

The aperture Stop may be disposed around the sensor-side eighth surface S8 of the fourth lens 204. The aperture Stop may be disposed around the object-side ninth surface S9 of the fifth lens 205. The aperture may reduce the TTL within the field of view range, and may enable miniaturization of the optical system. Accordingly, a decrease in the yield by weight of the optical system may be inhibited, and production efficiency may be improved. In addition, the optical system may be miniaturized by reducing the TTL at a horizontal field of view FOV_H of 170 degrees to 190 degrees.

The fifth lens 205 may be disposed as the fifth lens from the object side. The fifth lens 205 may be disposed as the fourth lens from the sensor side. The fifth lens 205 may be disposed between the fourth lens 204 and the sixth lens 206. The fifth lens 205 may have positive (+) or negative (−) refractive power on an optical axis OA. The fifth lens 205 may have positive (+) refractive power. The fifth lens 205 may include a plastic or glass material. For example, the fifth lens 205 may be provided as a glass material.

With respect to an optical axis OA, the ninth surface S9 on the object side of the fifth lens 205 may be convex, and the tenth surface S10 on the sensor side may be convex. The fifth lens 205 may have a shape in which both surfaces are convex. The fifth lens 205 is made of glass and may be aspherical. At least one or both of the ninth surface S9 and the tenth surface S10 may be aspherical. Aspherical coefficients of the ninth and tenth surfaces S9 and S10 may be provided as S9 and S10 of L6 of FIG. 14. At least one or both of the ninth surface S9 and the tenth surface S10 may be provided without a critical point from an optical axis OA to the end of the effective area.

The sixth lens 206 may be disposed as the sixth lens from the object side. The sixth lens 206 may be disposed as the third lens from the sensor side. The sixth lens 206 may be disposed between the fifth lens 205 and the seventh lens 207. The sixth lens 206 may have positive (+) or negative (−) refractive power on an optical axis OA. The sixth lens 206 may have positive (+) refractive power. The sixth lens 206 may include a plastic or glass material. For example, the sixth lens 206 may be provided as a plastic material.

With respect to the optical axis OA, the object-side eleventh surface S11 of the sixth lens 206 may be convex, and the sensor-side twelfth surface S12 may be convex. The sixth lens 206 may have a convex shape on both surfaces. The sixth lens 206 may be made of a plastic material and may be aspherical. At least one or both of the eleventh surface S11 and the twelfth surface S12 may be aspherical. Aspherical coefficients of the eleventh and twelfth surfaces S11 and S12 may be provided as S1 and S2 of L6 of FIG. 14. At least one or both of the eleventh surface S11 and the twelfth surface S12 may be provided without a critical point from an optical axis OA to the end of the effective area.

The seventh lens 207 may be disposed seventh from the object side. The seventh lens 207 may be disposed second from the sensor side. The seventh lens 207 may be disposed between the sixth lens 206 and the eighth lens 208. The seventh lens 207 may have positive (+) or negative (−) refractive power on an optical axis OA. The seventh lens 207 may have negative (−) refractive power. The seventh lens 207 may include a plastic or glass material. For example, the seventh lens 207 may be provided with a plastic material.

With respect to an optical axis OA, the 13th surface S13 on the object side of the seventh lens 207 may be convex, and the 14th surface S14 on the sensor side may be convex. The seventh lens 207 may have a shape in which both surfaces are convex. The seventh lens 207 may be made of a plastic material and may be aspherical. At least one or both of the 13th surface S13 and the 14th surface S14 may be aspherical. Aspherical coefficients of the 13th and 14th surfaces S13 and S14 may be provided as S13 and S14 of L7 of FIG. 14. At least one or both of the 13th surface S13 and the 14th surface S14 may be provided without a critical point from an optical axis OA to the end of the effective area.

The eighth lens 208 may be disposed furthest from the object side. The eighth lens 208 may be disposed closest to the image sensor 500. The eighth lens 208 may have positive (+) or negative (−) refractive power on an optical axis OA. The eighth lens 208 may have positive (+) refractive power. The eighth lens 208 may include a plastic or glass material. For example, the eighth lens 208 may be provided with a plastic material.

With respect to the optical axis OA, the object-side 15th surface S15 of the eighth lens 208 may have a convex shape, and the sensor-side 16th surface S16 may have a convex shape. The eighth lens 208 may have a convex shape on both surfaces. At least one or both of the 15th surface S15 and the 16th surface S16 may be aspherical. The aspherical coefficients of the 15th and 16th surfaces S15 and S16 may be provided as S15 and S16 of L8 of FIG. 14. At least one or both of the 15th surface S15 and the 16th surface S16 may be provided without a critical point from the optical axis OA to the end of the effective area.

The eighth lens 208 may be a plastic lens that is closest to the image sensor 500. In addition, by arranging two or more plastic lenses adjacent to the image sensor 500, aberrations such as spherical aberration and chromatic aberration can be improved by the lens surface having an aspherical surface, and the influence on the resolution can be controlled. In addition, by arranging the plastic lens as the lens adjacent to the image sensor 500, it can be insensitive to the assembly tolerance compared to a glass lens. That is, being insensitive to the assembly tolerance means that even if the assembly is slightly different from the design during assembly, the optical performance may not be significantly affected. In addition, by providing the two lenses 207 and 208 adjacent to the image sensor 500 as plastic, the optical performance can be improved by the lens surface having an aspherical surface, and for example, aberration characteristics can be improved and resolution deterioration can be inhibited.

TABLE 4

| | | | | | | Semi | Focal |
|---|---|---|---|---|---|---|---|
| Lens | Surface | Radius | Thickness | nd | vd | Aperture | length |
| 1 | S1 | 17.275 | 2.000 | 1.7762 | 49.6235 | 10.000 | −9.7604 |
| | S2 | 5.000 | 4.177 | | | 4.829 | |
| 2 | S3 | −4.903 | 1.500 | 1.5371 | 55.7074 | 4.563 | −6.3941 |
| | S4 | 12.691 | 1.071 | | | 2.577 | |
| 3 | S5 | 13.991 | 1.500 | 1.6633 | 21.2414 | 2.475 | 7.0149 |
| | S6 | −6.673 | 0.133 | | | 2.285 | |
| 4 | S7 | −6.662 | 2.683 | 1.6633 | 21.2414 | 2.200 | −14.8925 |
| | S8 | −23.752 | 0.100 | | | 2.121 | |
| | STOP | — | 0.359 | | | 2.099 | |
| 5 | S9 | 37.724 | 2.608 | 1.5521 | 75.4952 | 2.250 | 7.4985 |
| | S10 | −4.536 | 0.100 | | | 2.600 | |
| 6 | S11 | 9.788 | 1.938 | 1.5371 | 55.7074 | 2.900 | 10.1569 |
| | S12 | −11.472 | 0.100 | | | 2.855 | |
| 7 | S13 | −11.624 | 1.500 | 1.6633 | 21.2414 | 2.834 | −5.3279 |
| | S14 | 5.339 | 0.756 | | | 3.200 | |
| 8 | S15 | 5.548 | 2.805 | 1.5371 | 55.7074 | 3.907 | 7.6823 |
| | S16 | −13.253 | 2.720 | | | 4.217 | |
| Cover | | infinity | 0.900 | | | | |
| | | | 0.500 | | | | |
| Image | | infinity | 0.000 | | | | |

Table 4 shows the surface number Surface, radius of curvature Radius, center thickness of each lens or distance between lens surfaces Thickness, refractive index nd, Abbe number vd, effective radius Semi Aperture, and focal length Focal length of the lens according to a second embodiment of the present invention. At this time, the unit of the radius of curvature and thickness or distance may be mm.

TABLE 5

| Category | Value | Category | Value |
|---|---|---|---|
| F | 2.8720 | F-number | 1.8400 |
| ET1 | 2.5086 | FOV_H | 180.00 |
| ET2 | 2.7373 | EPD | 1.5609 |
| ET3 | 1.2584 | BFL | 0.5000 |
| ET4 | 2.6839 | TD | 26.9500 |
| ET5 | 1.7502 | ImgH | 4.32 |
| ET6 | 1.0000 | SD | 13.7864 |
| ET7 | 2.7613 | TTL | 27.4500 |
| ET8 | 0.9999 | GLca_Aver | 9.840 |
| ΣIndex | 12.9295 | PLca_Aver | 5.882 |
| ΣAbbe | 355.9651 | CT_max | 2.8054 |
| ΣCT | 16.5347 | CT_min | 1.5000 |
| ΣCG | 6.7958 | CT_Aver | 2.0668 |
| CA_max | 20.000 | F_LG1 | −6.324 |
| CA_min | 4.198 | F_LG2 | 6.105 |
| CA_Aver | 6.813 | | |

Table 5 shows categories of Mathematical expressions described above in the optical system 1100 of the embodiment, including the total track length (TTL) (mm), back focal length (BFL), effective focal length F (mm), ImgH (mm), effective diameter CA (mm), thickness (mm), TTL (mm), TD (mm), which is the optical axis distance from the first surface S1 to the twelfth surface S12, sum of refractive indices, sum of Abbe numbers, sum of thicknesses (mm), sum of gaps between adjacent lenses, effective diameter characteristics, sum of refractive indices of glass lenses, sum of refractive indices of plastic materials, angle of view FOV_H (degree), edge thickness ET, F number, and the like of the optical system 1100.

The center thickness of the first to eighth lenses 201 to 208 is represented by CT1 to CT8, the edge thickness at the end of the effective area of each lens is represented by ET1 to ET8, the center gap between two adjacent lenses is represented by CG1 to CG7, and the edge gap between the edges of each lens is represented by EG1 to EG7. Back focal length (BFL) is the optical axis distance from the image sensor 500 to the center of the last lens. TTL is the optical axis distance from the center of the first surface S1 of the first lens 201 to the upper surface of the image sensor 500.

As illustrated in FIG. 14, among the lenses of the lens unit in a second embodiment, the lens surfaces of the second, third, fourth, fifth, sixth, seventh, and eighth lenses 202, 202, 204, 205, 206, 207, and 208 may include aspherical surfaces having a 30th order aspherical coefficient. For example, the second, third, fourth, fifth, sixth, seventh, and eighth lenses 202, 202, 204, 205, 206, 207, and 208 may include lens surfaces having a 30th order aspherical coefficient. As described above, since the aspherical surface having the 30th order aspherical coefficient (a value other than “0”) can significantly change the aspherical shape of the periphery, the optical performance of the periphery of the field of view (FOV) can be well corrected.

The thickness T1 to T8 of the first to eighth lenses 201 to 208 and the gap G1 to G7 between adjacent two lenses can be set. As shown in FIG. 3, the thickness T1 to T8 of each lens in a Y-axis direction can be expressed at gaps of 0.1 mm or 0.2 mm or more, and the gap G1 to G7 between each lens can be expressed at gaps of 0.1 mm or 0.2 mm or more.

When comparing the absolute values of the radius of curvature of each lens, the radius of curvature of the ninth surface S9 of the fifth lens 205 on an optical axis OA may be the largest among the lenses, and the radius of curvature of the fourteenth surface S14 of the seventh lens 207 may be the smallest among the lenses. The difference between the maximum radius of curvature and the minimum radius of curvature may be 8 times or more, for example, in the range of 7.5 times to 8.5 times.

Since the effective diameter of a plastic lens is smaller than that of a glass lens, the lens placed on the object side of a plastic lens can have strong refractive power in order to refract light through the plastic lens. In addition, the radius of curvature of the lens surface can be small in order to strengthen the refractive power.

The absolute value of the curvature radius of the first surface S1 of the first lens 201 may be greater than the absolute value of the curvature radius of the second surface S2. The absolute value of the curvature radius of the third surface S3 of the second lens 202 may be less than the absolute value of the curvature radius of the fourth surface S4. The absolute value of the curvature radius of the fifth surface S5 of the third lens 203 may be greater than the absolute value of the curvature radius of the sixth surface S6. The absolute value of the curvature radius of the seventh surface S7 of the fourth lens 204 may be less than the absolute value of the curvature radius of the eighth surface S8. The absolute value of the curvature radius of the ninth surface S9 of the fifth lens 205 may be greater than the absolute value of the curvature radius of the tenth surface S10. The absolute value of the curvature radius of the eleventh surface S11 of the sixth lens 206 may be smaller than the absolute value of the curvature radius of the twelfth surface S12. The absolute value of the curvature radius of the thirteenth surface S13 of the seventh lens 207 may be larger than the absolute value of the curvature radius of the fourteenth surface S14. The absolute value of the curvature radius of the fifteenth surface S15 of the eighth lens 208 may be smaller than the absolute value of the curvature radius of the sixteenth surface S16.

The ratio of the radius of curvature of each lens can satisfy the following conditions.

$$3 < L 1 R 1 / L 1 R 2 \vert < 4 \qquad Condition 1$$

$$0.2 < \vert L 2 R 1 / L 2 R 2 \vert < 0.5 \qquad Condition 2$$

$$2 < \vert L 3 R 1 / L 3 R 2 \vert < 2.5 \qquad Condition 3$$

$$0.1 < L 4 R 1 / L 4 R 2 < 0.4 \qquad Condition 4$$

$$8 < \vert L 5 R 1 / L 5 R 2 \vert < 9 \qquad Condition 5$$

$$0.5 < \vert L 6 R 1 / L 6 R 2 \vert < 4 \qquad Condition 6$$

$$2 < \vert L 7 R 1 / L 7 R 2 \vert < 3 \qquad Condition 7$$

$$0.3 < \vert L 8 R 1 / L 8 R 2 \vert < 0.5 \qquad Condition 8$$

When explaining the center thickness CT of the lenses with respect to the optical axis, the center thickness CT8 of the eighth lens 208 is the largest among the lenses, and the center thickness CT2, CT3, and CT7 of at least one of the second lens 202, the third lens 203, and the seventh lens 207 is the smallest among the lenses. The difference between the maximum center thickness and the minimum center thickness among the lenses may be in the range of 2 mm or more and 2.5 mm or less. The center thickness of the eighth lens 208 being disposed closest to the sensor side may be set to the largest so as to be suitable for the chief ray angle (CRA) of the image sensor 500.

The center thickness of each lens can satisfy any one among the following conditions.

$$Condition 1 : CT 4 , CT 5 , CT 8 > CT 1 > CT 2 , CT 3 , CT 6 , CT 7$$

$$Condition 2 : CT 1 , CT 4 , CT 5 , CT 6 , CT 8 > CT 2 = CT 3 = CT 7$$

$$Condition 3 : CT 8 > CT 4 > CT 1 , CT 2 , CT 3 , CT 5 , CT 6 , CT 7$$

$$Condition 4 : CT 4 , CT 8 > CT 5 > CT 1 , CT 2 , CT 3 , CT 6 , CT 7$$

$$Condition 5 : CT 1 , CT 4 , CT 5 , CT 8 > CT 6 > CT 2 , CT 3 , CT 7$$

$$Condition 6 \text{:} CT 8 > CT 1 , CT 2 , CT 3 , CT 4 , CT 5 , CT 6 , CT 7$$

When explaining the center gap CG between the lenses, the center gap CG1 between the first lens 201 and the second lens 202 may be the maximum, and at least one of the center gap CG5 between the fifth and sixth lenses 205 and 206 and the center gap CG6 between the sixth and seventh lenses 206 and 207 may be the minimum. The difference between the maximum center gap and the minimum center gap among the spaced lens gaps may be 3 mm or more, for example, in the range of 3 mm to 4 mm.

The center gap between each lens can satisfy the conditions below.

$$Condition 1 : CG 1 > CG 2 , CG 3 , CG 4 , CG 5 , CG 6 , CG 7$$

$$Condition 2 : CG 1 > CG 2 > CG 3 , CG 4 , CG 5 , CG 6 , CG 7$$

$$Condition 3 : CG 1 , CG 2 , CG 4 , CG 7 > CG 3 > CG 5 , CG 6$$

$$Condition 4 : CG 1 , CG 2 , CG 7 > CG 4 > CG 3 , CG 5 , CG 6$$

$$Condition 5 : CG 1 , CG 2 , CG 3 , CG 4 , CG 7 > CG 5 = CG 6$$

$$Condition 7 : CG 1 , CG 2 > CG 7 > CG 3 , CG 4 , CG 5 , CG 6$$

When explaining the effective diameter, the lens having the maximum effective diameter may be a glass lens. The lens having the maximum effective diameter may be the first lens 201. Here, the effective diameter is an average of the effective diameter of the object side surface and the effective diameter of the sensor side surface of each lens. The lens surface having the maximum effective diameter may be the first surface S1 of the first lens 201.

The lens having the minimum effective diameter may be a lens disposed between the first lens 201 and the aperture STOP. The lens having the minimum effective diameter may be the fourth lens 204. The lens surface having the minimum effective diameter may be the eighth surface S8 of the fourth lens 204. The effective diameter of the lens made of a plastic material may be smaller than the effective diameter of the lens made of a glass material. The lens made of a plastic material may be disposed adjacent to the image sensor.

The effective diameter of each lens can satisfy any one among the conditions below.

$$Condition 1 : CA\_L1 > CA\_L2 , CA\_L3 , CA\_L4 , CA\_L5 , CA\_L6 , CA\_L7 , CA\_L8$$

$$Condition 2 : CA\_L1 , CA\_L8 > CA\_L2 > CA\_L3 , CA\_L4 , CA\_L5 , CA\_L6 , CA\_L7$$

$$Condition 3 : CA\_L1 , CA\_L2 , CA\_L5 , CA\_L6 , CA\_L7 , CA\_L8 > CA\_L3 , CA\_L4$$

$$Condition 4 : CA\_L1 , CA\_L2 , CA\_L3 , CA\_L5 , CA\_L6 , CA\_L7 , CA\_L8 > CA\_L4$$

$$Condition 5 : CA\_L1 , CA\_L2 , CA\_L6 , CA\_L7 , CA\_L8 > CA\_L5 > CA\_L3 , CA\_L4$$

$$Condition 6 : CA\_L1 , CA\_L2 , CA\_L7 , CA\_L8 > CA\_L6 > CA\_L3 , CA\_L4 , CA\_L5$$

$$Condition 7 : CA\_L1 , CA\_L2 , CA\_L8 > CA\_L7 > CA\_L3 , CA\_L4 , CA\_L5 , CA\_L6$$

$$Condition 8 : CA\_L1 > CA\_L8 > CA\_L2 , CA\_L3 , CA\_L4 , CA\_L5 , CA\_L6 , CA\_L7$$

When explaining the refractive index of the first lens 201 may be the largest among the lenses and may be greater than 1.7, for example, greater than 1.72. One or both of the second lens 202, the sixth lens 206, and the eighth lens 208 may have the smallest refractive index among the lenses. For example, the refractive indices among the second lens 202, the sixth lens 206, and the eighth lens 208 may be the smallest among the lenses and may be less than 1.6, for example, less than 1.55. The difference between the maximum refractive index and the minimum refractive index may be 0.2 or more. By providing a high refractive index lens made of glass closest to an object, and providing a lens adjacent to the glass lens and a lens adjacent to the image sensor 500 as a low refractive index lens made of plastic, the incidence efficiency can be increased, and the refractive power between the lenses made of glass and plastic can be adjusted to guide light to the image sensor 500.

The refractive index of each lens can satisfy any one among the conditions below.

$$Condition 1 : n 1 > n 2 , n 3 , n 4 , n 5 , n 6 , n 7 , n 8$$

$$Condition 2 : n 1 , n 3 , n 4 , n 5 , n 7 > n 2 = n 6 = n 8$$

$$Condition 3 : n 1 > n 3 = n 4 = n 7 > n 2 , n 5 , n 6 , n 8$$

$$Condition 4 : n 1 , n 3 , n 4 , n 7 > n 5 > n 2 , n 6 , n 8$$

When comparing the Abbe numbers, the Abbe number of the fifth lens 205 is the largest among the lenses, and may be 60 or more. The Abbe number of at least one among the third lens 203, the fourth lens 204, and the seventh lens 207 is the smallest among the lenses, and may be 25 or less. The difference between the maximum refractive index and the minimum Abbe number may be 50 or more. By making the Abbe number of the fifth lens 205 disposed at the center of the optical system 1000 the largest, and providing the Abbe number of the seventh lens 207 having a low refractive index adjacent to the image sensor 500 the smallest, the chromatic dispersion of light traveling between the lenses made of glass and plastic can be controlled, and the chromatic dispersion between the lenses made of glass and plastic can be increased to guide it to the image sensor 500.

The Abbe number of a lens can satisfy any one among the following conditions.

$$Condition 1 : v 2 , v 5 , v 6 , v 8 > v 1 > v 3 , v 4 , v 7$$

$$Condition 2 : v 5 > v 2 = v 6 = v 8 > v 1 , v 3 , v 4 , v 7$$

$$Condition 3 : v 1 , v 2 , v 5 , v 6 , v 8 > v 3 = v 4 = v 7$$

$$Condition 4 : v 5 > v 1 , v 2 , v 3 , v 4 , v 6 , v 7 , v 8$$

The focal lengths F1, F2, F4, and F7 of the first, second, fourth, and seventh lenses 201, 202, 204, and 207 may have negative (−) signs. The first, second, fourth, and seventh lenses 201, 202, 204, and 207 may have negative (−) refractive power. The focal lengths F3, F5, F6, and F8 of the third, fifth, sixth, and eighth lenses 203, 205, 206, and 208 may have positive (+) signs. The third, fifth, sixth, and eighth lenses 203, 205, 206, and 208 may have positive (+) refractive power. The third lens 203 having positive (+) refractive power may be disposed on the sensor side of the first lens 201 and the second lens 202 having negative (−) refractive power. Through this, light incident on the object side can move away from an optical axis direction and then gather again on an optical axis direction, thereby forming a stable optical path.

In addition, the sixth lens 206 and the seventh lens 207, which are adjacently disposed lenses, can satisfy the following conditions.

Refractive index of a lens with positive refractive power<Refractive index of a lens with negative refractive power Condition 1:

Dispersion value of a lens with positive refractive power>Dispersion value of a lens with negative refractive power Condition 2:

Here, among the plastic lenses, the sixth lens 206 has positive refractive power and the seventh lens 207 has negative refractive power, so that according to Conditions 1 and 2, the refractive index of the sixth lens 206 is smaller than that of the seventh lens 207, and the dispersion value of the sixth lens 206 is larger than that of the seventh lens 207. Chromatic aberration occurring in the plastic lens can be corrected by the plastic lens. In addition, since the sixth lens 206 and the seventh lens 207, which are plastic lenses being disposed in succession, satisfy the refractive index difference of 0.1 or more and 0.15 or less and the Abbe number difference of 20 or more and 50 or less, the chromatic aberration occurring in the plastic lens can be compensated for by the plastic lens.

The optical system has chromatic aberration, and chromatic aberration is corrected by using cemented lenses or two lenses disposed in succession. As the temperature changes from low to high, the lenses repeatedly contract and expand. Since the amount of change in lens characteristics according to the temperature change is the same for lenses of the same material, it is effective to correct chromatic aberration between lenses of the same material even when the temperature changes. Therefore, in a first embodiment of the present invention, chromatic aberration occurring in a plastic lens can be corrected by using the sixth lens 206 and the seventh lens 207.

From an optical axis to the effective diameter area, the maximum value of the distance between two lenses having the largest difference in Abbe numbers among two adjacent lenses may be smaller than the maximum value of the distance between the other two adjacent lenses. Here, the distance may mean the distance between the two lenses from an optical axis to the effective diameter area. The two lenses having the largest difference in Abbe numbers among two adjacent lenses may be the second lens 202 and the third lens 203, and the sixth lens 206 and the seventh lens 207. From an optical axis to the effective diameter area, in a direction perpendicular to the optical axis, the maximum value of the distance from the sensor side surface (the twelfth surface) S12 of the sixth lens 206 to the object side surface (the thirteenth surface) S13 of the seventh lens 207 may be smaller than the maximum value of the distance between the other two adjacent lenses. Through this, the distance between two lenses made of plastic material that is difficult to bond can be designed to be small, and the difference in Abbe numbers can be maximized to have the effect of reducing chromatic aberration to the same extent as a bonded lens even in a non-bonded state.

When comparing the focal lengths in absolute value, the focal length of the fourth lens 204 is the largest among the lenses, and may be 10 or more and 20 or less. The focal length of the seventh lens 207 is the smallest among the lenses, and the absolute value of the focal length of the seventh lens 207 may be 5 or more and 7 or less.

The absolute value of the focal length of each lens can satisfy any one among the conditions below.

$$Condition 1 : \vert f 4 \vert > \vert f 1 \text{\textbar >} \vert f 2 \vert , \vert f 3 \vert , \vert f 5 \vert , \vert f 6 \vert , \vert f 7 \vert , \vert f 8 \vert$$

$$Condition 2 : \vert f 1 \vert , \vert f 3 \vert , \vert f 4 \vert , \vert f 5 \vert , \vert f 6 \vert , \vert f 8 \vert > \vert f 2 \vert > \vert f 7 \vert$$

$$Condition 3 : \vert f 1 \vert , \vert f 4 \vert , \vert f 5 \vert , \vert f 6 \vert , \vert f 8 \vert > \vert f 3 \vert > \vert f 2 \vert , \vert f 7 \vert$$

$$Condition 4 : \vert f 4 \vert > \vert f 1 \vert , \vert f 2 \vert , \vert f 3 \vert , \vert f 5 \vert , \vert f 6 \vert , \vert f 7 \vert , \vert f 8 \vert$$

$$Condition 5 : \vert f 1 \vert , \vert f 4 \vert , \vert f 6 \vert , \vert f 8 \vert > \vert f 5 \vert > \vert f 2 \vert , \vert f 3 \vert , \vert f 7 \vert$$

$$Condition 6 : \vert f 4 \vert > \vert f 6 \vert > \vert f 1 \vert , \vert f 2 \vert , \vert f 3 \vert , \vert f 5 \vert , \vert f 7 \vert , \vert f 8 \vert$$

$$Condition 7 : \vert f 1 \vert , \vert f 2 \vert , \vert f 3 \vert , \vert f 4 \vert , \vert f 5 \vert , \vert f 6 \vert , \vert f 8 \vert > \vert f 7 \vert$$

$$Condition 8 : \vert f 1 \vert , \vert f 4 \vert , \vert f 6 \vert > \vert f 8 \vert > \vert f 2 \vert , \vert f 3 \vert , \vert f 5 \vert , \vert f 7 \vert$$

The thickness T1 of the first lens 201 may be a difference of 1.1 times or more between the maximum thickness and the minimum thickness, for example, 1.2 times to 1.5 times, and the center thickness CT1 may be a minimum and the edge thickness ET1 may be a maximum. The thickness T2 of the second lens 202 may be a maximum thickness in a range of 1.5 times to 2 times the minimum thickness. The second lens 202 may be a minimum in the center thickness CT2 and the maximum in the edge thickness ET2. The thickness T3 of the third lens 203 may be a maximum at the center and a minimum at the edge, and the maximum thickness is in a range of 1.1 times to 1.5 times the minimum thickness. The thickness T4 of the fourth lens 204 may be a minimum at the center and a maximum at the edge, and the maximum thickness is in a range of 1.1 times to 1.5 times the minimum thickness. The thickness T5 of the fifth lens 205 may be maximum at the center and minimum at the edge and the maximum thickness is in a range of 1.1 to 1.5 times the minimum thickness. The thickness T6 of the sixth lens 206 may be maximum at the center and minimum at the edge and the maximum thickness is in a range of 1.5 to 2 times the minimum thickness. The thickness T7 of the seventh lens 207 may be minimum at the center and maximum at the edge and the maximum thickness is in a range of 1.5 to 2 times the minimum thickness. The thickness T8 of the eighth lens 208 may be maximum at the center and minimum at the edge and the maximum thickness is in a range of 2 to 2.5 times the minimum thickness.

The ratio of the center thickness to the edge thickness of each lens can be referred to as a ‘meat slice ratio’. When the ratio of the large and small values of the center thickness and the edge thickness satisfies 2 to 2.5, manufacturability of a lens can be improved and advantageous in terms of yield.

The thickness of each lens can satisfy any among the following conditions.

$$Condition 1 : 0.5 < CT 1 / ET 1 < 1 , 1 < ET 1 / CT 1 < 1.5$$

$$Condition 2 : 0.3 < CT 2 / ET 2 < 0.6 , 1.5 < ET 2 / CT 2 < 2$$

$$Condition 3 : 1 < CT 3 / ET 3 < 1.5 , 0.5 < ET 3 / CT 3 < 1$$

$$Condition 4 : 0.5 < CT 4 / ET 4 < 1 , 1 < ET 4 / CT 4 < 1.5$$

$$Condition 5 : 1 < CT 5 / ET 5 < 1.5 , 0.5 < ET 5 / CT 5 < 1$$

$$Condition 6 : 5 < CT 6 / ET 6 < 2 , 0.3 < ET 6 / CT 6 < 0.8$$

$$Condition 7 : 0.5 < CT 7 / ET 7 < 1.5 < ET 7 / CT 7 < 2$$

$$Condition 8 : 2.5 < CT 8 / ET 8 < 3 , 0.1 < ET 8 / CT 8 < 0. 5$$

$$Condition 9 : 1 < \sum CT / \sum ET < 1.2 , 0 \text{.5} < \sum ET / \sum CT < 1$$

Among the gaps G1 to G7 between the lenses, the first gap G1 between the first and second lenses 201 and 202 may have a maximum in the center portion and a minimum in the edge. The second gap G2 between the second and third lenses 202 and 203 may have a maximum in the center and a minimum in the edge. The third gap G3 between the third and fourth lenses 203 and 204 may have a maximum in the edge and a minimum in the center portion. The fourth gap G4 between the fourth and fifth lenses 204 and 205 may have a minimum in the center portion and a maximum in the edge. The fifth gap G5 between the fifth and sixth lenses 205 and 206 may have a minimum in the center portion and a maximum in the edge. The sixth gap G6 between the sixth and seventh lenses 206 and 207 may have a minimum in the center portion and a maximum in the edge. The seventh gap G7 between the seventh and eighth lenses 207 and 208 may be maximum at the center portion and minimum at the edge.

FIGS. 18, 20, and 22 are graphs illustrating a diffraction modulation transfer function (MTF) at room temperature, low temperature, and high temperature in the optical system of FIG. 13, illustrating a luminance ratio (modulation) according to a spatial frequency. As illustrated in FIGS. 18, 20, and 22, in a second embodiment of the present invention, a deviation of MTF to a low temperature or a high temperature with respect to room temperature may be less than 10%, that is, 7% or less.

FIGS. 19, 21, and 23 are graphs showing aberration characteristics at room temperature, low temperature, and high temperature in the optical system of FIG. 13. In the aberration graphs of FIGS. 19, 21, and 23, spherical aberration (longitudinal spherical aberration), astigmatic field curves, and distortion are measured from left to right. In FIGS. 19, 21, and 23, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 19, 21, and 23, it can be interpreted that the closer each curve at room temperature, low temperature, and high temperature is to a Y-axis, the better the aberration correction function is. It can be seen that the optical system 1100 according to a second embodiment has measurement values close to a Y-axis in almost all areas. That is, the optical system 1100 according to a second embodiment has improved resolution and can have good optical performance not only in the center portion of the field of view (FOV) but also in the periphery portion. Here, the low temperature is −20 degrees or lower, for example, in the range of −20 to −40 degrees, the room temperature is in the range of 22 degrees±5 degrees or in the range of 18 degrees to 27 degrees, and the high temperature can be 85 degrees or higher, for example, in the range of 85 degrees to 205 degrees. Accordingly, it can be seen that the decrease in the modulation from low to high temperature in FIGS. 19, 21 and 23 is less than 10%, for example, less than 5%, or is almost unchanged.

Table 6 compares changes in optical characteristics such as EFL, BFL, F number F #, TTL, and field of view FOV_H at room temperature, low temperature, and high temperature in the optical system according to a second embodiment, and it can be seen that the change rate of the optical characteristics at low temperature is 5% or less, for example, 3% or less, with respect to room temperature, and it can be seen that the change rate of the optical characteristics at low temperature is 5% or less, for example, 3% or less, with respect to room temperature.

TABLE 6

| | Room | Low | High | Low/Room | High/Room |
|---|---|---|---|---|---|
| | temper- | temper- | temper- | temper- | temper- |
| | ature | ature | ature | ature | ature |
| EFL(F) | 2.87 | 2.85 | 2.90 | 99.30% | 101.04% |
| BFL | 4.12 | 4.11 | 4.13 | 99.75% | 100.24% |
| F# | 1.84 | 1.83 | 1.85 | 99.45% | 100.54% |
| TTL | 27.45 | 27.39 | 27.53 | 99.78% | 100.29% |
| FOV H | 180.00 | 182.00 | 177.61 | 101.11% | 98.67% |

Therefore, as shown in Table 6, it can be seen that the changes in optical characteristics according to the temperature change from low temperature to high temperature, for example, the change rate of effective focal length (EFL), TTL, BFL, F number, and field of view FOV_H, are less than 10%, that is, less than 5%, for example, in the range of 0 to 5%. This makes it possible to design temperature compensation for plastic lenses even when using at least one or two or more plastic lenses, thereby inhibiting a decrease in the reliability of optical characteristics.

The optical system of a second embodiment disclosed above can effectively control aberration characteristics such as chromatic aberration and distortion aberration, and can have good optical performance not only at the center portion of the field of view (FOV) but also at the periphery portion.

An optical system according to a third embodiment of the invention will be described.

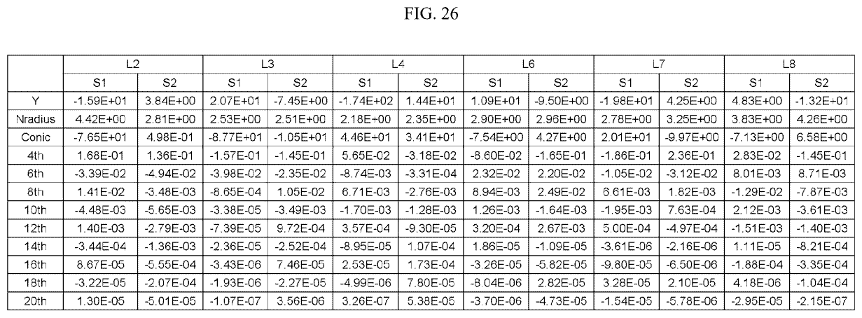

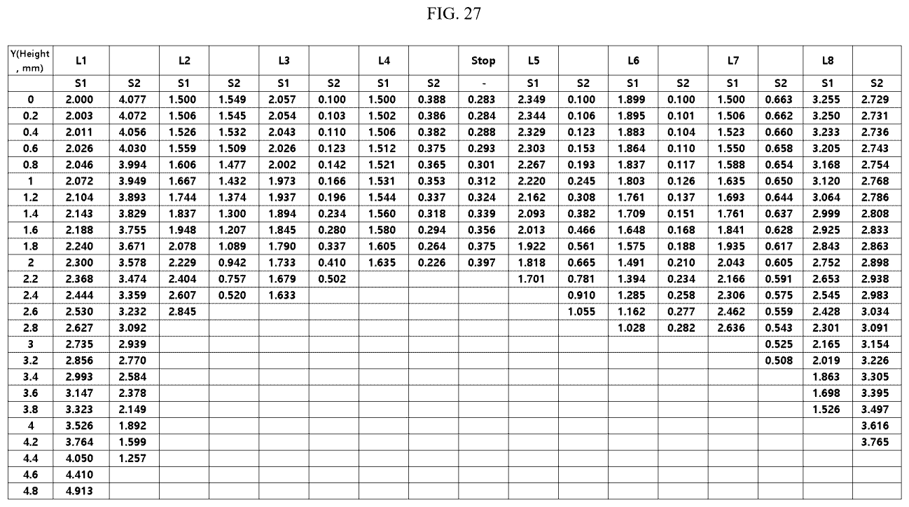

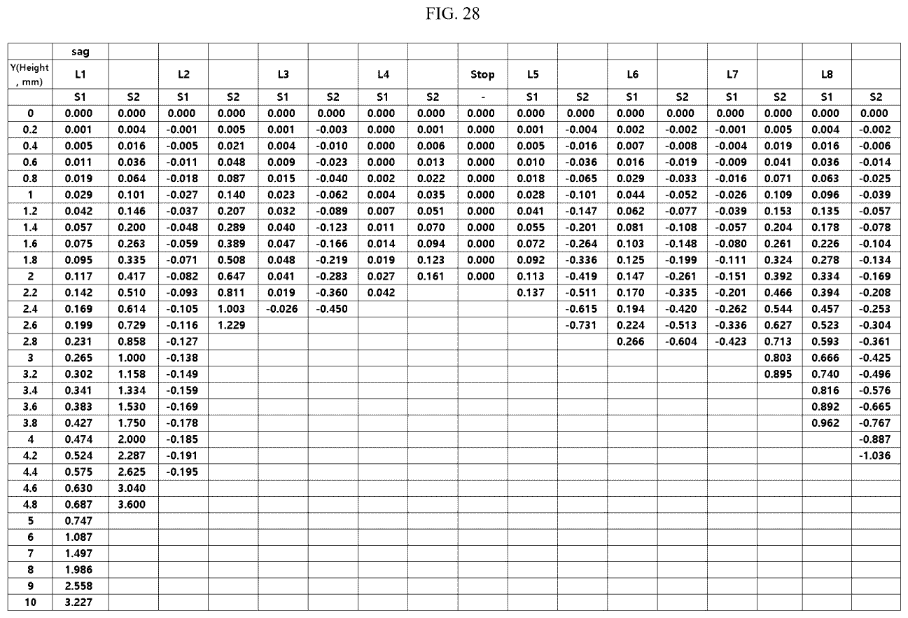

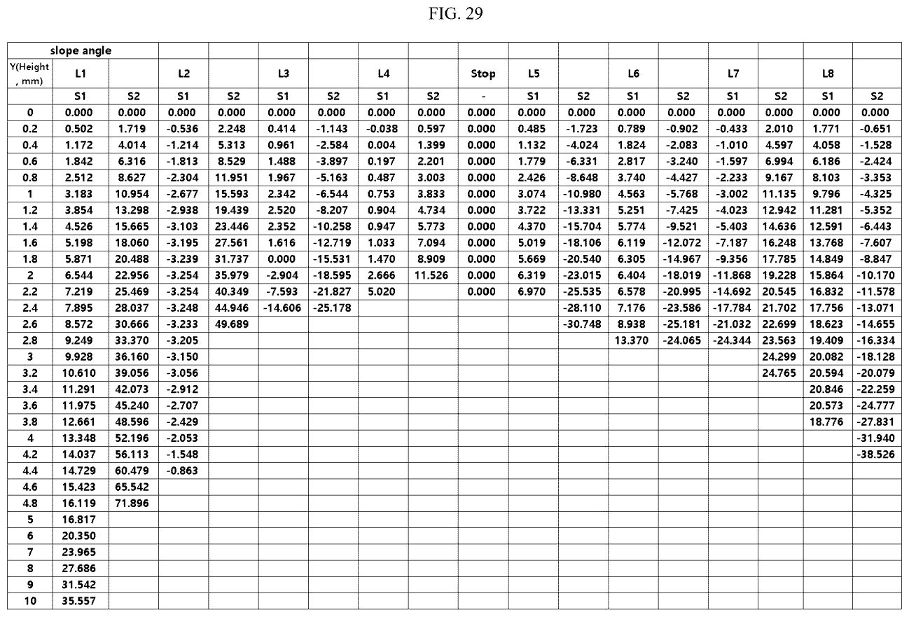

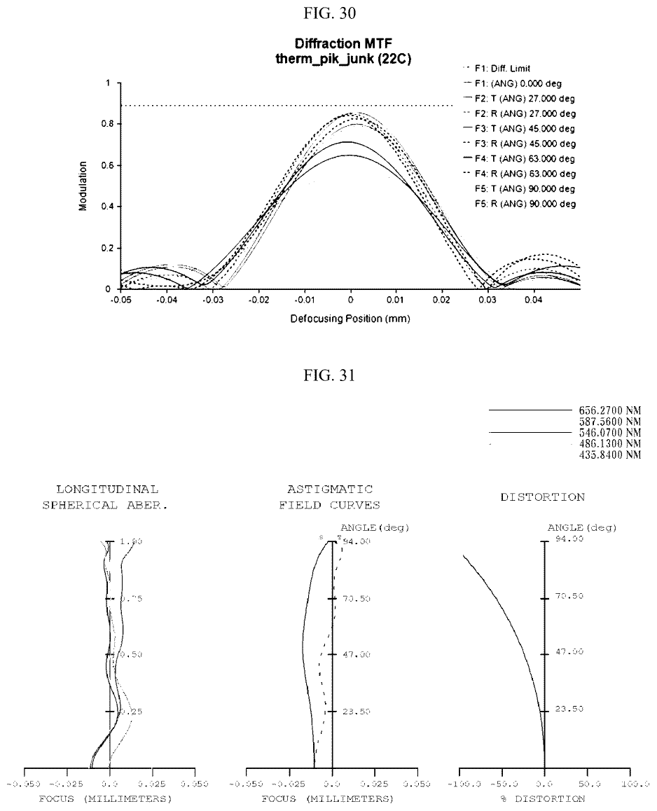

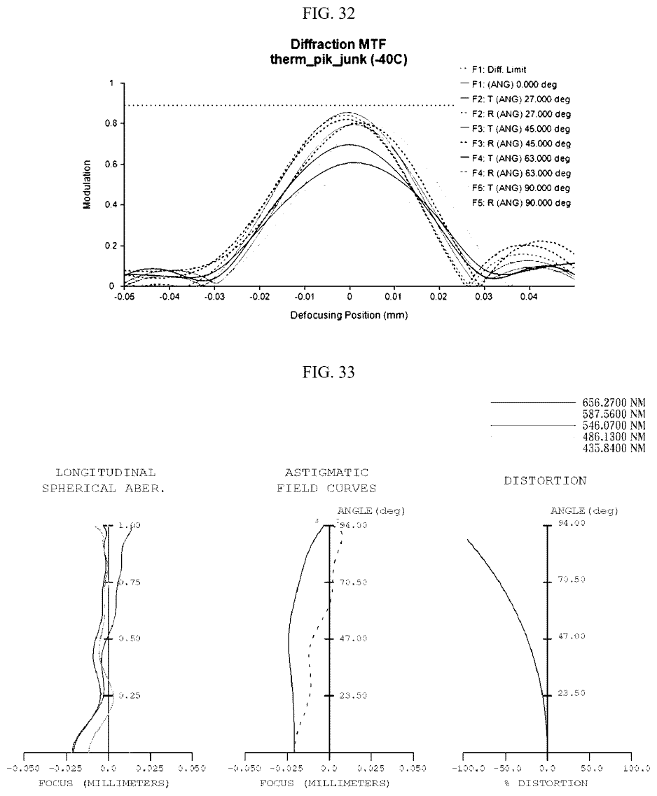

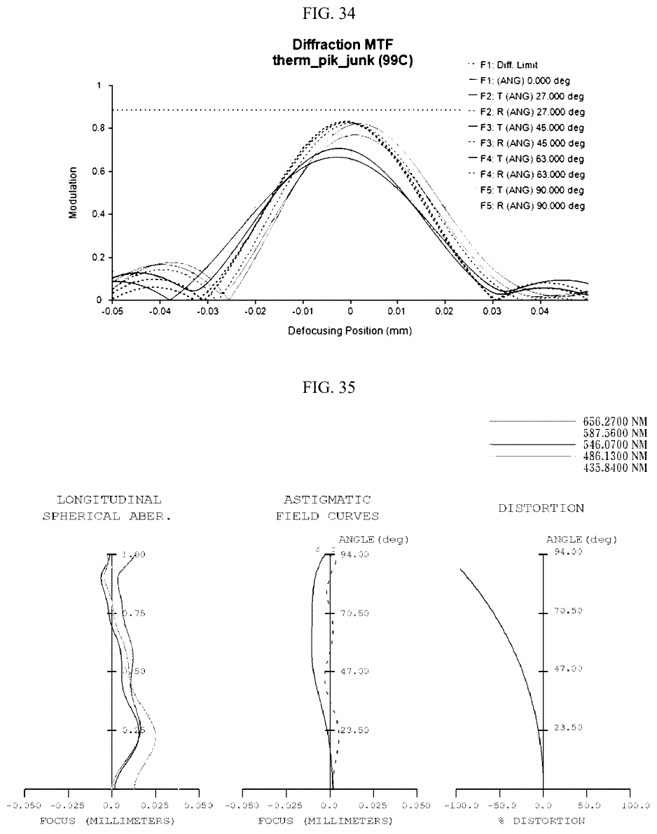

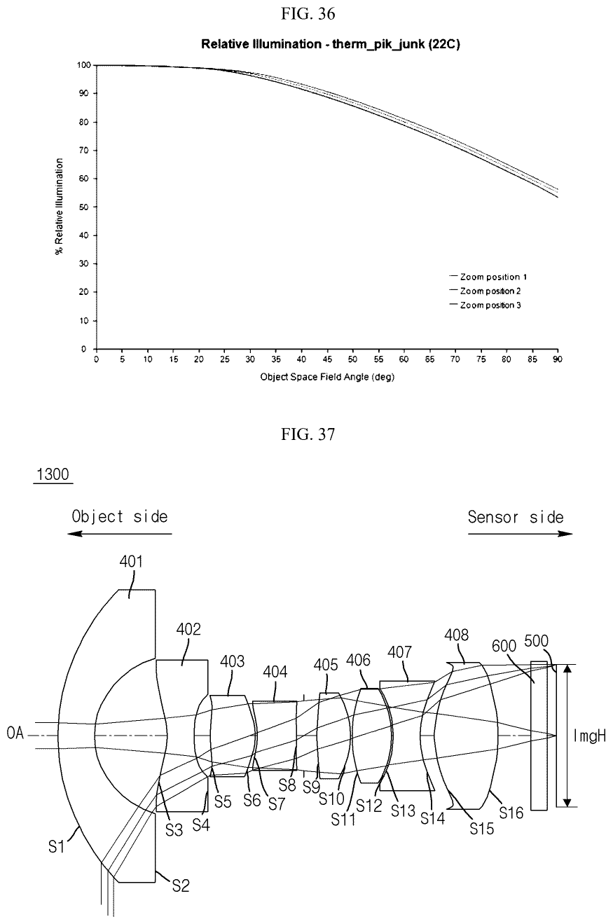

FIG. 25 is a side cross-sectional view of an optical system according to a third embodiment and a camera module having the same; FIG. 26 is a table showing aspherical coefficients of lenses in an optical system of FIG. 25; FIG. 27 is a table showing the thickness of each lens of an optical system of FIG. 25 and the spacing between adjacent lenses; FIG. 28 is a table showing the sag values of the lens surfaces of the first to eighth lenses in an optical system of FIG. 25; FIG. 29 is a table showing the slope angles of the lens surfaces of the first to eighth lenses in an optical system of FIG. 25; FIG. 30 is a graph showing data on the diffraction MTF of an optical system of FIG. 25 at room temperature; FIG. 31 is a graph showing data on the aberration characteristics of an optical system of FIG. 25 at room temperature; FIG. 32 is a graph showing data on the diffraction modulation transfer function (MTF) of an optical system of FIG. 25 at low temperature; FIG. 33 is a graph showing data on the aberration characteristics of an optical system of FIG. 25 at low temperature; FIG. 34 is a graph showing data on the diffraction MTF of an optical system of FIG. 25 at high temperature; FIG. 35 is a graph showing data on the aberration characteristics of an optical system of FIG. 25 at high temperature; and FIG. 36 is a graph showing the peripheral illumination ratio of an optical system of FIG. 25.

Referring to FIG. 25, the optical system 1200 includes a lens unit, and the lens unit may include a first lens 301 to an eighth lens 308. The first to eighth lenses 301 to 308 may be sequentially disposed along an optical axis OA of the optical system 1300. Light corresponding to information about an object may pass through the first lens 301 to the eighth lens 308 and a filter 600 and be incident on an image sensor 500.

The first lens 301 may be disposed closest to the object side. The first lens 301 may be disposed farthest from the sensor side. The first lens 301 may have negative (−) refractive power on an optical axis OA. The first lens 301 may include a plastic material or a glass material, and may be, for example, a glass material. The first lens 301 made of a glass material may reduce changes in the center position and the radius of curvature due to temperature changes according to the surrounding environment, and may protect the incident side surface of the optical system 1200.

The first surface S1 on the object side of the first lens 301 with respect to the optical axis may be convex, and the second surface S2 on the sensor side may be concave. The first lens 301 may have a meniscus shape convex toward the object side. The first lens 301 may be made of glass and may have a spherical surface. At least one or both of the first surface S1 and the second surface S2 may be provided without a critical point from an optical axis OA to the end of the effective area.

Due to the refractive characteristics of the first lens 301, the second lens 302 can be further separated from the first lens 301. That is, the center gap between the first and second lenses 301 and 302 can be the largest within the lens unit.

The refractive index n1 of the first lens 301 can satisfy the condition of n1>1.7 or n1>1.72. Since the refractive index n1 of the first lens 301 is the largest in the lens unit, the radius of curvature of the first and second lenses 301 and 302 can be increased, and lens manufacturing can be easy. If the refractive index n1 of the first lens 301 is smaller than the condition, the lens surface must be formed to be sharply concave or convex in order to increase the refractive power of the first and second lenses 301 and 302. In this case, lens manufacturing is not easy, the lens defect rate increases, and it can cause a decrease in yield.

The second lens 302 may be disposed second from the object side. The second lens 302 may be disposed seventh from the sensor side. The second lens 302 may be disposed between the first lens 301 and the third lens 303. The second lens 302 may have negative (−) refractive power on an optical axis OA. The second lens 302 may include a plastic or glass material. For example, the second lens 302 may be provided with a plastic material.

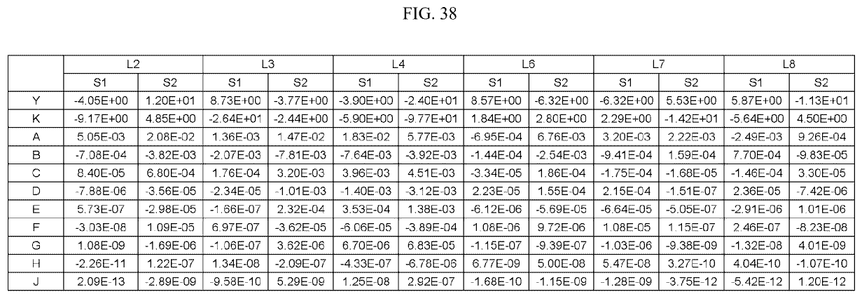

The object-side third surface S3 of the second lens 302 with respect to an optical axis OA is concave, and the sensor-side fourth surface S4 may be concave. The second lens 302 may have a concave shape on both surfaces. The second lens 302 is made of a plastic material and may be aspherical. At least one or both of the third surface S3 and the fourth surface S4 may be aspherical. The aspherical coefficients of the third and fourth surfaces S3 and S4 may be provided as S1 and S2 of L2 in FIG. 38. At least one or both of the first surface S3 and the second surface S4 may be provided without a critical point from an optical axis OA to the end of the effective area.

The third lens 303 may be disposed third from the object side. The third lens 303 may be disposed sixth from the sensor side. The third lens 303 may be disposed between the second lens 302 and the fourth lens 304. The third lens 303 may have positive (+) refractive power on an optical axis OA. The third lens 303 may include a plastic or glass material. For example, the third lens 303 may be provided with a plastic material.

The object-side fifth surface S5 of the third lens 303 with respect to an optical axis may be convex, and the sensor-side sixth surface S6 may be convex. The third lens 303 may have a convex shape on both surfaces. The third lens 303 may be made of a plastic material and may be aspherical. At least one or both of the fifth surface S5 and the sixth surface S6 may be aspherical. The aspherical coefficients of the fifth and sixth surfaces S5 and S6 may be provided as S5 and S6 of L3 of FIG. 38.

The fifth surface S5 of the third lens 303 may include a critical point from an optical axis OA to the end of the effective area. When the fifth surface S5 has a critical point, it may be located in a range of 70% to 80%, preferably 72% to 80%, of the effective radius r31 from an optical axis OA. The critical point of the fifth surface S5 may be located in a range of 1.5 mm to 20 mm, preferably 1.8 mm to 1.9 mm from an optical axis OA. The sixth surface S6 of the third lens 303 may be provided without a critical point from an optical axis OA to the end of the effective area.

The fourth lens 304 may be disposed fourth from the object side. The fourth lens 304 may be disposed fifth from the sensor side. The fourth lens 304 may be disposed between the third lens 303 and the fifth lens 305. The fourth lens 304 may have positive (+) or negative (−) refractive power on an optical axis OA. The fourth lens 304 may have negative (−) refractive power. The fourth lens 304 may include a plastic or glass material. For example, the fourth lens 304 may be provided with a plastic material.

The seventh surface S7 on the object side of the fourth lens 304 with respect to an optical axis may be concave, and the eighth surface S8 on the sensor side may be convex. The fourth lens 304 may have a convex meniscus shape toward the sensor side. The fourth lens 304 may have a concave meniscus shape toward the object side. The fourth lens 304 is made of a plastic material and may be aspherical. At least one or both of the seventh surface S7 and the eighth surface S8 may be aspherical. Aspherical coefficients of the seventh and eighth surfaces S7 and S8 may be provided as S1 and S2 of L4 of FIG. 38. At least one or both of the first surface S7 and the second surface S8 may be provided without a critical point from an optical axis OA to the end of the effective area.

The aperture Stop may be disposed around the sensor-side eighth surface S8 of the fourth lens 304. The aperture Stop may be disposed around the object-side ninth surface S9 of the fifth lens 305. The aperture may reduce the TTL within the field of view range, and may enable miniaturization of the optical system. Accordingly, a decrease in the yield by weight of the optical system may be inhibited, and production efficiency may be improved. In addition, the optical system may be miniaturized by reducing the TTL at a horizontal field of view FOV_H of 170 degrees to 190 degrees.

The fifth lens 305 may be disposed as the fifth lens from the object side. The fifth lens 305 may be disposed as the fourth lens from the sensor side. The fifth lens 305 may be disposed between the fourth lens 304 and the sixth lens 306. The fifth lens 305 may have positive (+) or negative (−) refractive power on an optical axis OA. The fifth lens 305 may have positive (+) refractive power. The fifth lens 305 may include a plastic or glass material. For example, the fifth lens 305 may be provided as a glass material.

With respect to an optical axis OA, the ninth surface S9 on the object side of the fifth lens 305 may be convex, and the tenth surface S10 on the sensor side may be convex. The fifth lens 305 may have a shape in which both surfaces are convex. The fifth lens 305 is made of glass and may be aspherical. At least one or both of the ninth surface S9 and the tenth surface S10 may be aspherical.

The sixth lens 306 may be disposed as the sixth lens from the object side. The sixth lens 306 may be disposed as the third lens from the sensor side. The sixth lens 306 may be disposed between the fifth lens 305 and the seventh lens 307. The sixth lens 306 may have positive (+) or negative (−) refractive power on an optical axis OA. The sixth lens 306 may have positive (+) refractive power. The sixth lens 306 may include a plastic or glass material. For example, the sixth lens 306 may be provided as a plastic material.

With respect to the optical axis OA, the object-side eleventh surface S11 of the sixth lens 306 may be convex, and the sensor-side twelfth surface S12 may be convex. The sixth lens 306 may have a convex shape on both surfaces. The sixth lens 306 may be made of a plastic material and may be aspherical. At least one or both of the eleventh surface S11 and the twelfth surface S12 may be aspherical. Aspherical coefficients of the eleventh and twelfth surfaces S11 and S12 may be provided as S1 and S2 of L6 of FIG. 38. At least one or both of the eleventh surface S11 and the twelfth surface S12 may be provided without a critical point from an optical axis OA to the end of the effective area.

The seventh lens 307 may be disposed seventh from the object side. The seventh lens 307 may be disposed second from the sensor side. The seventh lens 307 may be disposed between the sixth lens 306 and the eighth lens 308. The seventh lens 307 may have positive (+) or negative (−) refractive power on an optical axis OA. The seventh lens 307 may have negative (−) refractive power. The seventh lens 307 may include a plastic or glass material. For example, the seventh lens 307 may be provided with a plastic material.

With respect to an optical axis OA, the 13th surface S13 on the object side of the seventh lens 307 may be convex, and the 14th surface S14 on the sensor side may be convex. The seventh lens 307 may have a shape in which both surfaces are convex. The seventh lens 307 may be made of a plastic material and may be aspherical. At least one or both of the 13th surface S13 and the 14th surface S14 may be aspherical. Aspherical coefficients of the 13th and 14th surfaces S13 and S14 may be provided as S13 and S14 of L7 of FIG. 38. At least one or both of the 13th surface S13 and the 14th surface S14 may be provided without a critical point from an optical axis OA to the end of the effective area.

The eighth lens 308 may be disposed furthest from the object side. The eighth lens 308 may be disposed closest to the image sensor 500. The eighth lens 308 may have positive (+) or negative (−) refractive power on an optical axis OA. The eighth lens 308 may have positive (+) refractive power. The eighth lens 308 may include a plastic or glass material. For example, the eighth lens 308 may be provided with a plastic material.

With respect to the optical axis OA, the object-side 15th surface S15 of the eighth lens 308 may have a convex shape, and the sensor-side 16th surface S16 may have a convex shape. The eighth lens 308 may have a convex shape on both surfaces. At least one or both of the 15th surface S15 and the 16th surface S16 may be aspherical. The aspherical coefficients of the 15th and 16th surfaces S15 and S16 may be provided as S15 and S16 of L8 of FIG. 38. At least one or both of the 15th surface S15 and the 16th surface S16 may be provided without a critical point from the optical axis OA to the end of the effective area.

The eighth lens 308 may be a plastic lens that is closest to the image sensor 500. In addition, by arranging two or more plastic lenses adjacent to the image sensor 500, aberrations such as spherical aberration and chromatic aberration can be improved by the lens surface having an aspherical surface, and the influence on the resolution can be controlled. In addition, by arranging the plastic lens as the lens adjacent to the image sensor 500, it can be insensitive to the assembly tolerance compared to a glass lens. That is, being insensitive to the assembly tolerance means that even if the assembly is slightly different from the design during assembly, the optical performance may not be significantly affected. In addition, by providing the two lenses 307 and 308 adjacent to the image sensor 500 as plastic, the optical performance can be improved by the lens surface having an aspherical surface, and for example, aberration characteristics can be improved and resolution deterioration can be inhibited.

TABLE 7

| | | | | | | Semi | Focal |
|---|---|---|---|---|---|---|---|
| Lens | Surface | Radius | Thickness | nd | vd | Aperture | length |
| 1 | S1 | 17.110 | 2.000 | 1.7762 | 49.6235 | 10.005 | −9.8093 |
| | S2 | 5.000 | 4.077 | | | 4.832 | |
| 2 | S3 | −15.924 | 1.500 | 1.5371 | 55.7074 | 4.571 | −5.6080 |
| | S4 | 3.837 | 1.549 | | | 2.646 | |
| 3 | S5 | 20.727 | 2.057 | 1.6633 | 21.2414 | 2.568 | 8.5082 |
| | S6 | −7.448 | 0.100 | | | 2.525 | |
| 4 | S7 | −174.138 | 1.500 | 1.6633 | 21.2414 | 2.200 | −19.9944 |
| | S8 | 14.405 | 0.388 | | | 2.124 | |
| | STOP | — | 0.283 | | | 2.127 | |
| 5 | S9 | 17.717 | 2.349 | 1.5521 | 75.4952 | 2.312 | 7.3196 |
| | S10 | −4.988 | 0.100 | | | 2.600 | |
| 6 | S11 | 10.871 | 1.899 | 1.5371 | 55.7074 | 2.800 | 9.7583 |
| | S12 | −9.503 | 0.100 | | | 2.881 | |
| 7 | S13 | −19.849 | 1.500 | 1.6633 | 21.2414 | 2.860 | −5.1527 |
| | S14 | 4.253 | 0.663 | | | 3.300 | |
| 8 | S15 | 4.832 | 3.255 | 1.5371 | 55.7074 | 3.987 | 7.0305 |
| | S16 | −13.214 | 2.729 | | | 4.397 | |
| Cover | | infinity | 0.900 | | | | |
| | | | 0.500 | | | | |
| Image | | infinity | 0.000 | | | | |

Table 7 shows the surface number Surface, radius of curvature Radius, center thickness of each lens or distance between lens surfaces Thickness, refractive index nd, Abbe number vd, effective radius Semi Aperture, and focal length Focal length of the lens according to a third embodiment of the present invention. At this time, the unit of the radius of curvature and thickness or distance may be mm.

TABLE 8

| Category | Value | Category | Value |
|---|---|---|---|
| F | 2.8720 | F-number | 1.8400 |
| ET1 | 2.4789 | FOV_H | 180.000 |
| ET2 | 2.9658 | EPD | 1.5609 |
| ET3 | 1.6284 | BFL | 0.5000 |
| ET4 | 1.6457 | TD | 26.9500 |
| ET5 | 1.4677 | ImgH | 4.32 |
| ET6 | 0.9988 | SD | 13.7788 |
| ET7 | 2.8876 | TTL | 27.4500 |
| ET8 | 1.0026 | GLca_Aver | 9.875 |
| ΣIndex | 12.9295 | PLca_Aver | 5.998 |
| ΣAbbe | 355.9651 | CT_max | 3.2552 |
| ΣCT | 16.0609 | CT_min | 1.5000 |
| ΣCG | 7.2596 | CT_Aver | 2.0076 |
| CA_max | 20.010 | F_LG1 | −4.953 |
| CA_min | 4.249 | F_LG2 | 5.832 |
| CA_Aver | 6.910 | | |

Table 8 shows categories of the mathematical formulas described above in the optical system 1200 of the embodiment, including the total track length (TTL) (mm), back focal length (BFL), effective focal length F (mm), ImgH (mm), effective diameter CA (mm), thickness (mm), TTL (mm), TD (mm), which is the optical axis distance from the first surface S1 to the twelfth surface S12, sum of refractive indices, sum of Abbe numbers, sum of thicknesses (mm), sum of gaps between adjacent lenses, effective diameter characteristics, sum of refractive indices of glass lenses, sum of refractive indices of plastic materials, angle of view FOV_H (degree), edge thickness ET, F number, and the like of the optical system 1100.

The center thickness of the first to eighth lenses 301 to 308 is represented by CT1 to CT8, the edge thickness at the end of the effective area of each lens is represented by ET1 to ET8, the center gap between two adjacent lenses is represented by CG1 to CG7, and the edge gap between the edges of each lens is represented by EG1 to EG7. Back focal length (BFL) is the optical axis distance from the image sensor 500 to the center of the last lens. TTL is the optical axis distance from the center of the first surface S1 of the first lens 301 to the upper surface of the image sensor 500.

As illustrated in FIG. 38, among the lenses of the lens unit in the third embodiment, the lens surfaces of the second, third, fourth, sixth, seventh, and eighth lenses 302, 303, 304, 306, 307, and 308 may include aspherical surfaces having a 30th order aspherical surface coefficient. For example, the second, third, fourth, sixth, seventh, and eighth lenses 302, 303, 304, 306, 307, and 308 may include lens surfaces having a 30th order aspherical surface coefficient. As described above, since the aspherical surface having the 30th order aspherical surface coefficient (a value other than “0”) can significantly change the aspherical shape of the peripheral portion, the optical performance of the peripheral portion of the field of view (FOV) can be well corrected.

The thickness T1 to T8 of the first to eighth lenses 301 to 308 and the gap G1 to G7 between adjacent two lenses can be set. As shown in FIG. 3, the thickness T1 to T8 of each lens in a Y-axis direction can be expressed at a gap of 0.1 mm or 0.2 mm or more, and the gap G1 to G7 between each lens can be expressed at a gap of 0.1 mm or 0.2 mm or more.

When comparing the absolute values of the radius of curvature of each lens, the radius of curvature of the seventh surface S7 of the fourth lens 304 on an optical axis OA may be the largest among the lenses, and the radius of curvature of the fourth surface S4 of the second lens 302 may be the smallest among the lenses. The difference between the maximum radius of curvature and the minimum radius of curvature may be 15 times or more, for example, in the range of 15 times to 20 times.

Since the effective diameter of a plastic lens is smaller than that of a glass lens, the lens placed on the object side of a plastic lens can have strong refractive power in order to refract light through the plastic lens. In addition, the radius of curvature of the lens surface can be small in order to strengthen the refractive power.

The absolute value of the curvature radius of the first surface S1 of the first lens 301 may be greater than the absolute value of the curvature radius of the second surface S2. The absolute value of the curvature radius of the third surface S3 of the second lens 302 may be greater than the absolute value of the curvature radius of the fourth surface S4. The absolute value of the curvature radius of the fifth surface S5 of the third lens 303 may be greater than the absolute value of the curvature radius of the sixth surface S6. The absolute value of the curvature radius of the seventh surface S7 of the fourth lens 304 may be greater than the absolute value of the curvature radius of the eighth surface S8. The absolute value of the curvature radius of the ninth surface S9 of the fifth lens 305 may be greater than the absolute value of the curvature radius of the tenth surface S10. The absolute value of the curvature radius of the eleventh surface S11 of the sixth lens 306 may be greater than the absolute value of the curvature radius of the twelfth surface S12. The absolute value of the curvature radius of the thirteenth surface S13 of the seventh lens 307 may be greater than the absolute value of the curvature radius of the fourteenth surface S14. The absolute value of the curvature radius of the fifteenth surface S15 of the eighth lens 308 may be less than the absolute value of the curvature radius of the sixteenth surface S16.

The ratio of the radius of curvature of each lens can satisfy the following conditions.

$$Condition 1 : 3 < L 1 R 1 / L 1 R 2 \vert < 4$$

$$Condition 2 : 4 < \vert L 2 R 1 / L 2 R 2 \vert < 5$$

$$Condition 3 : 2 < \vert L 3 R 1 / L 3 R 2 \vert < 3$$

$$Condition 4 : 12 < \vert L 4 R 1 / L 4 R 2 \vert < 13$$

$$Condition 5 : 3 < \vert L 5 R 1 / L 5 R 2 \vert < 4$$

$$Condition 6 : 1 < \vert L 6 R 1 / L 6 R 2 \vert < 2$$

$$Condition 7 : 4 < \vert L 7 R 1 / L 7 R 2 \vert < 5$$

$$Condition 8 : 0.3 < L 8 R 1 / L 8 R 2 < 0.4$$

When explaining the center thickness CT of the lenses with respect to the optical axis, the center thickness CT8 of the eighth lens 308 is the largest among the lenses, and the center thickness CT2, CT4, and CT7 of at least one of the second lens 302, the third lens 303, and the seventh lens 307 is the smallest among the lenses. The difference between the maximum center thickness and the minimum center thickness among the lenses may be in the range of 2 mm or more and 2.5 mm or less. The center thickness of the eighth lens 308 disposed closest to the sensor side may be set to the largest so as to be suitable for the chief ray angle (CRA) of the image sensor 500.

The center thickness of each lens can satisfy any one among the following conditions.

$$Condition 1 : CT 3 , CT 5 , CT 8 > C T 1 > CT 2 , CT 4 , CT 6 , CT 7$$

$$Condition 2 : CT 1 , CT 3 , CT 5 , CT 6 , CT 8 > CT 2 = CT 4 = CT 7$$

$$Condition 3 : CT 5 , CT 8 > CT 3 > CT 1 , CT 2 , CT 4 , CT 6 , CT 7$$

$$Condition 4 : CT 8 > CT 5 > CT 1 , CT 2 , CT 3 , CT 4 , CT 6 , CT 7$$

$$Condition 5 : CT 1 , CT 3 , CT 5 , CT 8 > CT 6 > CT 2 , CT 4 , CT 7$$

$$Condition 6 : CT 8 > CT 1 , CT 2 , CT 3 , CT 4 , CT 5 , CT 6 , CT 7$$

When explaining the center gap CG between the lenses, the center gap CG1 between the first lens 301 and the second lens 302 may be the maximum, and at least one of the center gap CG5 between the fifth and sixth lenses 305 and 306 and the center gap CG6 between the sixth and seventh lenses 306 and 307 may be the minimum. The difference between the maximum center gap and the minimum center gap among the spaced lens gaps may be 3.5 mm or more, for example, in the range of 3.5 mm to 4.5 mm.

The center gap of each lens can satisfy any one among the following conditions.

$$Condition 1 : CG 1 > CG 2 , CG 3 , CG 4 , CG 5 , CG 6 , CG 7$$

$$Condition 2 : CG 1 > CG 2 > CG 3 , CG 4 , CG 5 , CG 6 , CG 7$$

$$Condition 3 : CG 1 , CG 2 , CG 4 , CG 7 > CG 3 = CG 5 = CG 6$$

$$Condition 4 : CG 1 , CG 2 > CG 4 > CG 3 , CG 5 , CG 6 , CG 7$$

$$Condition 5 : CG 1 , CG 2 , CG 4 > CG 7 > CG 3 , CG 5 , CG 6$$

When explaining the effective diameter, the lens having the maximum effective diameter may be a glass lens. The lens having the maximum effective diameter may be the first lens 301. Here, the effective diameter is an average of the effective diameter of the object side surface and the effective diameter of the sensor side surface of each lens. The lens surface having the maximum effective diameter may be the first surface S1 of the first lens 301.

The lens having the minimum effective diameter may be a lens disposed between the first lens 301 and the aperture STOP. The lens having the minimum effective diameter may be the fourth lens 304. The lens surface having the minimum effective diameter may be the eighth surface S8 of the fourth lens 304. The effective diameter of the lens made of a plastic material may be smaller than the effective diameter of the lens made of a glass material. The lens made of a plastic material may be disposed adjacent to the image sensor.

The effective diameter of each lens can satisfy any one among the conditions below.

$$Condition 1 : CA\_L1 > CA\_L2 , CA\_L3 , CA\_L4 , CA\_L5 , CA\_L6 , CA\_L7 , CA\_L8$$

$$Condition 2 : CA\_L1 , CA\_L8 > CA\_L2 > CA\_L3 , CA\_L4 , CA\_L5 , CA\_L6 , CA\_L7$$

$$Condition 3 : CA\_L1 , CA\_L2 , CA\_L6 , CA\_L7 , CA\_L8 > CA\_L3 > CA\_L4 , CA\_L5$$

$$Condition 4 : CA\_L1 , CA\_L2 , CA\_L3 , CA\_L5 , CA\_L6 , CA\_L7 , CA\_L8 > CA\_L4$$

$$Condition 5 : CA\_L1 , CA\_L2 , CA\_L3 , CA\_L6 , CA\_L7 , CA\_L8 > CA\_L5 > CA\_L4$$

$$Condition 6 : CA\_L1 > CA\_L2 , CA\_L7 , CA\_L8 > CA\_L6 > CA\_L3 , CA\_L4 , CA\_L5$$

$$Condition 7 : CA\_L1 > CA\_L2 , CA\_L8 > CA\_L7 > CA\_L3 , CA\_L4 , CA\_L5 , CA\_L6$$

$$Condition 8 : CA\_L1 > CA\_L8 > CA\_L2 , CA\_L3 , CA\_L4 , CA\_L5 , CA\_L6 , CA\_L7$$

When explaining the refractive index of the first lens 301 may be the largest among the lenses and may be greater than 1.7, for example, greater than 1.72. One or both of the second lens 302, the sixth lens 306, and the eighth lens 308 may have the smallest refractive index among the lenses. For example, the refractive indices among the second lens 302, the sixth lens 306, and the eighth lens 308 may be the smallest among the lenses and may be less than 1.6, for example, less than 1.55. The difference between the maximum refractive index and the minimum refractive index may be 0.2 or more. By providing a high refractive index lens made of glass closest to an object, and providing a lens adjacent to the glass lens and a lens adjacent to the image sensor 500 as a low refractive index lens made of plastic, the incidence efficiency can be increased, and the refractive power between the lenses made of glass and plastic can be adjusted to guide light to the image sensor 500.

The refractive index of each lens can satisfy any one among the conditions below.

$$Condition 1 : n 1 > n 2 , n 3 , n 4 , n 5 , n 6 , n 7 , n 8$$

$$Condition 2 : n 1 , n 3 , n 4 , n 5 , n 7 > n 2 = n 6 = n 8$$

$$Condition 3 : n 1 > n 3 = n 4 = n 7 > n 2 , n 5 , n 6 , n 8$$

$$Condition 4 : n 1 , n 3 , n 4 , n 7 > n 5 > n 2 , n 6 , n 8$$

When comparing the Abbe numbers, the Abbe number of the fifth lens 305 is the largest among the lenses, and may be 60 or more. The Abbe number of at least one among the third lens 303, the fourth lens 304, and the seventh lens 307 is the smallest among the lenses, and may be 25 or less. The difference between the maximum refractive index and the minimum Abbe number may be 50 or more. By making the Abbe number of the fifth lens 305 disposed at the center of the optical system 1000 the largest, and providing the Abbe number of the seventh lens 307 having a low refractive index adjacent to the image sensor 500 the smallest, the chromatic dispersion of light traveling between the lenses made of glass and plastic can be controlled, and the chromatic dispersion between the lenses made of glass and plastic can be increased to guide it to the image sensor 500.

The Abbe number of a lens can satisfy any one among the following conditions.

$$Condition 1 : v 2 , v 5 , v 6 , v 8 > v 1 > v 3 , v 4 , v 7$$

$$Condition 2 : v 5 > v 2 = v 6 = v 8 > v 1 , v 3 , v 4 , v 7$$

$$Condition 3 : v 1 , v 2 , v 5 , v 6 , v 8 > v 3 = v 4 = v 7$$

$$Condition 4 : v 5 > v 1 , v 2 , v 3 , v 4 , v 6 , v 7 , v 8$$

The focal lengths F1, F2, F4, and F7 of the first, second, fourth, and seventh lenses 301, 302, 304, and 307 may have negative (−) signs. The first, second, fourth, and seventh lenses 301, 302, 304, and 307 may have negative (−) refractive power. The focal lengths F3, F5, F6, and F8 of the third, fifth, sixth, and eighth lenses 303, 305, 306, and 308 may have positive (+) signs. The third, fifth, sixth, and eighth lenses 303, 305, 306, and 308 may have positive (+) refractive power. The third lens 303 having positive (+) refractive power may be disposed on the sensor side of the first lens 301 and the second lens 302 having negative (−) refractive power. Through this, light incident on the object side can move away from an optical axis direction and then gather again on an optical axis direction, thereby forming a stable optical path.

In addition, the sixth lens 306 and the seventh lens 307, which are adjacently disposed lenses, can satisfy the following conditions.

Refractive index of a lens with positive refractive power<Refractive index of a lens with negative refractive power Condition 1:

Dispersion value of a lens with positive refractive power>Dispersion value of a lens with negative refractive power Condition 2:

Here, among the plastic lenses, the sixth lens 306 has positive refractive power and the seventh lens 307 has negative refractive power, so that according to Conditions 1 and 2, the refractive index of the sixth lens 306 is smaller than that of the seventh lens 307, and the dispersion value of the sixth lens 306 is larger than that of the seventh lens 307. Chromatic aberration occurring in the plastic lens can be corrected by the plastic lens. In addition, since the sixth lens 306 and the seventh lens 307, which are plastic lenses being disposed in succession, satisfy the refractive index difference of 0.1 or more and 0.15 or less and the Abbe number difference of 20 or more and 50 or less, the chromatic aberration occurring in the plastic lens can be compensated for by the plastic lens.

The optical system has chromatic aberration, and chromatic aberration is corrected by using cemented lenses or two lenses disposed in succession. As the temperature changes from low to high, the lenses repeatedly contract and expand. Since the amount of change in lens characteristics according to the temperature change is the same for lenses of the same material, it is effective to correct chromatic aberration between lenses of the same material even when the temperature changes. Therefore, in a first embodiment of the present invention, chromatic aberration occurring in a plastic lens can be corrected by using the sixth lens 306 and the seventh lens 307.

From an optical axis to the effective diameter area, the maximum value of the distance between two lenses having the largest difference in Abbe numbers among two adjacent lenses may be smaller than the maximum value of the distance between the other two adjacent lenses. Here, the distance may mean the distance between the two lenses from an optical axis to the effective diameter area. The two lenses having the largest difference in Abbe numbers among two adjacent lenses may be the second lens 302 and the third lens 303, and the sixth lens 306 and the seventh lens 307. From an optical axis to the effective diameter area, in a direction perpendicular to the optical axis, the maximum value of the distance from the sensor side surface (the twelfth surface) S12 of the sixth lens 306 to the object side surface (the thirteenth surface) S13 of the seventh lens 307 may be smaller than the maximum value of the distance between the other two adjacent lenses. Through this, the distance between two lenses made of plastic material that is difficult to bond can be designed to be small, and the difference in Abbe numbers can be maximized to have the effect of reducing chromatic aberration to the same extent as a bonded lens even in a non-bonded state.

When comparing the focal lengths in absolute value, the focal length of the fourth lens 304 is the largest among the lenses, and may be 10 or more and 20 or less. The focal length of the seventh lens 307 is the smallest among the lenses, and the absolute value of the focal length of the seventh lens 307 may be 5 or more and 7 or less.

The absolute value of the focal length of each lens can satisfy any one among the conditions below.

$$Condition 1 : \vert f 4 \vert > \vert f 1 \vert > \vert f 2 \vert , \vert f 3 \vert , \vert f 5 \vert , \vert f 6 \vert , \vert f 7 \vert , \vert f 8 \vert$$

$$Condition 2 : \vert f 1 \vert , \vert f 3 \vert , \vert f 4 \vert , \vert f 5 \vert , \vert f 6 \vert , \vert f 8 \vert > \vert f 2 \vert > \vert f 7 \vert$$

$$Condition 3 : \vert f 1 \vert , \vert f 4 \vert , \vert f 6 \vert > \vert f 3 \vert > \vert f 2 \vert , \vert f 5 \vert , \vert f 7 \vert , \vert f 8 \vert$$

$$Condition 4 : \vert f 4 \vert > \vert f 1 \vert , \vert f 2 \vert , \vert f 3 \vert , \vert f 5 \vert , \vert f 6 \vert , \vert f 7 \vert , \vert f 8 \vert$$

$$Condition 5 : \vert f 1 \vert , \vert f 3 \vert , \vert f 4 \vert , \vert f 6 \vert > \vert f 5 \vert > \vert f 2 \vert , \vert f 7 \vert , \vert f 8 \vert$$

$$Condition 6 : \vert f 1 \vert , \vert f 4 \vert > \vert f 6 \vert > \vert f 2 \vert , \vert f 3 \vert , \vert f 5 \vert , \vert f 7 \vert , \vert f 8 \vert$$

$$Condition 7 : \vert f 1 \vert , \vert f 2 \vert , \vert f 3 \vert , \vert f 4 \vert , \vert f 5 \vert , \vert f 6 \vert , \vert f 8 \vert > \vert f 7 \vert$$

$$Condition 8 : \vert f 1 \vert , \vert f 3 \vert , \vert f 4 \vert , \vert f 5 \vert , \vert f 6 \vert > \vert f8 \vert > \vert f 2 \vert , \vert f 7 \vert$$

The thickness T1 of the first lens 301 may be a difference of 1.1 times or more between the maximum thickness and the minimum thickness, for example, 1.2 times to 1.5 times, and the center thickness CT1 may be a minimum and the edge thickness ET1 may be a maximum. The thickness T2 of the second lens 302 may be a maximum thickness in a range of 1.5 times to 2 times the minimum thickness. The second lens 302 may be a minimum in the center thickness CT2 and the maximum in the edge thickness ET2. The thickness T3 of the third lens 303 may be a maximum at the center and a minimum at the edge, and the maximum thickness is in a range of 1.1 times to 1.5 times the minimum thickness. The thickness T4 of the fourth lens 304 may be a minimum at the center and a maximum at the edge, and the maximum thickness is in a range of 1.1 times to 1.5 times the minimum thickness. The thickness T5 of the fifth lens 305 may be maximum at the center and minimum at the edge and the maximum thickness is in a range of 1.1 to 1.5 times the minimum thickness. The thickness T6 of the sixth lens 306 may be maximum at the center and minimum at the edge and the maximum thickness is in a range of 1.5 to 2 times the minimum thickness. The thickness T7 of the seventh lens 307 may be minimum at the center and maximum at the edge and the maximum thickness is in a range of 1.5 to 2 times the minimum thickness. The thickness T8 of the eighth lens 308 may be maximum at the center and minimum at the edge and the maximum thickness is in a range of 2 to 2.5 times the minimum thickness.

The ratio of the center thickness to the edge thickness of each lens can be referred to as a ‘meat slice ratio’. When the ratio of the large and small values of the center thickness and the edge thickness satisfies 2 to 2.5, manufacturability of a lens can be improved and advantageous in terms of yield.

The thickness of each lens can satisfy any among the following conditions.

$$Condition 1 : 0.5 < CT 1 / ET 1 < 1 , 1 < ET 1 / CT 1 < 1.5$$

$$Condition 2 : 0.3 < CT 2 / ET 2 < 0.6 , 1.5 < ET 2 / CT 2 < 2$$

$$Condition 3 : 1 < CT 3 / ET 3 < 1.5 , 0.5 < ET 3 / CT 3 < 1$$

$$Condition 4 : 0.5 < CT 4 / ET 4 < 1 , 1 < ET 4 / CT 4 < 1.5$$

$$Condition 5 : 1.5 < CT 5 / ET 5 < 2 , 0.5 < ET 5 / CT 5 < 1$$

$$Condition 6 : 1.5 < CT 6 / ET 6 < 2 , 0.5 < ET 6 / CT 6 < 1$$

$$Condition 7 : 0.5 < CT 7 / ET 7 < 1 , 1.5 < ET 7 / CT 7 < 2$$

$$Condition 8 : 3 < CT 8 / ET 8 < 3.5 , 0.1 < ET 8 / CT 8 < 0.5$$

$$Condition 9 : 1 < \sum CT / \sum ET < 1.2 , 0 \text{.5} < \sum ET / \sum CT < 1$$

Among the gaps G1 to G7 between the lenses, the first gap G1 between the first and second lenses 301 and 302 may have a maximum in the center portion and a minimum in the edge. The second gap G2 between the second and third lenses 302 and 303 may have a maximum in the center and a minimum in the edge. The third gap G3 between the third and fourth lenses 303 and 304 may have a maximum in the edge and a minimum in the center portion. The fourth gap G4 between the fourth and fifth lenses 304 and 305 may have a minimum in the center portion and a maximum in the edge. The fifth gap G5 between the fifth and sixth lenses 305 and 306 may have a minimum in the center portion and a maximum in the edge. The sixth gap G6 between the sixth and seventh lenses 306 and 307 may have a minimum in the center portion and a maximum in the edge. The seventh gap G7 between the seventh and eighth lenses 307 and 308 may be maximum at the center portion and minimum at the edge.

FIGS. 30, 32, and 34 are graphs illustrating a diffraction modulation transfer function (MTF) at room temperature, low temperature, and high temperature in the optical system of FIG. 25, illustrating a luminance ratio (modulation) according to a spatial frequency. As illustrated in FIGS. 30, 30, and 34, in a third embodiment of the present invention, a deviation of MTF to a low temperature or a high temperature with respect to room temperature may be less than 10%, that is, 7% or less.

FIGS. 31, 33, and 35 are graphs showing aberration characteristics at room temperature, low temperature, and high temperature in the optical system of FIG. 25. In the aberration graphs of FIGS. 31, 33, and 35, spherical aberration (longitudinal spherical aberration), astigmatic field curves, and distortion are measured from left to right. In FIGS. 31, 33, and 35, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 31, 33, and 35, it can be interpreted that the closer each curve at room temperature, low temperature, and high temperature is to a Y-axis, the better the aberration correction function is. It can be seen that the optical system 1200 according to a second embodiment has measurement values close to a Y-axis in almost all areas. That is, the optical system 1200 according to a second embodiment has improved resolution and can have good optical performance not only in the center portion of the field of view (FOV) but also in the periphery portion. Here, the low temperature is −20 degrees or lower, for example, in the range of −20 to −40 degrees, the room temperature is in the range of 22 degrees±5 degrees or in the range of 18 degrees to 27 degrees, and the high temperature can be 85 degrees or higher, for example, in the range of 85 degrees to 105 degrees. Accordingly, it can be seen that the decrease in the modulation from low to high temperature in FIGS. 31, 33, and 35 is less than 10%, for example, less than 5%, or is almost unchanged.

Table 9 compares changes in optical characteristics such as EFL, BFL, F number F #, TTL, and field of view FOV_H at room temperature, low temperature, and high temperature in the optical system according to a second embodiment, and it can be seen that the change rate of the optical characteristics at low temperature is 5% or less, for example, 3% or less, with respect to room temperature, and it can be seen that the change rate of the optical characteristics at low temperature is 5% or less, for example, 3% or less, with respect to room temperature.

TABLE 9

| | Room | Low | High | Low/Room | High/Room |
|---|---|---|---|---|---|
| | temper- | temper- | temper- | temper- | temper- |
| | ature | ature | ature | ature | ature |
| EFL(F) | 2.87 | 2.85 | 2.90 | 99.30% | 101.04% |
| BFL | 4.13 | 4.12 | 4.14 | 99.75% | 100.24% |
| F# | 1.84 | 1.83 | 1.86 | 99.45% | 101.08% |
| TTL | 27.45 | 27.39 | 27.53 | 99.78% | 100.29% |
| FOV_H | 180.00 | 182.27 | 177.33 | 101.26% | 98.51% |

Therefore, as shown in Table 9, it can be seen that the changes in optical characteristics according to the temperature change from low temperature to high temperature, for example, the change rate of effective focal length (EFL), TTL, BFL, F number, and field of view FOV_H, are less than 10%, that is, less than 5%, for example, in the range of 0 to 5%. This makes it possible to design temperature compensation for plastic lenses even when using at least one or two or more plastic lenses, thereby inhibiting a decrease in the reliability of optical characteristics.

The optical system of a third embodiment disclosed above can effectively control aberration characteristics such as chromatic aberration and distortion aberration, and can have good optical performance not only at the center portion of the field of view (FOV) but also at the periphery portion.

An optical system according to a fourth embodiment of the invention will be described.

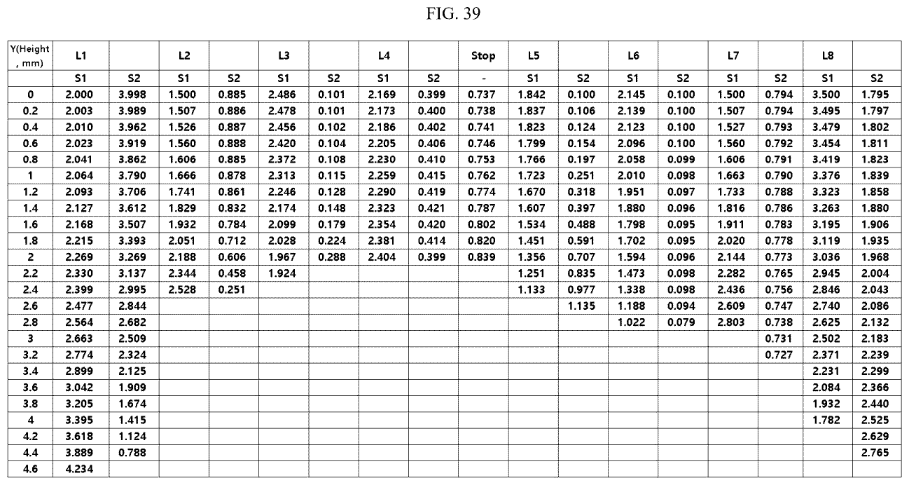

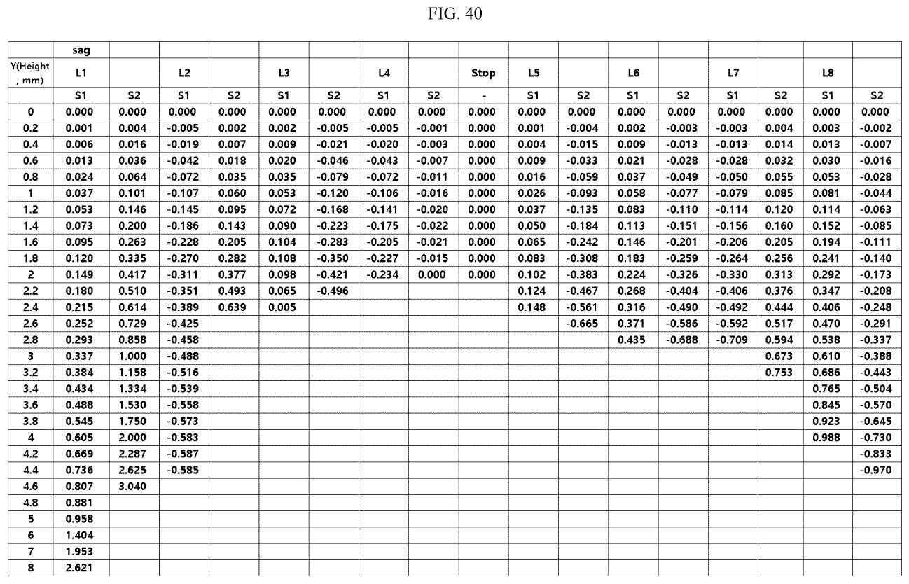

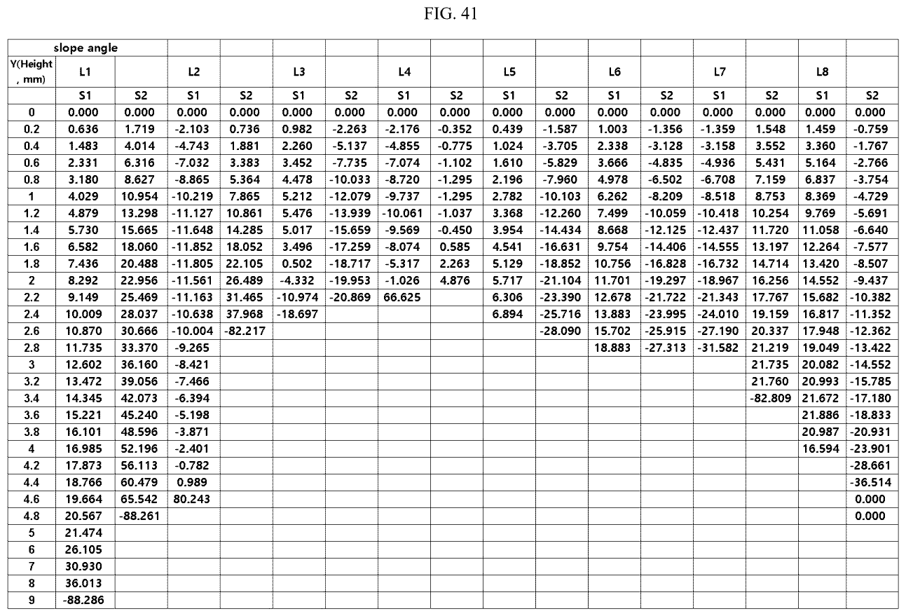

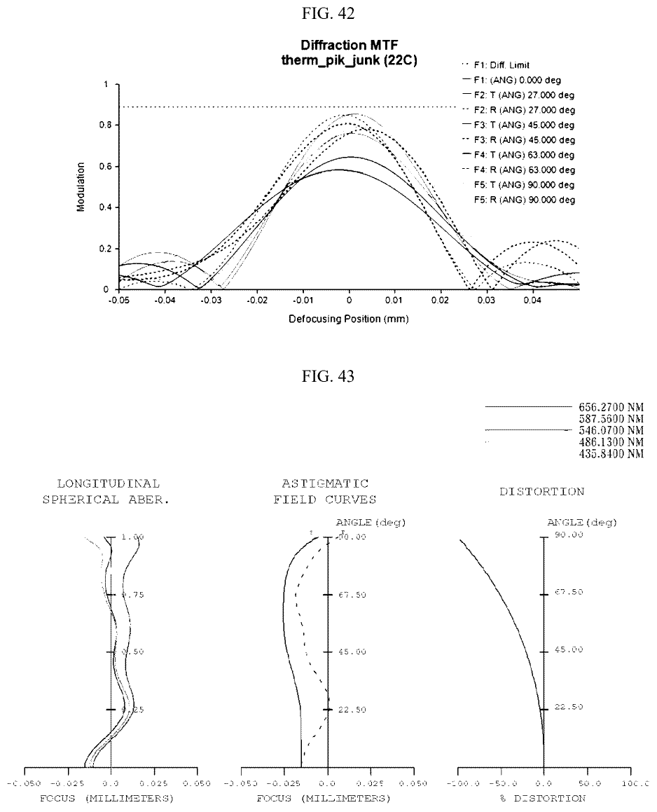

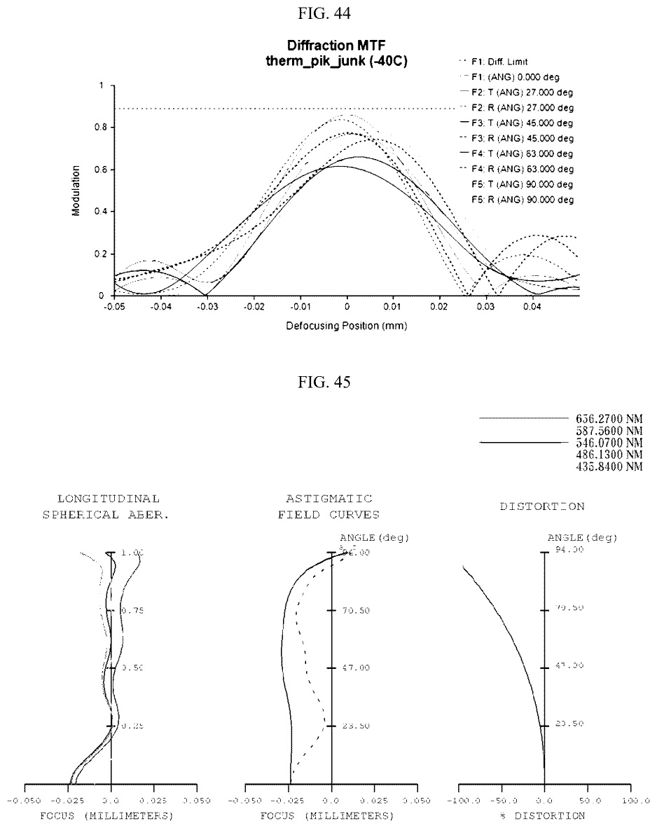

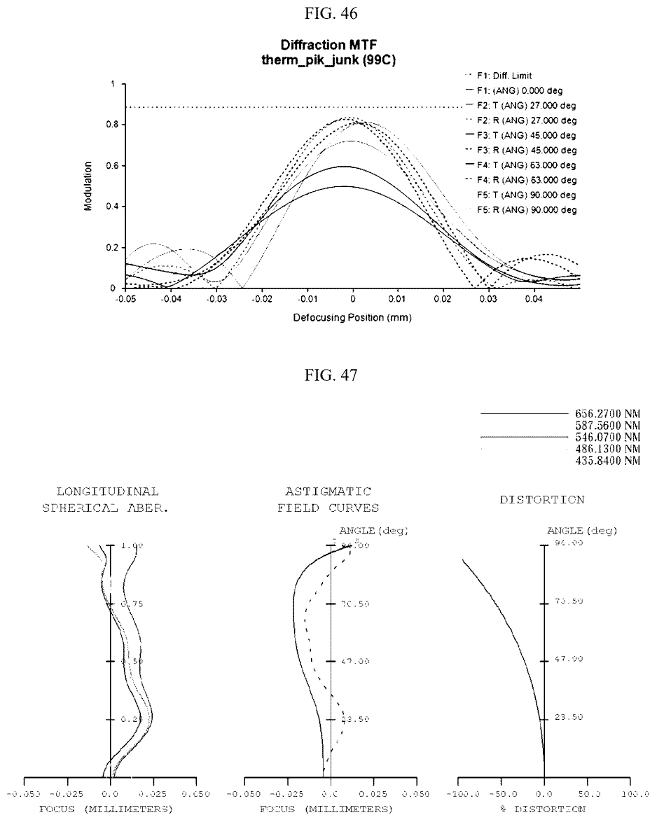

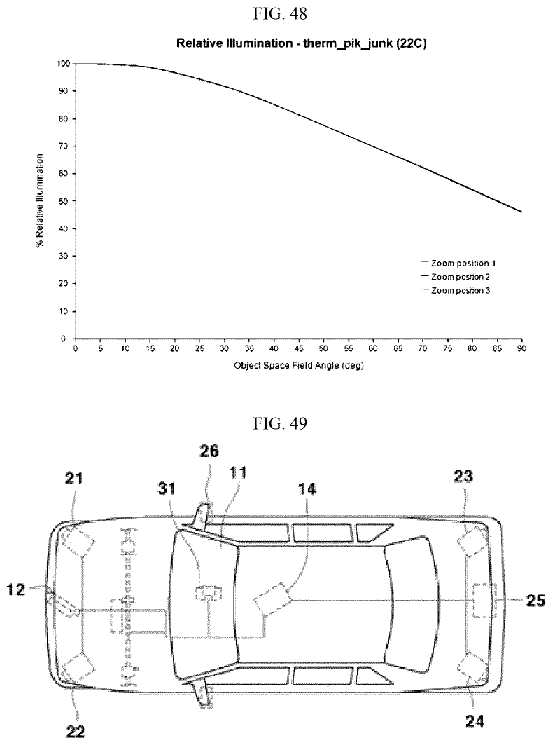

FIG. 37 is a side cross-sectional view of an optical system according to the fourth embodiment and a camera module having the same; FIG. 38 is a table showing aspherical coefficients of lenses in an optical system of FIG. 37; FIG. 39 is a table showing the thickness of each lens and the spacing between adjacent lenses in an optical system of FIG. 37; FIG. 40 is a table showing the Sag values of the lens surfaces of the first to eighth lenses in an optical system of FIG. 37; FIG. 41 is a table showing the Slope Angle of the lens surfaces of the first to eighth lenses in an optical system of FIG. 37; FIG. 42 is a graph showing data on the diffraction Modulation transfer function (MTF) of an optical system of FIG. 37 at room temperature; FIG. 43 is a graph showing data on the aberration characteristics of an optical system of FIG. 37 at room temperature; FIG. 44 is a graph showing data on the diffraction MTF of an optical system of FIG. 37 at low temperature; FIG. 45 is a graph showing data on the aberration characteristics of an optical system of FIG. 37 at low temperature; FIG. 46 is a graph showing data on the diffraction MTF of an optical system of FIG. 37 at high temperature; FIG. 47 is a graph showing data on the aberration characteristics of an optical system of FIG. 37 at high temperature; and FIG. 48 is a graph showing the peripheral illumination ratio of an optical system of FIG. 37.

Referring to FIG. 37, the optical system 1300 includes a lens unit, and the lens unit may include a first lens 401 to an eighth lens 408. The first to eighth lenses 401 to 408 may be sequentially disposed along an optical axis OA of the optical system 1300. Light corresponding to information about an object may pass through the first lens 401 to the eighth lens 408 and a filter 600 and be incident on an image sensor 500.

The first lens 401 may be disposed closest to the object side. The first lens 401 may be disposed farthest from the sensor side. The first lens 401 may have negative (−) refractive power on an optical axis OA. The first lens 401 may include a plastic material or a glass material, and may be, for example, a glass material. The first lens 401 made of a glass material may reduce changes in the center position and the radius of curvature due to temperature changes according to the surrounding environment, and may protect the incident side surface of the optical system 1300.

The first surface S1 on the object side of the first lens 401 with respect to the optical axis may be convex, and the second surface S2 on the sensor side may be concave. The first lens 401 may have a meniscus shape convex toward the object side. The first lens 401 may be made of glass and may have a spherical surface. At least one or both of the first surface S1 and the second surface S2 may be provided without a critical point from an optical axis OA to the end of the effective area.

Due to the refractive characteristics of the first lens 401, the second lens 402 can be further separated from the first lens 401. That is, the center gap between the first and second lenses 401 and 402 can be the largest within the lens unit.

The refractive index n1 of the first lens 401 can satisfy the condition of n1>1.7 or n1>1.72. Since the refractive index n1 of the first lens 401 is the largest in the lens unit, the radius of curvature of the first and second lenses 401 and 402 can be increased, and lens manufacturing can be easy. If the refractive index n1 of the first lens 401 is smaller than the condition, the lens surface must be formed to be sharply concave or convex in order to increase the refractive power of the first and second lenses 401 and 402. In this case, lens manufacturing is not easy, the lens defect rate increases, and it can cause a decrease in yield.

The second lens 402 may be disposed second from the object side. The second lens 402 may be disposed seventh from the sensor side. The second lens 402 may be disposed between the first lens 401 and the third lens 403. The second lens 402 may have negative (−) refractive power on an optical axis OA. The second lens 402 may include a plastic or glass material. For example, the second lens 402 may be provided with a plastic material.

The object-side third surface S3 of the second lens 402 with respect to the optical axis OA is concave, and the sensor-side fourth surface S4 may be concave. The second lens 402 may have a concave shape on both surfaces. The second lens 402 is made of a plastic material and may be aspherical. At least one or both of the third surface S3 and the fourth surface S4 may be aspherical. The aspherical coefficients of the third and fourth surfaces S3 and S4 may be provided as S1 and S2 of L2 in FIG. 38.

The third surface S3 of the second lens 402 may include a critical point from an optical axis OA to the end of the effective area. When the third surface S3 has a critical point, it may be located in a range of 90% to 97%, preferably 93% to 95%, of the effective radius r21 from an optical axis OA. The critical point of the third surface S3 may be located in a range of 4 mm to 4.5 mm, preferably 4.2 mm to 4.3 mm from an optical axis OA. The fourth surface S4 of the second lens 202 may be provided without a critical point from an optical axis OA to the end of the effective area.

The third lens 403 may be disposed third from the object side. The third lens 403 may be disposed sixth from the sensor side. The third lens 403 may be disposed between the second lens 402 and the fourth lens 404. The third lens 403 may have positive (+) refractive power on an optical axis OA. The third lens 403 may include a plastic or glass material. For example, the third lens 403 may be provided with a plastic material.

The object-side fifth surface S5 of the third lens 403 with respect to an optical axis may be convex, and the sensor-side sixth surface S6 may be convex. The third lens 403 may have a convex shape on both surfaces. The third lens 403 may be made of a plastic material and may be aspherical. At least one or both of the fifth surface S5 and the sixth surface S6 may be aspherical. The aspherical coefficients of the fifth and sixth surfaces S5 and S6 may be provided as S5 and S6 of L3 of FIG. 38.

The fifth surface S5 of the third lens 403 may include a critical point from an optical axis OA to the end of the effective area. When the fifth surface S5 has a critical point, it may be located in a range of 72% to 82%, preferably 75% to 79%, of the effective radius r31 from an optical axis OA. The critical point of the fifth surface S5 may be located in a range of 1.5 mm to 2 mm, preferably 1.8 mm to 1.9 mm from an optical axis OA. The sixth surface S6 of the third lens 403 may be provided without a critical point from an optical axis OA to the end of the effective area.

The fourth lens 404 may be disposed fourth from the object side. The fourth lens 404 may be disposed fifth from the sensor side. The fourth lens 404 may be disposed between the third lens 403 and the fifth lens 405. The fourth lens 404 may have positive (+) or negative (−) refractive power on an optical axis OA. The fourth lens 404 may have negative (−) refractive power. The fourth lens 404 may include a plastic or glass material. For example, the fourth lens 404 may be provided with a plastic material.

The seventh surface S7 on the object side of the fourth lens 404 with respect to an optical axis may be concave, and the eighth surface S8 on the sensor side may be convex. The fourth lens 404 may have a convex meniscus shape toward the sensor side. The fourth lens 404 may have a concave meniscus shape toward the object side. The fourth lens 404 is made of a plastic material and may be aspherical. At least one or both of the seventh surface S7 and the eighth surface S8 may be aspherical. Aspherical coefficients of the seventh and eighth surfaces S7 and S8 may be provided as S1 and S2 of L4 of FIG. 38.

The seventh surface S7 of the fourth lens 404 may include a critical point from an optical axis OA to the end of the effective area. When the seventh surface S7 has a critical point, it may be located in a range of 70% to 80%, preferably in a range of 71% to 76%, of the effective radius r41 from an optical axis OA. The critical point of the seventh surface S7 may be located in a range of 1.3 mm to 2 mm, preferably in a range of 1.5 mm to 1.6 mm from an optical axis OA. The eighth surface S8 of the fourth lens 404 may be provided without a critical point from an optical axis OA to the end of the effective area.

The aperture Stop may be disposed around the sensor-side eighth surface S8 of the fourth lens 404. The aperture Stop may be disposed around the object-side ninth surface S9 of the fifth lens 405. The aperture may reduce the TTL within the field of view range, and may enable miniaturization of the optical system. Accordingly, a decrease in the yield by weight of the optical system may be inhibited, and production efficiency may be improved. In addition, the optical system may be miniaturized by reducing the TTL at a horizontal field of view FOV_H of 170 degrees to 190 degrees.

The fifth lens 405 may be disposed as the fifth lens from the object side. The fifth lens 405 may be disposed as the fourth lens from the sensor side. The fifth lens 405 may be disposed between the fourth lens 304 and the sixth lens 406. The fifth lens 405 may have positive (+) or negative (−) refractive power on an optical axis OA. The fifth lens 405 may have positive (+) refractive power. The fifth lens 405 may include a plastic or glass material. For example, the fifth lens 405 may be provided as a glass material.

With respect to an optical axis OA, the ninth surface S9 on the object side of the fifth lens 405 may be convex, and the tenth surface S10 on the sensor side may be convex. The fifth lens 405 may have a shape in which both surfaces are convex. The fifth lens 405 is made of glass and may be aspherical. At least one or both of the ninth surface S9 and the tenth surface S10 may be aspherical.

The sixth lens 406 may be disposed as the sixth lens from the object side. The sixth lens 406 may be disposed as the third lens from the sensor side. The sixth lens 406 may be disposed between the fifth lens 405 and the seventh lens 407. The sixth lens 406 may have positive (+) or negative (−) refractive power on an optical axis OA. The sixth lens 406 may have positive (+) refractive power. The sixth lens 406 may include a plastic or glass material. For example, the sixth lens 406 may be provided as a plastic material.

With respect to the optical axis OA, the object-side eleventh surface S11 of the sixth lens 406 may be convex, and the sensor-side twelfth surface S12 may be convex. The sixth lens 406 may have a convex shape on both surfaces. The sixth lens 406 may be made of a plastic material and may be aspherical. At least one or both of the eleventh surface S11 and the twelfth surface S12 may be aspherical. Aspherical coefficients of the eleventh and twelfth surfaces S11 and S12 may be provided as S1 and S2 of L6 of FIG. 38. At least one or both of the eleventh surface S11 and the twelfth surface S12 may be provided without a critical point from an optical axis OA to the end of the effective area.

The seventh lens 407 may be disposed seventh from the object side. The seventh lens 407 may be disposed second from the sensor side. The seventh lens 407 may be disposed between the sixth lens 406 and the eighth lens 408. The seventh lens 407 may have positive (+) or negative (−) refractive power on an optical axis OA. The seventh lens 407 may have negative (−) refractive power. The seventh lens 407 may include a plastic or glass material. For example, the seventh lens 407 may be provided with a plastic material.

With respect to an optical axis OA, the 13th surface S13 on the object side of the seventh lens 407 may be convex, and the 14th surface S14 on the sensor side may be convex. The seventh lens 407 may have a shape in which both surfaces are convex. The seventh lens 407 may be made of a plastic material and may be aspherical. At least one or both of the 13th surface S13 and the 14th surface S14 may be aspherical. Aspherical coefficients of the 13th and 14th surfaces S13 and S14 may be provided as S13 and S14 of L7 of FIG. 38. At least one or both of the 13th surface S13 and the 14th surface S14 may be provided without a critical point from an optical axis OA to the end of the effective area.

The eighth lens 408 may be disposed furthest from the object side. The eighth lens 408 may be disposed closest to the image sensor 500. The eighth lens 408 may have positive (+) or negative (−) refractive power on an optical axis OA. The eighth lens 408 may have positive (+) refractive power. The eighth lens 408 may include a plastic or glass material. For example, the eighth lens 408 may be provided with a plastic material.

With respect to the optical axis OA, the object-side 15th surface S15 of the eighth lens 408 may have a convex shape, and the sensor-side 16th surface S16 may have a convex shape. The eighth lens 408 may have a convex shape on both surfaces. At least one or both of the 15th surface S15 and the 16th surface S16 may be aspherical. The aspherical coefficients of the 15th and 16th surfaces S15 and S16 may be provided as S15 and S16 of L8 of FIG. 38. At least one or both of the 15th surface S15 and the 16th surface S16 may be provided without a critical point from the optical axis OA to the end of the effective area.

The eighth lens 408 may be a plastic lens that is closest to the image sensor 500. In addition, by arranging two or more plastic lenses adjacent to the image sensor 500, aberrations such as spherical aberration and chromatic aberration can be improved by the lens surface having an aspherical surface, and the influence on the resolution can be controlled. In addition, by arranging the plastic lens as the lens adjacent to the image sensor 500, it can be insensitive to the assembly tolerance compared to a glass lens. That is, being insensitive to the assembly tolerance means that even if the assembly is slightly different from the design during assembly, the optical performance may not be significantly affected. In addition, by providing the two lenses 407 and 408 adjacent to the image sensor 500 as plastic, the optical performance can be improved by the lens surface having an aspherical surface, and for example, aberration characteristics can be improved and resolution deterioration can be inhibited.

TABLE 10

| | | | | | | Semi | Focal |
|---|---|---|---|---|---|---|---|
| Lens | Surface | Radius | Thickness | nd | vd | Aperture | length |
| 1 | S1 | 13.522 | 2.000 | 2.0091 | 29.1342 | 8.908 | −8.9126 |
| | S2 | 5.000 | 3.998 | | | 4.718 | |
| 2 | S3 | −4.051 | 1.500 | 1.5371 | 55.7074 | 4.583 | −5.4565 |
| | S4 | 11.970 | 0.885 | | | 2.538 | |
| 3 | S5 | 8.728 | 2.486 | 1.6633 | 21.2414 | 2.481 | 4.3117 |
| | S6 | −3.771 | 0.101 | | | 2.298 | |
| 4 | S7 | −3.904 | 2.169 | 1.6633 | 21.2414 | 2.100 | −7.3452 |
| | S8 | −24.010 | 0.399 | | | 2.081 | |
| | STOP | — | 0.737 | | | 2.102 | |
| 5 | S9 | 19.577 | 1.842 | 1.5521 | 75.4952 | 2.422 | 7.8914 |
| | S10 | −5.416 | 0.100 | | | 2.600 | |
| 6 | S11 | 8.568 | 2.145 | 1.5371 | 55.7074 | 2.800 | 7.1286 |
| | S12 | −6.317 | 0.100 | | | 2.869 | |
| 7 | S13 | −6.315 | 1.500 | 1.6633 | 21.2414 | 2.854 | −4.2296 |
| | S14 | 5.526 | 0.794 | | | 3.342 | |
| 8 | S15 | 5.871 | 3.500 | 1.5371 | 55.7074 | 4.040 | 7.7493 |
| | S16 | −11.321 | 1.795 | | | 4.476 | |
| Cover | | infinity | 0.900 | | | | |
| | | | 0.500 | | | | |
| Image | | infinity | 0.000 | | | | |

Table 10 shows the surface number Surface, radius of curvature Radius, center thickness of each lens or distance between lens surfaces Thickness, refractive index nd, Abbe number vd, effective radius Semi Aperture, and focal length Focal length of the lens according to a third embodiment of the present invention. At this time, the unit of the radius of curvature and thickness or distance may be mm.

TABLE 11

| Category | Value | Category | Value |
|---|---|---|---|
| F | 2.8720 | F-number | 1.8400 |
| ET1 | 2.0898 | FOV_H | 180.0000 |
| ET2 | 2.8196 | EPD | 1.5609 |
| ET3 | 1.9647 | BFL | 0.5000 |
| ET4 | 2.4078 | TD | 26.9500 |
| ET5 | 1.0282 | ImgH | 4.32 |
| ET6 | 0.9950 | SD | 13.4121 |
| ET7 | 3.0065 | TTL | 27.4500 |
| ET8 | 1.6464 | GLca_Aver | 9.324 |
| ΣIndex | 13.1624 | PLca_Aver | 5.933 |
| ΣAbbe | 335.4758 | CT_max | 3.5000 |
| ΣCT | 17.1413 | CT_min | 1.5000 |
| ΣCG | 7.1136 | CT_Aver | 2.1427 |
| CA_max | 17.816 | F_LG1 | −7.688 |
| CA_min | 4.163 | F_LG2 | 6.416 |
| CA_Aver | 6.731 | | |

Table 8 shows categories of Mathematical expression described above in the optical system 1300 of the embodiment, including the total track length (TTL) (mm), back focal length (BFL), effective focal length F (mm), ImgH (mm), effective diameter CA (mm), thickness (mm), TTL (mm), TD (mm), which is the optical axis distance from the first surface S1 to the twelfth surface S12, sum of refractive indices, sum of Abbe numbers, sum of thicknesses (mm), sum of gaps between adjacent lenses, effective diameter characteristics, sum of refractive indices of glass lenses, sum of refractive indices of plastic materials, angle of view FOV_H (degree), edge thickness ET, F number, and the like of the optical system 1300.

The center thickness of the first to eighth lenses 401 to 408 is represented by CT1 to CT8, the edge thickness at the end of the effective area of each lens is represented by ET1 to ET8, the center gap between two adjacent lenses is represented by CG1 to CG7, and the edge gap between the edges of each lens is represented by EG1 to EG7. Back focal length (BFL) is the optical axis distance from the image sensor 500 to the center of the last lens. TTL is the optical axis distance from the center of the first surface S1 of the first lens 301 to the upper surface of the image sensor 500.

As illustrated in FIG. 38, among the lenses of the lens unit in the third embodiment, the lens surfaces of the second, third, fourth, sixth, seventh, and eighth lenses 402, 403, 404, 406, 407, and 408 may include aspherical surfaces having a 30th order aspherical surface coefficient. For example, the second, third, fourth, sixth, seventh, and eighth lenses 402, 403, 404, 406, 407, and 408 may include lens surfaces having a 30th order aspherical surface coefficient. As described above, since the aspherical surface having the 30th order aspherical surface coefficient (a value other than “0”) can significantly change the aspherical shape of the peripheral portion, the optical performance of the peripheral portion of the field of view (FOV) can be well corrected.

The thickness T1 to T8 of the first to eighth lenses 401 to 408 and the gap G1 to G7 between adjacent two lenses can be set. As shown in FIG. 3, the thickness T1 to T8 of each lens in a Y-axis direction can be expressed at a gap of 0.1 mm or 0.2 mm or more, and the gap G1 to G7 between each lens can be expressed at a gap of 0.1 mm or 0.2 mm or more.

When comparing the absolute values of the radius of curvature of each lens, the radius of curvature of the seventh surface S7 of the fourth lens 404 on an optical axis OA may be the largest among the lenses, and the radius of curvature of the fourth surface S4 of the second lens 402 may be the smallest among the lenses. The difference between the maximum radius of curvature and the minimum radius of curvature may be 8 times or more, for example, in the range of 7.5 times to 8.5 times.

Since the effective diameter of a plastic lens is smaller than that of a glass lens, the lens placed on the object side of a plastic lens can have strong refractive power in order to refract light through the plastic lens. In addition, the radius of curvature of the lens surface can be small in order to strengthen the refractive power.

The absolute value of the curvature radius of the first surface S1 of the first lens 401 may be greater than the absolute value of the curvature radius of the second surface S2. The absolute value of the curvature radius of the third surface S3 of the second lens 402 may be greater than the absolute value of the curvature radius of the fourth surface S4. The absolute value of the curvature radius of the fifth surface S5 of the third lens 403 may be greater than the absolute value of the curvature radius of the sixth surface S6. The absolute value of the curvature radius of the seventh surface S7 of the fourth lens 404 may be greater than the absolute value of the curvature radius of the eighth surface S8. The absolute value of the curvature radius of the ninth surface S9 of the fifth lens 405 may be greater than the absolute value of the curvature radius of the tenth surface S10. The absolute value of the curvature radius of the eleventh surface S11 of the sixth lens 406 may be greater than the absolute value of the curvature radius of the twelfth surface S12. The absolute value of the curvature radius of the thirteenth surface S13 of the seventh lens 407 may be greater than the absolute value of the curvature radius of the fourteenth surface S14. The absolute value of the curvature radius of the fifteenth surface S15 of the eighth lens 408 may be less than the absolute value of the curvature radius of the sixteenth surface S16.

The ratio of the radius of curvature of each lens can satisfy the following conditions.

$$Condition 1 : 2 < L 1 R 1 / L 1 R 2 \vert < 3$$

$$Condition 2 : 0.1 < \vert L 2 R 1 / L 2 R 2 \vert < 0.5$$

$$Condition 3 : 2 < \vert L 3 R 1 / L 3 R 2 \vert < 3$$

$$Condition 4 : 0.1 < \vert L 4 R 1 / L 4 R 2 \vert < 0.5$$

$$Condition 5 : 3 < \vert L 5 R 1 / L 5 R 2 \vert < 4$$

$$Condition 6 : 1 < \vert L 6 R 1 / L 6 R 2 \vert < 2$$

$$Condition 7 : 1 < \vert L 7 R 1 / L 7 R 2 \vert < 2$$

$$Condition 8 : 0.5 < \vert L8R 1 / L 8 R 2 \vert < 1$$

When explaining the center thickness CT of the lenses with respect to the optical axis, the center thickness CT8 of the eighth lens 408 is the largest among the lenses, and the center thickness CT2, CT4, and CT7 of at least one of the second lens 402, the third lens 403, and the seventh lens 407 is the smallest among the lenses. The difference between the maximum center thickness and the minimum center thickness among the lenses may be in the range of 2 mm or more and 2.5 mm or less. The center thickness of the eighth lens 408 disposed closest to the sensor side may be set to the largest so as to be suitable for the chief ray angle (CRA) of the image sensor 500.

The center thickness of each lens can satisfy any one among the following conditions.

$$Condition 1 : CT 1 , CT 3 , CT 4 , CT 6 > CT 1 > CT 2 , CT 5 , CT 7$$

$$Condition 2 : CT 1 , CT 3 , CT 4 , CT 5 , CT 6 , CT 8 > CT 2 = CT 7$$

$$Condition 3 : CT 8 > CT 3 > CT 1 , CT 2 , CT 4 , CT 5 , CT 6 , CT 7$$

$$Condition 4 : CT 1 , CT 3 , CT 4 , CT 6 , CT 8 > CT 5 , > CT 2 = CT 7$$

$$Condition 5 : CT 3 , CT 4 , CT 8 > CT 6 > CT 1 , CT 2 , CT 5 , CT 7$$

$$Condition 6 : CT 8 > CT 1 , CT 2 , CT 3 , CT 4 , CT 5 , CT 6 , CT 7$$

When explaining the center gap CG between the lenses, the center gap CG1 between the first lens 401 and the second lens 402 may be the maximum, and at least one of the center gap CG5 between the fifth and sixth lenses 405 and 406 and the center gap CG6 between the sixth and seventh lenses 406 and 407 may be the minimum. The difference between the maximum center gap and the minimum center gap among the spaced lens gaps may be 3 mm or more, for example, in the range of 3 mm to 4 mm.

The center gap of each lens can satisfy any one among the following conditions.

$$Condition 1 : CG 1 > CG 2 , CG 3 , CG 4 , CG 5 , CG 6 , CG 7$$

$$Condition 2 : CG 1 , CG 4 > CG 2 > CG 3 , CG 5 , CG 6 , CG 7$$

$$Condition 3 : CG 1 , CG 2 , CG 4 , CG 7 > CG 3 > CG 5 , CG 6$$

$$Condition 4 : CG 1 > CG 4 > CG 2 , CG 3 , CG 5 , CG 6 , CG 7$$

$$Condition 5 : CG 1 , CG 2 , CG 3 , CG 4 , CG 7 > CG 5 = CG 6$$

$$Condition 7 : CG 1 , CG 2 , CG 4 > CG 7 > CG 3 , CG 5 , CG 6$$

When explaining the effective diameter, the lens having the maximum effective diameter may be a glass lens. The lens having the maximum effective diameter may be the first lens 401. Here, the effective diameter is an average of the effective diameter of the object side surface and the effective diameter of the sensor side surface of each lens. The lens surface having the maximum effective diameter may be the first surface S1 of the first lens 401.

The lens having the minimum effective diameter may be a lens disposed between the first lens 401 and the aperture STOP. The lens having the minimum effective diameter may be the fourth lens 404. The lens surface having the minimum effective diameter may be the eighth surface S8 of the fourth lens 404. The effective diameter of the lens made of a plastic material may be smaller than the effective diameter of the lens made of a glass material. The lens made of a plastic material may be disposed adjacent to the image sensor.

The effective diameter of each lens can satisfy any one among the conditions below.

$$Condition 1 : CA\_L1 > CA\_L2 , CA\_L3 , CA\_L4 , CA\_L5 , CA\_L6 , CA\_L7 , CA\_L8$$

$$Condition 2 : CA\_L1 , CA\_L8 > CA\_L2 > CA\_L3 , CA\_L4 , CA\_L5 , CA\_L6 , CA\_L7$$

$$Condition 3 : CA\_L1 , CA\_L2 , CA\_L5 , CA\_L6 , CA\_L7 , CA\_L8 > CA\_L3 > CA\_L4$$

$$Condition 4 : CA\_L1 , CA\_L2 , CA\_L3 , CA\_L5 , CA\_L6 , CA\_L7 , CA\_L8 > CA\_L4$$

$$Condition 5 : CA\_L1 , CA\_L2 , CA\_L6 , CA\_L7 , CA\_L8 > CA\_L5 > CA\_L3 > CA\_L4$$

$$Condition 6 : CA\_L1 , CA\_L2 , CA\_L7 , CA\_L8 > CA\_L6 > CA\_L3 , CA\_L4 , CA\_L5$$

$$Condition 7 : CA\_L1 , CA\_L2 , CA\_L8 > CA\_L7 > CA\_L3 , CA\_L4 , CA\_L5 , CA\_L6$$

$$Condition 8 : CA\_L1 > CA\_L8 > CA\_L2 , CA\_L3 , CA\_L4 , CA\_L5 , CA\_L6 , CA\_L7$$

When explaining the refractive index of the first lens 401 may be the largest among the lenses and may be greater than 2, for example, greater than 2.02. One or both of the second lens 402, the sixth lens 406, and the eighth lens 408 may have the smallest refractive index among the lenses. For example, the refractive indices among the second lens 402, the sixth lens 406, and the eighth lens 408 may be the smallest among the lenses and may be less than 1.6, for example, less than 1.55. The difference between the maximum refractive index and the minimum refractive index may be 0.2 or more. By providing a high refractive index lens made of glass closest to an object, and providing a lens adjacent to the glass lens and a lens adjacent to the image sensor 500 as a low refractive index lens made of plastic, the incidence efficiency can be increased, and the refractive power between the lenses made of glass and plastic can be adjusted to guide light to the image sensor 500.

The refractive index of each lens can satisfy any one among the conditions below.

$$Condition 1 : n 1 > n 2 , n 3 , n 4 , n 5 , n 6 , n 7 , n 8$$

$$Condition 2 : n 1 , n 3 , n 4 , n 5 , n 7 > n 2 = n 6 = n 8$$

$$Condition 3 : n 1 > n 3 = n 4 = n 7 > n 2 , n 5 , n 6 , n 8$$

$$Condition 4 : n 1 , n 3 , n 4 , n 7 > n 5 > n 2 , n 6 , n 8$$

When comparing the Abbe numbers, the Abbe number of the fifth lens 405 is the largest among the lenses, and may be 60 or more. The Abbe number of at least one among the third lens 403, the fourth lens 404, and the seventh lens 407 is the smallest among the lenses, and may be 25 or less. The difference between the maximum refractive index and the minimum Abbe number may be 50 or more. By making the Abbe number of the fifth lens 405 disposed at the center of the optical system 1000 the largest, and providing the Abbe number of the seventh lens 407 having a low refractive index adjacent to the image sensor 500 the smallest, the chromatic dispersion of light traveling between the lenses made of glass and plastic can be controlled, and the chromatic dispersion between the lenses made of glass and plastic can be increased to guide it to the image sensor 500.

The Abbe number of a lens can satisfy any one among the following conditions.

$$Condition 1 : v 2 , v 5 , v 6 , v 8 > v 1 > v 3 , v 4 , v 7$$

$$Condition 2 : v 5 > v 2 = v 6 = v 8 > v 1 , v 3 , v 4 , v 7$$

$$Condition 3 : v 1 , v 2 , v 5 , v 6 , v 8 > v 3 = v 4 = v 7$$

$$Condition 4 : v 5 > v 1 , v 2 , v 3 , v 4 , v 6 , v 7 , v 8$$

The focal lengths F1, F2, F4, and F7 of the first, second, fourth, and seventh lenses 401, 402, 404, and 407 may have negative (−) signs. The first, second, fourth, and seventh lenses 401, 402, 404, and 407 may have negative (−) refractive power. The focal lengths F3, F5, F6, and F8 of the third, fifth, sixth, and eighth lenses 403, 405, 406, and 408 may have positive (+) signs. The third, fifth, sixth, and eighth lenses 403, 405, 406, and 408 may have positive (+) refractive power. The third lens 403 having positive (+) refractive power may be disposed on the sensor side of the first lens 401 and the second lens 402 having negative (−) refractive power. Through this, light incident on the object side can move away from an optical axis direction and then gather again on an optical axis direction, thereby forming a stable optical path.

In addition, the sixth lens 406 and the seventh lens 407, which are adjacently disposed lenses, can satisfy the following conditions.

Refractive index of a lens with positive refractive power<Refractive index of a lens with negative refractive power Condition 1:

Dispersion value of a lens with positive refractive power>Dispersion value of a lens with negative refractive power Condition 2:

Here, among the plastic lenses, the sixth lens 406 has positive refractive power and the seventh lens 407 has negative refractive power, so that according to Conditions 1 and 2, the refractive index of the sixth lens 406 is smaller than that of the seventh lens 407, and the dispersion value of the sixth lens 406 is larger than that of the seventh lens 407. Chromatic aberration occurring in the plastic lens can be corrected by the plastic lens. In addition, since the sixth lens 406 and the seventh lens 407, which are plastic lenses being disposed in succession, satisfy the refractive index difference of 0.1 or more and 0.15 or less and the Abbe number difference of 20 or more and 50 or less, the chromatic aberration occurring in the plastic lens can be compensated for by the plastic lens.

The optical system has chromatic aberration, and chromatic aberration is corrected by using cemented lenses or two lenses disposed in succession. As the temperature changes from low to high, the lenses repeatedly contract and expand. Since the amount of change in lens characteristics according to the temperature change is the same for lenses of the same material, it is effective to correct chromatic aberration between lenses of the same material even when the temperature changes. Therefore, in a first embodiment of the present invention, chromatic aberration occurring in a plastic lens can be corrected by using the sixth lens 406 and the seventh lens 407.

From an optical axis to the effective diameter area, the maximum value of the distance between two lenses having the largest difference in Abbe numbers among two adjacent lenses may be smaller than the maximum value of the distance between the other two adjacent lenses. Here, the distance may mean the distance between the two lenses from an optical axis to the effective diameter area. The two lenses having the largest difference in Abbe numbers among two adjacent lenses may be the second lens 402 and the third lens 403, and the sixth lens 406 and the seventh lens 407. From an optical axis to the effective diameter area, in a direction perpendicular to the optical axis, the maximum value of the distance from the sensor side surface (the twelfth surface) S12 of the sixth lens 406 to the object side surface (the thirteenth surface) S13 of the seventh lens 407 may be smaller than the maximum value of the distance between the other two adjacent lenses. Through this, the distance between two lenses made of plastic material that is difficult to bond can be designed to be small, and the difference in Abbe numbers can be maximized to have the effect of reducing chromatic aberration to the same extent as a bonded lens even in a non-bonded state.

When comparing the focal lengths in absolute value, the focal length of the first lens 401 is the largest among the lenses, and may be 8 or more and 10 or less. The focal length of the seventh lens 407 is the smallest among the lenses, and the absolute value of the focal length of the seventh lens 407 may be 4 or more and 5 or less.

The absolute value of the focal length of each lens can satisfy any one among the conditions below.

$$Condition 1 : \vert f 1 \vert > \vert f 2 \vert , \vert f 3 \vert , \vert f 4 \vert , \vert f 5 \vert , \vert f 6 \vert , \vert f 7 \vert , \vert f 8 \vert$$

$$Condition 2 : \vert f 1 \vert , \vert f 4 \vert , \vert f 5 \vert , \vert f 6 \vert , \vert f 8 \vert > \vert f 2 \vert > \vert f 3 \vert , \vert f 7 \vert$$

$$Condition 3 : \vert f 1 \vert , \vert f 2 \vert , \vert f 4 \vert , \vert f 5 \vert , \vert f 6 \vert , \vert f 8 \vert > \vert f 3 \vert > \vert f 7 \vert$$

$$Condition 4 : \vert f 1 \vert , \vert f 5 \vert , \vert f 8 \vert > \vert f 4 \vert > \vert f 2 \vert , \vert f 3 \vert , \vert f 6 \vert , \vert f 7 \vert$$

$$Condition 5 : \vert f 1 \vert > \vert f 5 \vert > \vert f 2 \vert , \vert f 3 \vert , \vert f 4 \vert , \vert f 6 \vert , \vert f 7 \vert , \vert f 8 \vert$$

$$Condition 6 : \vert f 1 \vert , \vert f 4 \vert , \vert f 5 \vert , \vert f 8 \vert > \vert f 6 \vert > \vert f 2 \vert , \vert f 3 \vert , \vert f 7 \vert$$

$$Condition 7 : \vert f 1 \vert , \vert f 2 \vert , \vert f 3 \vert , \vert f 4 \vert , \vert f 5 \vert , \vert f 6 \vert , \vert f 8 \vert > \vert f 7 \vert$$

$$Condition 8 : \vert f 1 \vert , \vert f 5 \vert > \vert f 8 \vert > \vert f 2 \vert , \vert f 3 \vert , \vert f 4 \vert , \vert f 6 \vert , \vert f 7 \vert$$

The thickness T1 of the first lens 401 may be a difference of 1.1 times or more between the maximum thickness and the minimum thickness, for example, 1.2 times to 1.5 times, and the center thickness CT1 may be a minimum and the edge thickness ET1 may be a maximum. The thickness T2 of the second lens 402 may be a maximum thickness in a range of 1.5 times to 2 times the minimum thickness. The second lens 402 may be a minimum in the center thickness CT2 and the maximum in the edge thickness ET2. The thickness T3 of the third lens 403 may be a maximum at the center and a minimum at the edge, and the maximum thickness is in a range of 1.1 times to 1.5 times the minimum thickness. The thickness T4 of the fourth lens 404 may be a minimum at the center and a maximum at the edge, and the maximum thickness is in a range of 1.1 times to 1.5 times the minimum thickness. The thickness T5 of the fifth lens 405 may be maximum at the center and minimum at the edge and the maximum thickness is in a range of 1.5 to 2 times the minimum thickness. The thickness T6 of the sixth lens 406 may be maximum at the center and minimum at the edge and the maximum thickness is in a range of 2 to 2.5 times the minimum thickness. The thickness T7 of the seventh lens 407 may be minimum at the center and maximum at the edge and the maximum thickness is in a range of 2 to 2.5 times the minimum thickness. The thickness T8 of the eighth lens 408 may be maximum at the center and minimum at the edge and the maximum thickness is in a range of 2 to 2.5 times the minimum thickness.

The ratio of the center thickness to the edge thickness of each lens can be referred to as a ‘meat slice ratio’. When the ratio of the large and small values of the center thickness and the edge thickness satisfies 2 to 2.5, manufacturability of a lens can be improved and advantageous in terms of yield.

The thickness of each lens can satisfy any among the following conditions.

$$Condition 1 : 0.5 < CT 1 / ET 1 < 1 , 1 < ET 1 / CT 1 < 1.5$$

$$Condition 2 : 0.3 < CT 2 / ET 2 < 0.6 , 1.5 < ET 2 / CT 2 < 2$$

$$Condition 3 : 1 < CT 3 / ET 3 < 1.5 , 0.5 < ET 3 / CT 3 < 1$$

$$Condition 4 : 0.5 < CT 4 / ET 4 < 1 , 1 < ET 4 / CT 4 < 1.5$$

$$Condition 5 : 5 < CT 5 / ET 5 < 2 , 0.4 < ET 5 / CT 5 < 0.6$$

$$Condition 6 : 2 < CT 6 / ET 6 < 2.5 , 0.1 < ET 6 / CT 6 < 0.5$$

$$Condition 7 : 0.1 < CT 7 / ET 7 < 0.5 , 2 < ET 7 / CT 7 < 2.5$$

$$Condition 8 : 2 < CT 8 / ET 8 < 2.5 , 0.1 < ET 8 / CT 8 < 0.5$$

$$Condition 7 : 1 < \sum CT / \sum ET < 1.2 , 0 \text{.5} < \sum ET / \sum CT < 1$$

Among the gaps G1 to G7 between the lenses, the first gap G1 between the first and second lenses 401 and 402 may have a maximum in the center portion and a minimum in the edge. The second gap G2 between the second and third lenses 402 and 403 may have a maximum in the center and a minimum in the edge. The third gap G3 between the third and fourth lenses 403 and 404 may have a maximum in the edge and a minimum in the center portion. The fourth gap G4 between the fourth and fifth lenses 404 and 405 may have a minimum in the center portion and a maximum in the edge. The fifth gap G5 between the fifth and sixth lenses 405 and 406 may have a minimum in the center portion and a maximum in the edge. The sixth gap G6 between the sixth and seventh lenses 406 and 407 may have a minimum in the center portion and a maximum in the edge. The seventh gap G7 between the seventh and eighth lenses 407 and 408 may be maximum at the center portion and minimum at the edge.

FIGS. 42, 44, and 46 are graphs illustrating a diffraction modulation transfer function (MTF) at room temperature, low temperature, and high temperature in the optical system of FIG. 37, illustrating a luminance ratio (modulation) according to a spatial frequency. As illustrated in FIGS. 42, 44, and 46, in a fourth embodiment of the present invention, a deviation of MTF to a low temperature or a high temperature with respect to room temperature may be less than 10%, that is, 7% or less.

FIGS. 43, 45, and 47 are graphs showing aberration characteristics at room temperature, low temperature, and high temperature in the optical system of FIG. 37. In the aberration graphs of FIGS. 43, 45, and 47, spherical aberration (longitudinal spherical aberration), astigmatic field curves, and distortion are measured from left to right. In FIGS. 43, 45, and 47, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 43, 45, and 47, it can be interpreted that the closer each curve at room temperature, low temperature, and high temperature is to a Y-axis, the better the aberration correction function is. It can be seen that the optical system 1300 according to a second embodiment has measurement values close to a Y-axis in almost all areas. That is, the optical system 1300 according to a second embodiment has improved resolution and can have good optical performance not only in the center portion of the field of view (FOV) but also in the periphery portion. Here, the low temperature is −20 degrees or lower, for example, in the range of −20 to −40 degrees, the room temperature is in the range of 22 degrees±5 degrees or in the range of 18 degrees to 27 degrees, and the high temperature can be 85 degrees or higher, for example, in the range of 85 degrees to 105 degrees. Accordingly, it can be seen that the decrease in the modulation from low to high temperature in FIGS. 43, 45, and 47 is less than 10%, for example, less than 5%, or is almost unchanged.

Table 13 compares changes in optical characteristics such as EFL, BFL, F number F #, TTL, and field of view FOV_H at room temperature, low temperature, and high temperature in the optical system according to a fourth embodiment, and it can be seen that the change rate of the optical characteristics at low temperature is 5% or less, for example, 3% or less, with respect to room temperature, and it can be seen that the change rate of the optical characteristics at low temperature is 5% or less, for example, 3% or less, with respect to room temperature.

TABLE 12

| | Room | Low | High | Low/Room | High/Room |
|---|---|---|---|---|---|
| | temper- | temper- | temper- | temper- | temper- |
| | ature | ature | ature | ature | ature |
| EFL(F) | 2.87 | 2.86 | 2.89 | 99.65% | 100.69% |
| BFL | 3.20 | 3.19 | 3.20 | 99.68% | 100.00% |
| F# | 1.84 | 1.83 | 1.85 | 99.45% | 100.54% |
| TTL | 27.45 | 27.38 | 27.53 | 99.74% | 100.29% |
| FOV_H | 180.00 | 181.69 | 177.98 | 100.93% | 98.87% |

Therefore, as shown in Table 12, it can be seen that the changes in optical characteristics according to the temperature change from low temperature to high temperature, for example, the change rate of effective focal length (EFL), TTL, BFL, F number, and field of view FOV_H, are less than 10%, that is, less than 5%, for example, in the range of 0 to 5%. This makes it possible to design temperature compensation for plastic lenses even when using at least one or two or more plastic lenses, thereby inhibiting a decrease in the reliability of optical characteristics.

The optical system of a fourth embodiment disclosed above can effectively control aberration characteristics such as chromatic aberration and distortion aberration, and can have good optical performance not only at the center portion of the field of view (FOV) but also at the periphery portion.

The optical systems 1000, 1100, 1200, and 1300 according to the first to fourth embodiments disclosed above can satisfy at least one or two or more of Mathematical expressions described below. Accordingly, the optical systems 1000, 1100, 1200, and 1300 according to the first to fourth embodiments can have improved optical characteristics. For example, when the optical systems 1000, 1100, 1200, and 1300 satisfies at least one Mathematical expression, the optical systems 1000, 1100, 1200, and 1300 can effectively control aberration characteristics such as chromatic aberration and distortion aberration, and can have good optical performance not only at the center portion of the field of view (FOV) but also at the periphery portion. In addition, the optical systems 1000, 1100, 1200, and 1300 can have improved resolution. In addition, the thickness at the optical axis OA of the lens described in Mathematical expressions and the gap at the optical axis OA of adjacent lenses may refer to the first to fourth embodiments disclosed above.

$$3 < L 1 R 2 < 10 \qquad [ Mathematical expression 1 ]$$

In Mathematical expression 1, L1R2 is the radius of curvature of the sensor side surface (second surface) S2 of the first lenses 101, 201, 301, and 401. If Mathematical expression 1 is satisfied, a gap between the first lenses 101, 201, 301, and 401 and the second lenses 102, 202, 302, and 402 can be secured when assembling the lenses, and assembly can be facilitated. In addition, if Mathematical expression 1 is satisfied, the influence on incident light and TTL can be controlled. In the first to fourth embodiments, Mathematical expression 1 can preferably satisfy 3<L1R2<7.

$$70 < v 5 < 90 \qquad [ Mathematical expression 2 ]$$

In Mathematical expression 2, v5 is the Abbe number of the fifth lenses 105, 205, 305, and 405. In the optical systems 1000, 1100, 1200, and 1300, the influence of the fifth lenses 105, 205, 305, and 405 may be the greatest, and by increasing the Abbe number, dispersion may be minimal and chromatic aberration may be small. In the first to fourth embodiments, Mathematical expression 2 may preferably satisfy 73<v5<85.

$$0.3 < CG 1 / \sum CG < 0.8 \qquad [ Mathematical expression 3 ]$$

In Mathematical expression 3, CG1 is a center gap between the first lenses 101, 201, 301, and 401 and the second lenses 102, 202, 302, and 402, and ΣCG is a sum of gaps between adjacent lenses. When Mathematical expression 3 is satisfied, light emitted from the first lenses 101, 201, 301, and 401, which has a large influence in the entire optical system, sets an optical path for entering the remaining lenses, and the optical system can have good optical performance at the set angle of view and focal length. In the first to fourth embodiments, Mathematical expression 3 can preferably satisfy 0.4<CG1/ΣCG<0.7.

$$< CG 1 / \sum CT < 0.3 \qquad [ Mathematical expression 4 ]$$

In Mathematical expression 4, CG1 is a center gap between the first lenses 101, 201, 301, and 401 and the second lenses 102, 202, 302, and 402, and ΣCT is a sum of the center thicknesses of the lenses. When Mathematical expression 4 is satisfied, light emitted from the first lenses 101, 201, 301, and 401, which has a large influence in the entire optical system, sets an optical path for entering the remaining lenses, and the optical system can have good optical performance at the set angle of view and focal length. In the first to fourth embodiments, Mathematical expression 4 can preferably satisfy 0.2<CG1/ΣCT<0.3.

$$0.1 < CG 1 / < 0.3 \qquad [ Mathematical expression 5 ]$$

In Mathematical expression 5, CG1 is a center gap between the first lenses 101, 201, 301, and 401 and the second lenses 102, 202, 302, and 402, and can set the relationship of TTL, which is a distance (mm) from an optical axis OA from the center of the first surface S1 of the first lenses 101, 201, 301, and 401 to the upper surface of the image sensor 500. When Mathematical expression 5 is satisfied, the light emitted from the first lenses 101, 201, 301, and 401, which has a large influence in the entire optical system, sets an optical path for entering the remaining lenses, and the optical system can have good optical performance at the set angle of view and focal length. In the first to fourth embodiments, Mathematical expression 5 can preferably satisfy 0.1<CG1/TTL<0.2.

$$0.3 < \sum CT / TTL < 0.8 \qquad [ Mathematical expression 6 ]$$

Mathematical expression 6 can set the relationship between the sum ΣCT of the center thicknesses of the first to eighth lenses 101-108, 201-208, 301-308, and 401-408 and TTL, which is the distance (mm) from the center of the first surface S1 of the first lenses 101, 201, 301, and 401 to an upper surface of the image sensor 500 on an optical axis OA. To reduce TTL, a lot of light refraction must occur. In order to refract a lot of light, the power of the lenses must increase, and the lenses become thicker to increase the power. When it is less than the lower limit of Mathematical expression 6, the sum of the thicknesses of the lenses decreases and the refractive power weakens. When it is more than the upper limit of Mathematical expression 6, there is a problem that the sum of the thicknesses of the lenses increases excessively, which increases TTL. In the first to fourth embodiments, Mathematical expression 6 can preferably satisfy 0.5<ΣCT/TTL<0.7.

$$0.1 < \sum CG / TTL < 0.5 \qquad [ Mathematical expression 7 ]$$

Mathematical expression 7 can set the relationship between the sum ΣCG of adjacent lens gaps among the first to eighth lenses 101-108, 201-208, 301-308, and 401-408 and TTL, which is the distance (mm) from the center of the first surface S1 to the upper surface of the image sensor 500 on the optical axis OA. To reduce TTL, a lot of light refraction must occur. To refract a lot of light, the power of the lenses must increase, and to increase the power, the lenses become thicker. When it is less than the lower limit of Mathematical expression 7, the sum of the thicknesses of the lenses decreases and the refractive power weakens, becoming weaker than the desired power. When it is more than the upper limit of Mathematical expression 7, there is a problem that the sum of the thicknesses of the lenses increases excessively, which increases TTL. In the first to fourth embodiments, Mathematical expression 7 can preferably satisfy 0.1<ΣCG/TTL<0.3.

$$2 < \sum CT / \sum CG < 3 \qquad [ Mathematical expression 8 ]$$

In Mathematical expression 8, ΣCT is the sum of the center thicknesses of the lenses, and ΣCG is the sum of the gaps between adjacent lenses. When Mathematical expression 8 is satisfied, the optical system can have good optical performance at the focal length at the set angle of view, and can reduce the TTL. In the first to fourth embodiments, Mathematical expression 8 can preferably satisfy 2<ΣCT/ΣCG<2.5.

$$25 < \sum Abb / \sum Index < 30 \qquad [ Mathematical expression 9 ]$$

In Mathematical expression 9, ΣAbb means the sum of Abbe's numbers of each of the plurality of lenses, and ΣIndex means the sum of refractive indices of each of the plurality of lenses at the d-line. When Mathematical expression 9 is satisfied, the optical systems 1000, 1100, 1200, and 1300 can have improved aberration characteristics and resolution. Mathematical expression 9 can control optical characteristics by setting the sum of Abbe's numbers and the sum of refractive indices of the lenses. In the first to fourth embodiments, preferably, Mathematical expression 9 can satisfy 25<ΣAbb/ΣIndex<28.

$$0.5 < \sum CT / \sum ET < 1.5 \qquad [ Mathematical expression 10 ]$$

In Mathematical expression 10, ΣCT is the sum of the center thicknesses of the lenses, and ΣET is the sum of the edge thicknesses, that is, the ends of the effective areas of the lenses. When Mathematical expression 10 is satisfied, the optical system can have good optical performance at the focal length at the set angle of view, and can reduce the TTL. In the first to fourth embodiments, preferably, Mathematical expression 10 can satisfy 0.8<ΣCT/ΣET<1.2.

$$0.5 < CT 1 / ET 1 < 1 \qquad [ Mathematical expression 11 ]$$

In Mathematical expression 11, CT1 is the center thickness of the first lenses 101, 201, 301, and 401, and ET1 is the edge thickness of the first lenses 101, 201, 301, and 401. Through this, it is possible to set a factor affecting the angle of view of the optical system, and it is possible to set a factor affecting the effective focal length (EFL). Mathematical expression 11 can preferably satisfy 0.6<CT1/ET1<1 in the first to fourth embodiments.

$$2 < CT 8 / ET 8 < 3.5 \qquad [ Mathematical expression 12 ]$$

In Mathematical expression 12, CT8 is the center thickness of the eighth lenses 108, 208, 308, and 408, and ET8 is the edge thickness of the eighth lenses 108, 208, 308, and 408. Through this, it is possible to set a factor affecting the angle of view of the optical system, and it is possible to set a factor affecting the effective focal length (EFL). Mathematical expression 12 can preferably satisfy 2<CT8/ET8<3.3 in the first to fourth embodiments.

$$1 < GLCa\_AVER / PLCa\_Aver < 2 \qquad [ Mathematical expression 13 ]$$

In Mathematical expression 13, GLCa_AVER represents an average effective diameter of glass lenses, and PLCa_AVER represents an average effective diameter of plastic lenses. A lens barrel in which a lens unit is disposed has at least one inner barrel within the lens barrel, and at least some of the plastic material lenses included in the lens unit may be disposed in the inner barrel. In the case of a plastic material lens, since the amount of expansion is large at high temperatures, a wider space is required within the lens barrel. In Mathematical expression 13, by setting the effective diameter size of the glass lens and the effective diameter size of the plastic lens, it is possible to suppress deterioration of optical characteristics due to temperature change, and the optical systems 1000, 1100, 1200, and 1300 can control incident light and set factors affecting aberration. In the first to fourth embodiments, Mathematical expression 13 preferably satisfies 1.5<GLCa_AVER/PLCa_AVER<1.7.

$$2 < CA\_L1S1 / CA\_L1S2 < 4 \qquad [ Mathematical expression 14 ]$$

In Mathematical expression 14, CA_L1S1 denotes an effective diameter of the first surface S1 of the first lenses 101, 201, 301, and 401, and CA_L1S2 denotes an effective diameter of the second surface S2 of the first lenses 101, 201, 301, and 401. When Mathematical expression 14 is satisfied, the deterioration of optical characteristics due to temperature change can be suppressed, and the optical systems 1000, 1100, 1200, and 1300 can control incident light and set factors affecting aberration. In the first to fourth embodiments, Mathematical expression 14 can preferably satisfy 2.5<CA_L1S1/CA_L1S2<3.7.

$$1 < CA\_L1 / CA\_L8 < 2 \qquad [ Mathematical expression 15 ]$$

In Mathematical expression 15, CA_L1 denotes an effective diameter of the first lenses 101, 201, 301, and 401, and CA_L8 denotes an effective diameter of the eighth lenses 108, 208, 308, and 408. The lens barrel in which the lens unit is disposed has at least one inner barrel within the lens barrel, and at least some of the plastic material lenses included in the lens unit can be disposed in the inner barrel. In the case of a plastic material lens, since the amount of expansion is large at high temperatures, a wider space is required within the lens barrel. Therefore, if Mathematical expression 15, which sets the relationship between the effective diameter of the first lenses 101, 201, 301, and 401 made of glass and the effective diameter of the eighth lenses 108, 208, 308, and 408 made of plastic, is satisfied, the deterioration of optical characteristics due to temperature change can be suppressed, and the optical systems 1000, 1100, 1200, and 1300 can control the incident light and set factors affecting aberration. In the first to fourth embodiments, Mathematical expression 15 can preferably satisfy 1.5<CA_L1/CA_L8<1.8.

$$3 < CA\_L1 / ImgH < 5 \qquad [ Mathematical expression 16 ]$$

Mathematical expression 16 can set the relationship between the size of the effective diameter CA_L1 of the first lenses 101, 201, 301, and 401 and ImgH, which is ½ of the maximum diagonal length of the image sensor. If Mathematical expression 16 is satisfied, the TTL suitable for a vehicle optical system is satisfied, and the set angle of view can be satisfied. If it is less than the lower limit of Mathematical expression 16, the effective diameter of the lens disposed in the optical systems 1000, 1100, 1200, and 1300 becomes the largest, which causes a problem in that the TTL becomes longer. If it exceeds the upper limit of Mathematical expression 16, there is a problem in that the angle of view becomes excessively larger than that satisfied by the optical systems 1000, 1100, 1200, and 1300. In the first to fourth embodiments, Mathematical expression 16 can preferably satisfy 3<CA_L1/ImgH<4.

$$0.5 < CT\_Max / CG\_Max < 1 \qquad [ Mathematical expression 17 ]$$

In Mathematical expression 17, CT_Max is the maximum center thickness among the lenses, and CG_Max is the maximum gap between adjacent lenses. When Mathematical expression 17 is satisfied, the optical system can have good optical performance at the focal length at the set angle of view, and can reduce the TTL. In the first to fourth embodiments, Mathematical expression 17 can preferably satisfy 0.5<CT_Max/CG_Max<1.

$$4 < CA\_max / CA\_min < 5 \qquad [ Mathematical expression 18 ]$$

In Mathematical expression 18, CA_max represents a maximum effective diameter among the object side surfaces and the sensor side surfaces of the lenses, and CA_Min represents a minimum effective diameter among the object side surfaces and the sensor side surfaces of the lenses. When Mathematical expression 18 is satisfied, the optical system can set a size for a slim and compact structure while maintaining optical performance. In the first to fourth embodiments, Mathematical expression 18 can preferably satisfy 4.2<CA_max/CA_min<4.8.

$$2 < CA\_max / CA\_Aver < 3 \qquad [ Mathematical expression 19 ]$$

In Mathematical expression 19, CA_max represents a maximum effective diameter among the object side surfaces and the sensor side surfaces of the lenses, and CA_Aver represents an average of the effective diameters of the object side surfaces and the sensor side surfaces of the lenses. When Mathematical expression 19 is satisfied, the optical system can set a size for a slim and compact structure while maintaining optical performance. In the first to fourth embodiments, Mathematical expression 19 can preferably satisfy 2.5<CA_max/CA_Aver<3.

$$0.5 < CA\_min / CA\_Aver < 1 \qquad [ Mathematical expression 20 ]$$

In Mathematical expression 20, CA_Min represents a minimum effective diameter among the object side surfaces and the sensor side surfaces of the lenses, and CA_Aver represents an average of the effective diameters of the object side surfaces and the sensor side surfaces of the lenses. When Mathematical expression 20 is satisfied, the optical system can set a size for a slim and compact structure while maintaining optical performance. In the first to fourth embodiments, Mathematical expression 20 can preferably satisfy 0.5<CA_min/CA_Aver<0.8.

$$4 < CA\_max / ImgH < 6 \qquad [ Mathematical expression 21 ]$$

Mathematical expression 21 indicates that CA_max represents the maximum effective diameter among the object side surfaces and the sensor side surfaces of the lenses, and Imgh represents ½ of the maximum diagonal length of the image sensor 500. When Mathematical expression 21 is satisfied, the optical system can maintain good optical performance and set a size for a slim and compact structure. In the first to fourth embodiments, Mathematical expression 21 can preferably satisfy 4<CA_max/ImgH<5.

$$25 < TTL < 30 \qquad [ Mathematical expression 22 ]$$

In Mathematical expression 22, total track length (TTL) means the distance (mm) from the center of the first surface S1 of the first lenses 101, 201, 301, and 401 to an upper surface of the image sensor 500 on the optical axis OA. When Mathematical expression 22 is satisfied, a suitable vehicle optical system can be provided. In the first to fourth embodiments, Mathematical expression 22 can preferably satisfy 26<TTL<28.

$$4 < ImgH < 6 \qquad [ Mathematical expression 23 ]$$

Mathematical expression 23 means that ImgH means ½ of the maximum diagonal length of the image sensor 500. Mathematical expression 23 can set the diagonal size of the image sensor 500 and provide an optical system having a vehicle sensor size. In the first to fourth embodiments, Mathematical expression 23 can preferably satisfy 4<ImgH<5.

$$0.3 < BFL < 1.5 \qquad [ Mathematical expression 24 ]$$

In Mathematical expression 24, BFL is the optical axis distance from the image sensor 500 to the center of the sensor side surface of the last lens. When Mathematical expression 24 is satisfied, the installation space of the filter 600 and the cover glass can be secured, the assembling property of the components can be improved through the gap between the image sensor 500 and the last lens, and the coupling reliability can be improved. In the first to fourth embodiments, Mathematical expression 24 can preferably satisfy 0.3<BFL<1. When the BFL is less than the range of Mathematical expression 24, some of the light traveling to the image sensor may not be transmitted to the image sensor, which may cause a decrease in resolution. When the BFL exceeds the range of Mathematical expression 24, stray light may be introduced, which may deteriorate the aberration characteristics of the optical system.

$$1.5 < F < 3 \qquad [ Mathematical expression 25 ]$$

Mathematical expression 25 can set the overall focal length F to suit the vehicle optical system. In the first to fourth embodiments, Mathematical expression 25 can satisfy 2<F<3.

$$170 < FOV\_H < 190 \qquad [ Mathematical expression 26 ]$$

In Mathematical expression 26, FOV_H represents the horizontal angle of view (degree) of the optical systems 1000, 1100, 1200, and 1300, and can provide an angle of view suitable for a vehicle optical system. In the first to fourth embodiments, preferably, 175<FOV_H<185 can be satisfied.

$$1 < TTL / CA\_max < 3 \qquad [ Mathematical expression 27 ]$$

In mathematical expression 27, CA_max means the largest effective diameter (mm) among the object side surface and the sensor side surface of a plurality of lenses, and total track length (TTL) means the distance (mm) from the vertex of the first surface S1 of the first lenses 101, 201, 301, and 401 to the upper surface of the image sensor 500 on the optical axis OA. Mathematical expression 27 sets the relationship between the total optical axis length of the optical system and the maximum effective diameter, so as to provide an improved vehicle optical system. In the first to fourth embodiments, Mathematical expression 27 can preferably satisfy 1<TTL/CA_max<2.

$$6 < TTL / ImgH < 8 \qquad [ Mathematical expression 28 ]$$

In Mathematical expression 28, total track length (TTL) means the distance (mm) from the vertex of the first surface S1 of the first lenses 101, 201, 301, and 401 to an upper surface of the image sensor 500 on an optical axis OA, and ImgH means ½ of the maximum diagonal length of the image sensor 500. When Mathematical expression 28 is satisfied, the optical systems 1000, 1100, 1200, and 1300 can have TTL for application to the vehicle image sensor 500, thereby providing further improved image quality. In the first to fourth embodiments, Mathematical expression 28 can preferably satisfy 6<TTL/ImgH<7.

$$0.1 < BFL / ImgH < 0.5 \qquad [ Mathematical expression 29 ]$$

In Mathematical expression 29, BFL is an optical axis distance from the image sensor 500 to the center of the sensor side surface of the last lens, and ImgH means ½ of the maximum diagonal length of the image sensor 500. When Mathematical expression 29 is satisfied, the optical systems 1000, 1100, 1200, and 1300 can secure a back focal length (BFL) for applying the size of the vehicle image sensor 500, set a gap between the last lens and the image sensor 500, and have good optical characteristics at the center and periphery of the field of view (FOV). In the first to fourth embodiments, Mathematical expression 29 can preferably satisfy 0.1<BFL/ImgH<0.3.

$$50 < TTL / BFL < 60 \qquad [ Mathematical expression 30 ]$$

In Mathematical expression 30, total track length (TTL) means the distance (mm) from the vertex of the first surface S1 of the first lenses 101, 201, 301, and 401 to the upper surface of the image sensor 500 on the optical axis OA, and BFL means the optical axis distance from the image sensor 500 to the center of the sensor side surface of the last lens. When Mathematical expression 30 is satisfied, the optical systems 1000, 1100, 1200, and 1300 can secure BFL. In the first to fourth embodiments, Mathematical expression 30 can preferably satisfy 53<TTL/BFL<57.

$$8 < TTL / F < 10 \qquad [ Mathematical expression 31 ]$$

In Mathematical expression 31, total track length (TTL) means the distance (mm) from the vertex of the first surface S1 of the first lenses 101, 201, 301, and 401 to an upper surface of the image sensor 500 on an optical axis OA, and F is the effective focal length of the optical system. Accordingly, an optical system for a driver assistance system can be provided. When the optical systems 1000, 1100, 1200, and 1300 according to the embodiment satisfies Mathematical expression 31, the optical systems 1000, 1100, 1200, and 1300 can have an appropriate focal length in a set TTL range, and provides an optical system that can form an image while maintaining an appropriate focal length even when the temperature changes from low temperature to high temperature. If it is less than the lower limit of the Mathematical expression 31, the refractive power of the lenses needs to be increased making it difficult to correct spherical aberration or distortion aberration. If it is more than the upper limit of the Mathematical expression 31, the effective diameter or TTL of the lenses becomes long, which may cause a problem of an enlargement of the imaging lens system. In the first to fourth embodiments, the Mathematical expression 31 can preferably satisfy 9<TTL/F<10.

$$5 < F / BFL < 7 \qquad [ Mathematical expression 32 ]$$

In Mathematical expression 32, F is an effective focal length of the optical system, and BFL means an optical axis distance from the image sensor 500 to the center of the sensor side surface of the last lens. When Mathematical expression 32 is satisfied, the optical systems 1000, 1100, 1200, and 1300 can have a set angle of view and an appropriate focal length, and a vehicle optical system can be provided. In addition, the optical systems 1000, 1100, 1200, and 1300 can minimize the gap between the last lens and the image sensor 500, and thus can have good optical characteristics at the periphery of the field of view (FOV). In the first to fourth embodiments, Mathematical expression 32 can preferably satisfy 5<F/BFL<6.

$$0.1 < F / ImgH < 1 \qquad [ Mathematical expression 33 ]$$

In Mathematical expression 33, F is an effective focal length of the optical system, and ImgH means ½ of the maximum diagonal length of the image sensor 500. Such optical systems 1000, 1100, 1200, and 1300 can have improved aberration characteristics in the size of the vehicle image sensor 500. In the first to fourth embodiments, Mathematical expression 33 can preferably satisfy 0.5<F/ImgH<0.8.

$$z = \frac{{cY}^{2}}{1 + \sqrt{1 - ( 1 + K ) {c}^{2} {Y}^{2}}} + {AY}^{4} + {BY}^{5} + {CY}^{4} + {DY}^{4} + {EY}^{4} + … \qquad [ Mathematical expression 34 ]$$

In Mathematical expression 34, Z may mean Sag, which is the distance from any location on the aspheric surface to the vertex of the aspheric surface along the optical axis. Y may mean the distance from any location on the aspheric surface to the optical axis in the direction perpendicular to the optical axis. ‘c’ may mean the curvature of the lens, and K may mean the conic constant. In addition, A, B, C, D, E, and F may mean aspheric constants.

The optical systems 1000, 1100, 1200, and 1300 according to the first to fourth embodiments can satisfy at least one or two or more mathematical expressions from Mathematical expression 1 to Mathematical expression 34. In this case, the optical systems 1000, 1100, 1200, and 1300 can have improved optical characteristics. In detail, when the optical systems 1000, 1100, 1200, and 1300 satisfies at least one or two or more mathematical expressions from Mathematical expression 1 to Mathematical expression 34, the optical systems 1000, 1100, 1200, and 1300 can have improved resolution and improve aberration and distortion characteristics. In addition, the optical systems 1000, 1100, 1200, and 1300 can secure a back focal length (BFL) for applying a vehicle image sensor 500, compensate for optical characteristic degradation due to temperature change, and minimize the gap between the last lens and the image sensor 500, thereby providing good optical performance at the center and periphery portions of the field of view (FOV).

Table 13 shows the result values for Mathematical expression 1 to Mathematical expression 33 described above in the optical systems 1000, 1100, 1200, and 1300 of the embodiment. Referring to Table 13, it can be seen that the optical systems 1000, 1100, 1200, and 1300 satisfies at least one, two or more, or three or more of Mathematical expression 1 to Mathematical expression 33. In detail, it can be seen that the optical systems 1000, 1100, 1200, and 1300 according to the embodiment satisfies all of Mathematical expression 1 to Mathematical expression 33. Accordingly, the optical systems 1000, 1100, 1200, and 1300 can have good optical performance at the center and periphery portions of the field of view FOV and can have excellent optical characteristics.

TABLE 13

| | | First | Second | Third | Fourth |
|---|---|---|---|---|---|
| Mathematical expression | | embodiment | embodiment | embodiment | embodiment |
| 1 | 3 < L1R2 < 10 | 5.000 | 5.000 | 5.000 | 5.000 |
| 2 | 50 < V5 < 80 | 75.495 | 75.495 | 75.495 | 75.495 |
| 3 | 0.3 < CG1/ΣCG < 0.8 | 0.590 | 0.615 | 0.562 | 0.562 |
| 4 | 0.1 < CG1/ΣCT < 0.3 | 0.241 | 0.253 | 0.254 | 0.233 |
| 5 | 0.1 < CG1/TTL < 0.3 | 0.150 | 0.152 | 0.149 | 0.146 |
| 6 | 0.3 < ΣCT/TTL < 0.8 | 0.621 | 0.602 | 0.585 | 0.624 |
| 7 | 0.1 < ΣCG/TTL < 0.5 | 0.254 | 0.248 | 0.264 | 0.259 |
| 8 | 2 < ΣCT/ΣCG < 3 | 2.446 | 2.433 | 2.212 | 2.410 |
| 9 | 25 < ΣAbb/ΣIndex < 30 | 27.302 | 27.531 | 27.531 | 25.487 |
| 10 | 0.5 < ΣCT/ΣΕT < 1.5 | 1.048 | 1.053 | 1.065 | 1.074 |
| 11 | 0.5 < CT1/ET1 < 1 | 0.765 | 0.797 | 0.807 | 0.957 |
| 12 | 2 < CT8/ET8 < 3.5 | 2.290 | 2.805 | 3.247 | 2.126 |
| 13 | 1 < GLCa_AVER/ | 1.651 | 1.673 | 1.646 | 1.572 |
| | PLCa_AVER < 2 | | | | |
| 14 | 2 < CA_L1S1/ | 3.574 | 3.455 | 3.422 | 2.704 |
| | CA_L1S2 < 4 | | | | |
| 15 | 1 < CA_L1/CA_L8 < 2 | 1.753 | 1.825 | 1.770 | 1.600 |
| 16 | 3 < CA_L1/ImgH < 5 | 3.434 | 3.433 | 3.434 | 3.154 |
| 17 | 0.5 < CT_Max/ | 0.851 | 0.672 | 0.798 | 0.875 |
| | CG_Max < 1 | | | | |
| 18 | 4 < CA_max/ | 4.646 | 4.764 | 4.709 | 4.280 |
| | CA_min < 5 | | | | |
| 19 | 2 < CA_max/ | 2.902 | 2.936 | 2.896 | 2.647 |
| | CA_Aver < 3 | | | | |
| 20 | 0.5 < CA_min/ | 0.625 | 0.616 | 0.615 | 0.618 |
| | CA_Aver < 1 | | | | |
| 21 | 4 < CA_max/ImgH < 6 | 4.634 | 4.630 | 4.632 | 4.124 |
| 22 | 25 < TTL < 30 | 27.450 | 27.450 | 27.450 | 27.450 |
| 23 | 4 < ImgH < 6 | 4.320 | 4.320 | 4.320 | 4.320 |
| 24 | 0.3 < BFL < 1.5 | 0.500 | 0.500 | 0.500 | 0.500 |
| 25 | 1.5 < F < 3 | 2.872 | 2.872 | 2.872 | 2.872 |
| 26 | 170 < FOV H < 190 | 180.000 | 180.000 | 180.000 | 180.000 |
| 27 | 1 < TTL/CA_max < 3 | 1.371 | 1.373 | 1.372 | 1.541 |
| 28 | 6 < TTL/ImgH < 8 | 6.354 | 6.354 | 6.354 | 6.354 |
| 29 | 0.1 < BFL/ImgH < 0.5 | 0.116 | 0.116 | 0.116 | 0.116 |
| 30 | 50 < TTL/BFL < 60 | 54.900 | 54.900 | 54.900 | 54.900 |
| 31 | 8 < TTL/F < 10 | 9.558 | 9.558 | 9.558 | 9.558 |
| 32 | 5 < F/BFL < 7 | 5.744 | 5.744 | 5.744 | 5.744 |
| 33 | 0.1 < F/ImgH < 1 | 0.665 | 0.665 | 0.665 | 0.665 |

FIG. 49 is an example of a plan view of a vehicle to which a camera module or optical system according to an embodiment of the invention is applied. Referring to FIG. 49, a vehicle camera system according to an embodiment of the invention includes an image generation unit 11, a first information generation unit 12, second information generation units 21, 22, 23, 24, 25, and 26, and a control unit 14. The image generation unit 11 may include at least one camera module 31 being disposed in the vehicle, and may capture images of the front of the vehicle and/or the driver to generate images of the front or interior of the vehicle. The image generation unit 11 may capture images of the front of the vehicle as well as the surroundings of the vehicle in one or more directions using the camera module 31, to generate images of the surroundings of the vehicle. Here, the front and surrounding images may be digital images, and may include color images, black and white images, and infrared images. In addition, the front and surrounding images may include still images and moving images. The image generation unit 11 provides the driver image, the front image, and the surrounding image to the control unit 14. Next, the first information generation unit 12 may include at least one radar and/or camera being disposed in the own vehicle, and detects the front of the own vehicle to generate the first detection information. Specifically, the first information generation unit 12 is disposed in the own vehicle, and detects the position and speed of vehicles located in front of the own vehicle, the presence and position of pedestrians, and the like to generate the first detection information.

By using the first detection information generated by the first information generating unit 12, the distance between the own vehicle and the vehicle in front can be controlled to be maintained at a constant level, and the stability of vehicle operation can be improved in specific preset cases, such as when the driver wants to change the driving lane of the own vehicle or when parking in reverse. The first information generating unit 12 provides the first detection information to the control unit 14. The second information generation units 21, 22, 23, 24, 25, and 26 detects each side of the own vehicle and generates second detection information with respect to the front image generated by the image generating unit 11 and the first detection information generated by the first information generating unit 12. Specifically, the second information generation units 21, 22, 23, 24, 25, and 26 may include at least one radar and/or camera disposed in the own vehicle, and may detect the position and speed of vehicles located on the side of the own vehicle or capture images. Here, the second information generation units 21, 22, 23, 24, 25, and 26 can be disposed at each of the front two corners, side mirrors, and the rear center and rear two corners of the vehicle.

At least one information generation unit of these vehicle camera systems may be equipped with an optical system and a camera module having the same as described in the embodiments disclosed above, and may provide or process information acquired through the front, rear, each side or corner area of the vehicle to a user to enable autonomous driving or to protect the vehicle and objects from surrounding safety.

The optical system of the camera module according to the embodiment of the invention can be mounted in multiple units in a vehicle for safety regulation, reinforcement of autonomous driving function, and increased convenience. In addition, the optical system of the camera module is applied in a vehicle as a component for control such as a lane keeping assistance system (LKAS), a lane departure warning system (LDWS), and a driver monitoring system (DMS). Such a vehicle camera module can implement stable optical performance even under changes in ambient temperature, and can provide a module with price competitiveness, thereby securing the reliability of vehicle components.

The features, structures, effects, and the like described in the embodiments above are included in at least one embodiment and are not necessarily limited to only one embodiment. Furthermore, the features, structures, effects, and the like illustrated in each embodiment can be combined or modified and implemented in other embodiments by a person with ordinary knowledge in the field to which the embodiments belong. Therefore, contents related to such combinations and modifications should be interpreted as being included in the scope of the embodiments.

In addition, although the above has been described with reference to embodiments, these are merely examples and do not limit the present invention, and those with ordinary skill in the art to which the present invention pertains will recognize that various modifications and applications not exemplified above are possible without departing from the essential characteristics of the present invention. For example, each component specifically shown in the examples can be modified and implemented. And, the differences related to such modifications and applications should be interpreted as being included in the scope of the present invention defined in the appended claims.

1. An optical system comprising:
first to eighth lenses disposed along an optical axis from an object side to a sensor side, each lens having an object side surface and a sensor side surface;
wherein the first lens has negative (−) refractive power,
wherein the second lens has negative (−) refractive power,
wherein the third lens has positive (+) refractive power,
wherein the fourth lens has negative (−) refractive power,
wherein the fifth lens has positive (+) refractive power,
wherein the sixth lens has positive (+) refractive power,
wherein the seventh lens has negative (−) refractive power,
wherein the eighth lens has positive (+) refractive power,
wherein an aperture is disposed between the fourth lens and the fifth lens,
wherein among distances between adjacent lenses on an optical axis, the distance between the first lens and the second lens is the greatest, and
wherein the second lens has a concave shape on both the object side and sensor side surfaces.

2. The optical system according to claim 1,
wherein at least one among the first lens and the fifth lens is made of glass, and
wherein at least one among the second to fourth lenses and the sixth to eighth lenses is made of plastic.

3. The optical system according to claim 1,
wherein at least one among the lenses disposed on an object side and a sensor side of the aperture is made of glass.

4. The optical system according to claim 1,
wherein among thicknesses of the first to eighth lenses on the optical axis, the thickness of the eighth lens is the largest.

5. The optical system according to claim 1,
wherein from the optical axis to an effective diameter area, a maximum value of the distance between two adjacent lenses having a largest difference in Abbe numbers is smaller than the maximum value of the distance between two other adjacent lenses.

6. The optical system according to claim 1,
wherein the eighth lens has a convex shape on both the object side and sensor side surfaces.

7. The optical system according to claim 1, satisfying:
$$Conditional expression 170 < FOV\_H < 190 ,$$
wherein FOV_H means a horizontal field of view (in degree) of the optical system.

8. The optical system according to claim 1, satisfying:
$$Conditional expression 0 \text{.3} < CG 1 / \sum CG < 0.8 ,$$
wherein CG1 is the distance between the first lens and the second lens on the optical axis, and
wherein ΣCG is the sum of gaps between adjacent lenses on the optical axis.

9. The optical system according to claim 1, satisfying:
$$Conditional expression 3 < L 1 R 2 < 10 ,$$
wherein L1R2 means a radius of curvature of the first lens.

10. An optical system comprising:
first to eighth lenses being disposed along an optical axis from an object side to a sensor side, each lens having an object side surface and a sensor side surface;
wherein the first lens has negative (−) refractive power,
wherein the second lens has negative (−) refractive power,
wherein the third lens has positive (+) refractive power,
wherein the fourth lens has negative (−) refractive power,
wherein the fifth lens has positive (+) refractive power,
wherein the sixth lens has positive (+) refractive power,
wherein the seventh lens has negative (−) refractive power,
wherein the eighth lens has positive (+) refractive power,
wherein among thicknesses of the first to eighth lenses on the optical axis, the thickness of the eighth lens is the largest, and
wherein the second lens has a concave shape on both surfaces.

11. The optical system according to claim 10,
wherein among effective diameters of the first to eighth lenses, the effective diameter of the first lens is the largest, and the effective diameter of the fourth lens is the smallest.

12. The optical system according to claim 10,
wherein among distances between two adjacent lenses on the optical axis, the distance between the sixth lens and the seventh lens is the smallest.

13. The optical system according to claim 10,
wherein among distances between two adjacent lenses on the optical axis, the distance between the first lens and the second lens is the greatest.

14. The optical system according to claim 10, comprising:
an aperture disposed between the fourth lens and the fifth lens,
a first lens group disposed on the object side with respect to the aperture, and a second lens group disposed on the sensor side with respect to the aperture, and
wherein a sign of a composite focal length of the first lens group and a sign of a composite focal length of the second lens group are different from each other.

15. The optical system according to claim 14,
wherein at least one of the lenses disposed on the object side and the sensor side of the above aperture is made of glass.

16. An optical system comprising:
a first to eighth lenses being disposed along an optical axis from an object side to a sensor side, each lens having an object side surface and a sensor side surface;
wherein the first lens has negative (−) refractive power,
wherein the second lens has negative (−) refractive power,
wherein the third lens has positive (+) refractive power,
wherein the fourth lens has negative (−) refractive power,
wherein the fifth lens has positive (+) refractive power,
wherein the sixth lens has positive (+) refractive power,
wherein the seventh lens has negative (−) refractive power,
wherein the eighth lens has positive (+) refractive power, and
wherein the second lens has a concave shape on both the object side and sensor side surfaces.

17. The optical system according to claim 16,
wherein the third lens has a concave shape on both the object side and sensor side surfaces.

18. The optical system according to claim 16,
wherein the fourth lens has a concave meniscus shape toward the object side.

19. The optical system according to claim 16,
wherein among distances between two adjacent lenses on the optical axis, the distance between the sixth lens and the seventh lens is the smallest.

20. The optical system according to claim 16, comprising:
an aperture disposed between the fourth lens and the fifth lens,
a first lens group disposed on the object side with respect to the aperture, and a second lens group disposed on the sensor side with respect to the aperture, and
wherein a sign of a composite focal length of the first lens group and a sign of a composite focal length of the second lens group are different from each other.
